(19) United States
(12) Patent Application Publication
(10) Pub. No.: US 2009/0109142 A1
(43) Pub. Date: Apr. 30, 2009

(54) EL DISPLAY DEVICE

(75) Inventor: Hiroshi Takahara, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 12/058,149

(22) Filed: Mar. 28, 2008

(30) Foreign Application Priority Data
Mar. 29, 2007 (JP) 2007-086204
Jan. 15, 2008 (JP) 2008-005394
Feb. 29, 2008 (JP) 2008-049400

(51) Int. Cl. G09G 3/30

(52) U.S. Cl. 345/76

(57) ABSTRACT

A switch being turned off using an output open function of a power supply circuit, a cathode voltage Vss is not transmitted, an output terminal takes on a high impedance condition and, a probing being done into a pad of the cathode voltage Vss output terminal with a probe, an ammeter which measures a current is disposed between the probe 304 and an external power source Vsst, making an adjustment time cathode voltage Vsst equal to an image display time cathode voltage Vss.

### TECHNICAL FIELD

The present invention relates to an EL display device using a light-emitting display device such as an EL display panel (display device) using an organic or inorganic electroluminescence (EL) element or the like.

### BACKGROUND OF THE INVENTION

An active matrix type image display device using an organic EL material or an inorganic EL material as an electrooptical transformation substance is of a light-emitting type whose emission luminance changes in response to a current written to a pixel, and which also has a light-emitting element in each pixel. The EL display device has advantages when compared with a liquid crystal panel, such as a high image visibility, a high luminous efficiency, no need for a backlight, and a high response speed.

To date, regarding an organic EL (PLED, OLED or OEL) panel, an active matrix system has been actively developed. This system, being one which controls a current flowing through a light-emitting element inside each pixel circuit by means of an active element (generally, a thin film transistor TFT) provided inside the pixel circuit, is described in JP-A-2003-255856 (kokai) and JP-A-2003-271095 (kokai).

In red (R), green (G) and blue (B) EL elements of the EL display device, as their component materials or the like are different from each other, luminous efficiencies and drive voltages are different. Also, the luminous efficiencies and drive voltages of the EL elements vary depending on manufacturing conditions of the EL display panel. For this reason, as EL display devices different in luminance and chromaticity are fabricated, it has been necessary to adjust the luminance and the chromaticity.

However, the luminance adjustment and the chromaticity adjustment are carried out by adjusting a current amount flowing through EL elements in an illumination area. The current amount adjustment is carried out by blocking a current pathway, and inserting a measuring instrument, such as an ammeter, in the blocked current pathway.

In order to insert a measuring instrument such as the ammeter, a mechanism has been required which physically blocks the current pathway, and a switch has been required which re-connects the current pathway to the ammeter. Due to the introduction of these mechanisms, there has been a problem in that a cost of the EL display device is increased, and a large amount of adjustment time is required.

Also, in the EL display device, a magnitude of a current flowing though a display screen varies depending on a display image. For this reason, when an image of a high luminance is displayed, a large current flows from a power supply circuit. For this reason, the power supply circuit has been required to be designed in such a way as to be able to pass a maximum current used.

However, in the event that the power supply circuit is designed in such a way as to be able to pass the maximum current used, there has been a problem in that a power supply circuit such as a power supply IC becomes very large.

Also, there has been a problem in that a long time is required for a defect inspection or characteristic evaluation of the EL display panel.

Therein, the invention may provide an EL display device which can measure or monitor a current flowing through a power supply wiring without physically changing or operating a mechanism or the like of the power supply wiring.

### BRIEF SUMMARY OF THE INVENTION

According to one embodiment of the invention, there is provided an EL display device including a display screen in which a plurality of EL elements are disposed in a matrix formation; a source drive circuit which, being connected to each EL element, supplies an image signal to each EL element; a gate drive circuit connected to each EL element; and an extraction terminal which, as well as supplying a drive voltage to each EL element via a voltage output terminal, has a switch which open-circuits or short-circuits each EL element and the voltage output terminal and, being disposed between each EL element and the switch, extracts a current flowing through each EL terminal.

According to the embodiment of the invention, it is possible to measure or monitor a current flowing through a power supply wiring without physically changing or operating a mechanism or the like of the power supply wiring.

### BRIEF DESCRIPTION OF THE DRAWINGS

FIG. 1 is a configuration diagram of a power supply circuit of an EL display device;

FIG. 2 is a configuration diagram of the EL display device;

FIG. 3 is an illustration of a pixel operation of the EL display device;

FIGS. 4A and 4B are illustrations of the pixel operation of the EL display device;

FIGS. 5A and 5B are illustrations of a method of driving the EL display device;

FIG. 6 is an illustration of the method of driving the EL display device;

FIGS. 7A and 7B are illustrations of the method of driving the EL display device;

FIG. 8 is an illustration of the EL display device of the embodiment;

FIG. 9 is an illustration of the EL display device of the embodiment;

FIG. 10 is an illustration of the EL display device of the embodiment;

FIG. 11 is an illustration of the EL display device of the embodiment;

FIG. 12 is an illustration of a power supply circuit of the EL display device;

FIG. 13 is an illustration of the power supply circuit of the EL display device;

FIG. 14 is an illustration of the power supply circuit of the EL display device;

FIG. 15 is an illustration of the power supply circuit of the EL display device;

FIG. 16 is an illustration of the power supply circuit of the EL display device;

FIG. 17 is an illustration of the power supply circuit of the EL display device;

FIG. 18 is an illustration of the power supply circuit of the EL display device;

FIG. 19 is an illustration of the power supply circuit of the EL display device;

FIG. 20 is an illustration of the power supply circuit of the EL display device;

FIG. 21 is an illustration of the power supply circuit of the EL display device;

FIG. 22 is an illustration of the power supply circuit of the EL display device;

FIG. 23 is an illustration of the power supply circuit of the EL display device;

FIG. 24 is an illustration of the power supply circuit of the EL display device;

FIG. 25 is an illustration of the power supply circuit of the EL display device;

FIG. 26 is an illustration of the power supply circuit of the EL display device;

FIG. 27 is an illustration of the EL display device of the embodiment;

FIG. 28 is an illustration of the EL display device of the embodiment;

FIG. 29 is an illustration of the EL display device of the embodiment;

FIG. 30 is an illustration of the EL display device of the embodiment;

FIG. 31 is an illustration of the EL display device of the embodiment;

FIG. 32 is an illustration of the EL display device of the embodiment;

FIG. 33 is an illustration of the EL display device of the embodiment;

FIG. 34 is an illustration of the EL display device of the embodiment;

FIG. 35 is an illustration of the EL display device of the embodiment;

FIG. 36 is an illustration of the EL display device of the embodiment;

FIG. 37 is an illustration of the EL display device of the embodiment;

FIG. 38 is an illustration of the EL display device of the embodiment;

FIG. 39 is an illustration of the EL display device of the embodiment;

FIG. 40 is an illustration of the EL display device of the embodiment;

FIG. 41 is an illustration of the EL display device of the embodiment;

FIGS. 42A and 42B are illustrations of the EL display device of the embodiment;

FIG. 43 is an illustration of the EL display device of the embodiment;

FIG. 44 is an illustration of the EL display device of the embodiment;

FIGS. 45A and 45B are illustrations of the EL display device of the embodiment;

FIG. 46 is an illustration of the EL display device of the embodiment;

FIG. 47 is an illustration of the EL display device of the embodiment;

FIG. 48 is an illustration of the EL display device of the embodiment;

FIG. 49 is an illustration of the EL display device of the embodiment;

FIG. 50 is an illustration of the EL display device of the embodiment;

FIG. 51 is an illustration of the EL display device of the embodiment;

FIG. 52 is an illustration of the EL display device of the embodiment;

FIG. 53 is an illustration of the EL display device of the embodiment;

FIG. 54 is an illustration of the EL display device of the embodiment;

FIG. 55 is an illustration of the EL display device of the embodiment;

FIG. 56 is an illustration of the EL display device of the embodiment;

FIG. 57 is an illustration of the EL display device of the embodiment;

FIG. 58 is an illustration of the EL display device of the embodiment;

FIG. 59 is an illustration of the EL display device of the embodiment;

FIG. 60 is an illustration of the EL display device of the embodiment;

FIG. 61 is an illustration of the EL display device of the embodiment;

FIG. 62 is an illustration of the EL display device of the embodiment;

FIG. 63 is an illustration of the EL display device of the embodiment;

FIG. 64 is an illustration of the EL display device of the embodiment;

FIG. 65 is a pixel configuration diagram of the EL display device of the embodiment;

FIG. 66 is a pixel configuration diagram of the EL display device of the embodiment;

FIGS. 67A and 67B are pixel configuration diagrams of the EL display device of the embodiment;

FIGS. 68A and 68B are pixel configuration diagrams of the EL display device of the embodiment;

FIG. 69 is an illustration of the EL display device of the embodiment;

FIG. 70 is a pixel configuration diagram of the EL display device of the embodiment;

FIG. 71 is a pixel configuration diagram of the EL display device of the embodiment;

FIGS. 72A and 72B are pixel configuration diagrams of the EL display device of the embodiment;

FIG. 73 is a pixel configuration diagram of the EL display device of the embodiment;

FIG. 74 is a pixel configuration diagram of the EL display device of the embodiment;

FIG. 75 is a pixel configuration diagram of the EL display device of the embodiment;

FIG. 76 is an illustration of the EL display device of the embodiment;

FIG. 77 is an illustration of the EL display device of the embodiment; and

FIG. 78 is an illustration of the EL display device of the embodiment.

### DETAILED DESCRIPTION OF THE INVENTION

Hereafter, a description will be given, based on the drawings, of an EL display device of an embodiment of the invention.

In the present specification, in order to facilitate understanding, some portions of the drawings are omitted, or increased or reduced in size.

Also, portions indicated by the same numbers, symbols or the like have the same or similar modes, configurations, materials, functions or operations.

### Outline of Embodiment

Firstly, a description will be given of an outline of the EL display device of the embodiment.

In the embodiment, a power supply circuit 12 or the like, used in the EL display device, is provided with a circuit which severs voltage generation circuits from a power supply wiring which supplies a current to EL elements. Also, it includes a function of varying an output voltage.

When adjusting the EL display device, the circuit which severs the voltage generation circuits is operated and, in a condition in which the voltage generation circuits of the power supply circuit are severed from the power supply wiring, a voltage is applied to the power supply wiring from an external voltage generation circuit. Also, an ammeter is disposed between the power supply wiring and the external voltage generation circuit.

The external voltage generation circuit transmits a steady-state operation time voltage of the EL display device and, in a condition in which a current flowing through the power supply wiring is monitored with the ammeter, adjusts the EL display device in such a way as to have a predetermined luminance, or in such a way that a predetermined current flows through the EL display device.

By the heretofore described means, it is possible to measure the current flowing through the power supply wiring without physically changing or operating a mechanism or the like of the power supply wiring. Consequently, it not happening that a cost of the EL display device increases, it is possible to implement the adjustment in a short time.

Also, a current flowing through a display screen is calculated or predicted by carrying out a process of adding or weighting an image signal input into the EL display device, a black strip-shaped non-illumination area is generated on the display screen by means of the calculated current or the like, and a size of the black strip-shaped non-illumination area is changed. Alternatively, by changing an amplitude of the image signal with a width of the black strip-shaped non-illumination area remaining constant, a control is carried out in such a way that a magnitude of the current flowing through the display screen does not reach a certain value. Also, by means of this control, it being possible to arrange in such a way as to maintain the current flowing through the display screen from the power supply circuit at the certain value or smaller, it is possible to suppress a heat generation of the EL display device. Also, by varying a voltage transmitted by the power supply circuit (a power supply IC) 12, it is possible to suppress the heat generation of the EL display device.

Also, by varying the voltage applied to the EL display device while monitoring a current flowing through an illumination area, it is possible to realize an optimum black level adjustment or white balance.

Also, by controlling an inspection transistor, or the like, it is possible to realize an inspection of the EL display device.

Also, as a larger current than a current used in a normal display condition can be caused to flow through the illumination area of the EL display device, it is possible to actualize an aging process.

### Details of Embodiment

Hereafter, a description will be given of details of the EL display device of the embodiment.

### 1. Configuration of Gate Drive Circuits

A description will be given of gate drive circuits 22 of the EL display device.

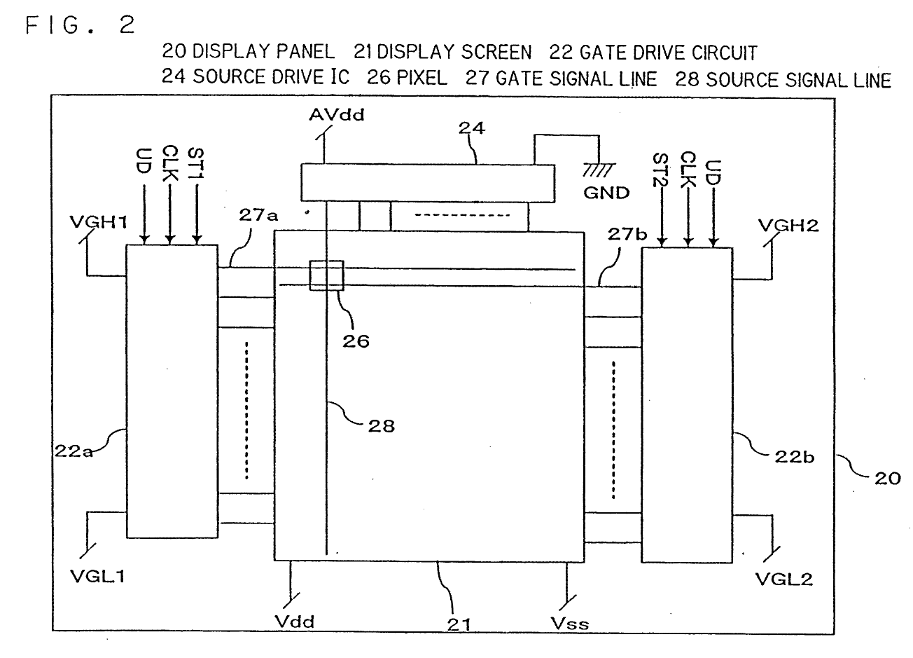

As shown in FIG. 2, a gate drive circuit 22a is provided at a left end of a display screen 21, while a gate drive circuit 22b is provided at a right end. It is sufficient that the gate drive circuits 22 are formed in a vacant area of a display panel.

### 1-1. Outline

The gate drive circuit 22a controls a gate signal line 27a, while the gate drive circuit 22b controls a gate signal line 27b. On voltages (VGL) of the gate signal lines 27 and off voltages (VGH) of the gate signal lines 27 are supplied to the gate drive circuits 22a and 22b. The off voltages (VGH) are voltages which are equal to or higher than, or approximate to, an anode voltage Vdd. The on voltages (VGL) are voltages which are approximate to a cathode voltage Vss or a ground voltage (GND). The approximate voltage is a voltage in a range of ±3V.

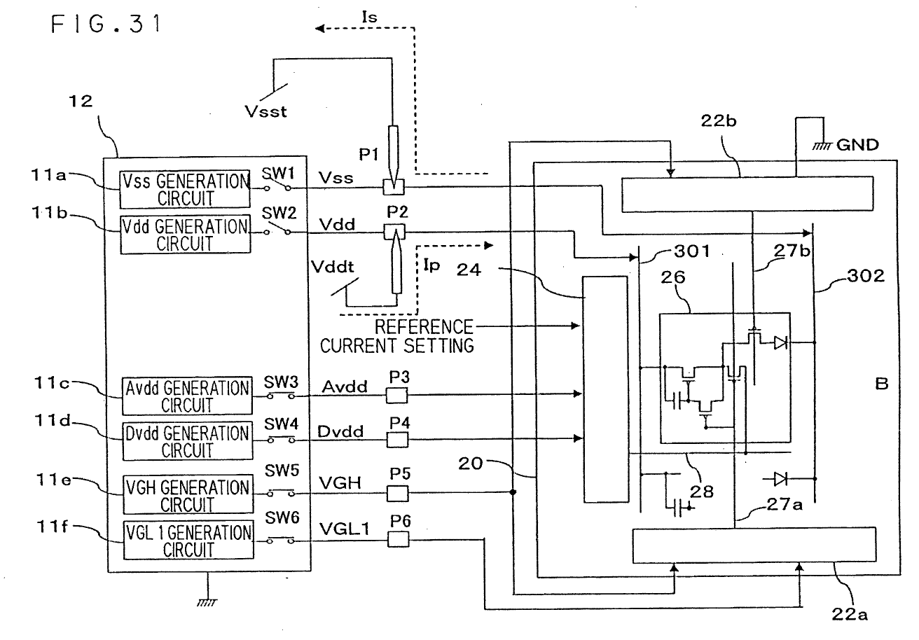

In the embodiment, a description will be given taking an off voltage of transistors 31 to be VGH, and an on voltage VGL, but this is not limiting. Polarities of the on voltage (VGL) and off voltage (VGH) are set corresponding to a kind of channel (a P channel or an N channel) of a drive transistor 31a. Also, as shown in FIG. 31, it is also acceptable to take one or a plurality of the voltages of the gate drive circuits 22 to be the GND voltage. In FIG. 31, the gate drive circuit 22b operates at the VGH voltage and a VGL=GND voltage, while the gate drive circuit 22a operates at the VGH voltage and a VGL1 voltage.

In the embodiment, the drive transistor 31a is taken to be a P channel transistor. In this case, the on voltage is taken as VGL, and the off voltage as VGH. In a case in which the drive transistor 31a is an N channel transistor, the on voltage is taken as VGH, and the off voltage as VGL. It is also acceptable to incorporate VGH1, VGH2, VGL1 and VGL2 in such a way as to conform to FIG. 2. In this case too, AVdd, and VGH1, VGH2, VGL1 and VGL2 are simultaneously activated by means of an ON1 command, while Vdd and Vss are activated by means of an ON2 command.

A source drive circuit (IC) 24 generates a program current Iw or a program voltage Vw, which are an image signal or a cancellation voltage. The generated image signal or cancellation voltage is applied to a source signal line 28. It is also acceptable to form a three selection circuit 481 between the source drive circuit (IC) 24 and the source signal line 28. A quantity selected by the selection circuit 481 not being limited to three, it is also acceptable to configure in such a way that it is another selection quantity such as six.

In the EL display device of the embodiment, it is taken that the gate drive circuit 22a has the on voltage VGH1 and the off voltage VGL1, while the gate drive circuit 22b has the on voltage VGH2 and the off voltage VGL2. Also, it is taken that VGH1=VGH2, and VGL1<VGL2. In the embodiment, drive voltages (VGH2 and VGL1) of the gate signal line 27 which selects a pixel 26 and writes the image signal, and drive voltages (VGH2 and VGL2) of the gate signal line 27 which controls a current passed through the EL element 35, are made different.

A configuration is such that, when taking a power supply voltage of the source drive circuit 24 to be Vcc (V), and the anode voltage Vdd (V), a relationship of Vdd−1.5(V)≦Vcc≦Vdd is satisfied.

Also, a configuration is such that, when taking the on voltages or off voltages of the gate drive circuits to be VGH (V), and the anode voltage Vdd (V), a relationship of Vdd+0.2(V)≦VGH≦Vdd+2.5(V) is satisfied.

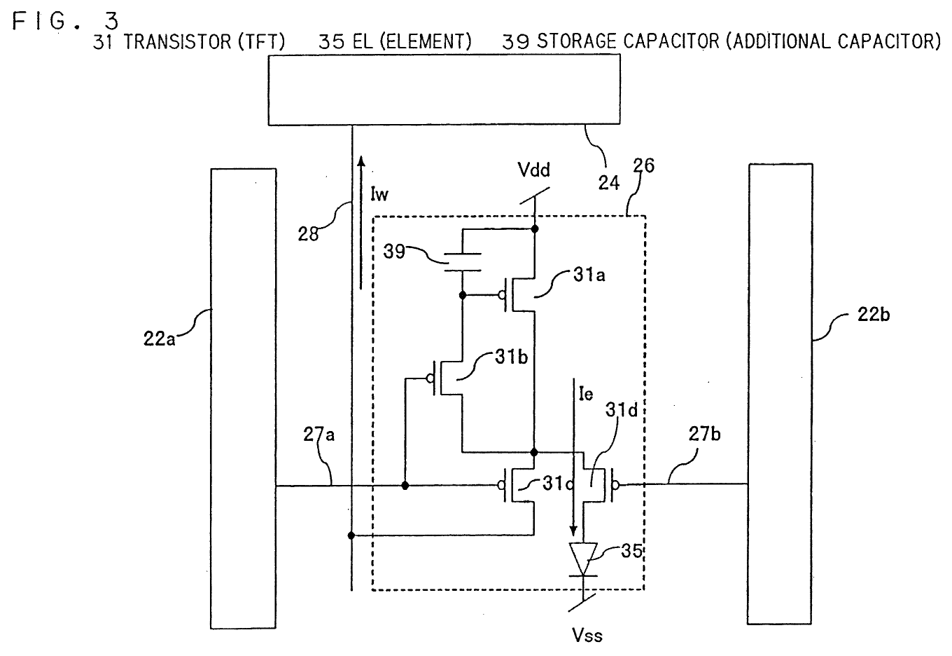

In a pixel configuration of the EL display device, as one example, shown in FIG. 3, switching transistors 31b and 31c function as switches for selecting pixels (rows) to which is applied the image signal transmitted by the source drive circuit 24. A switching transistor 31d functions as a switch for supplying a current to the EL element 35. That is, the switching transistor 31d operates as a switch which selects pixels (rows) to be caused to emit light.

FIG. 3 shows a pixel configuration of a current program (the image signal is Iw of a current signal), but it also operates by applying a voltage signal as the image signal.

### 1-2. Application of Input Signal

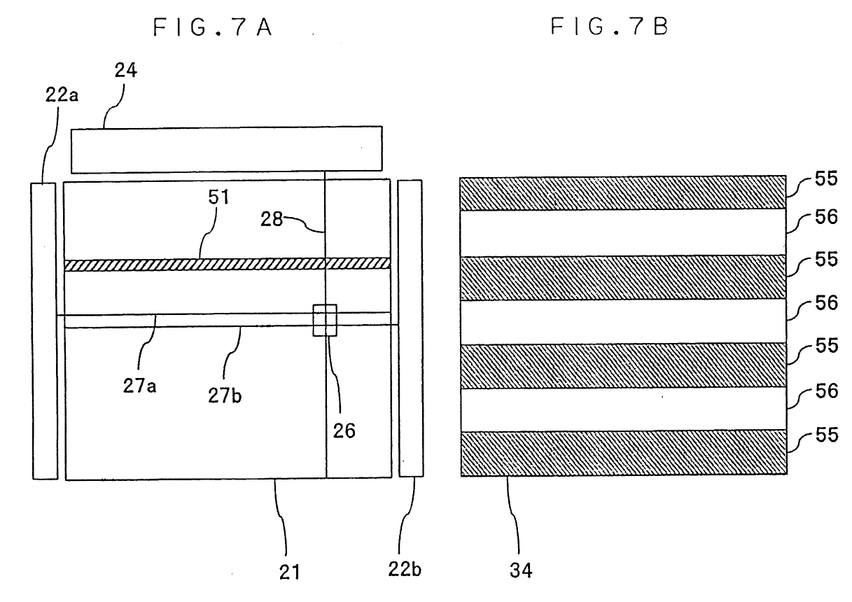

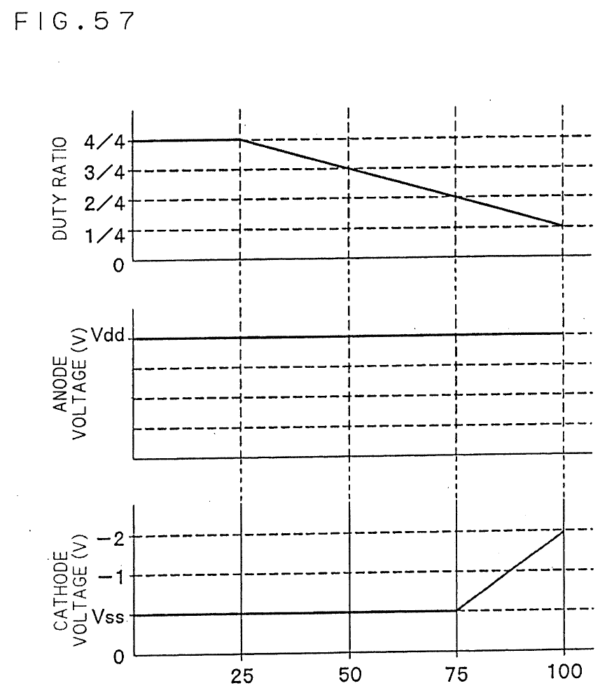

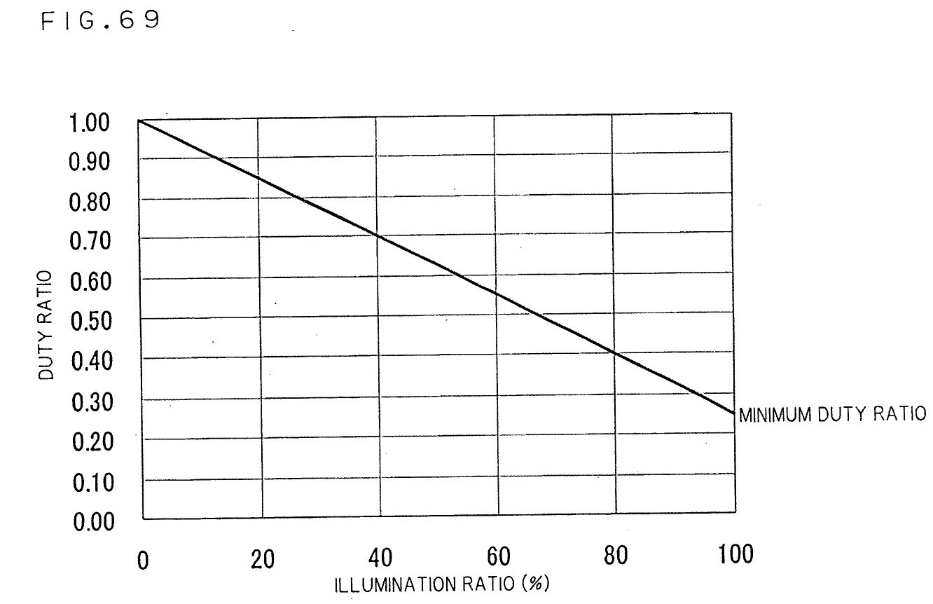

A clock signal (CLK), a start signal (ST1 or ST2) or an up/down signal (UP) is applied to the gate drive circuits 22. The clock signal (CLK) is synchronized with a horizontal synchronization signal (HD). Also, when necessary, the clock signal (CLK) is generated by an oscillation module built into the EL display device. By controlling the start signal (ST2), it is possible to realize a duty drive of FIGS. 7A, 7B and 57, and also, it is possible to realize an illumination ratio control of FIG. 69. A signal applied to the gate drive circuits 22, such as the clock signal (CLK), start signal (ST1 or ST2) or up/down signal (UP), is generated by the source drive IC 24, level-shifted by a level shifter circuit formed on an array substrate, and applied to the gate drive circuits 22.

The clock signal (CLK) is a signal for sequentially moving pixel rows to be selected. The start pulse signal (ST) is a signal for designating pixel rows to be selected. The start pulse signal (ST) moves through shift register circuits of the gate drive circuits 22 by clock signal (CLK). The up/down signal is a screen flip vertical switching signal. The gate signal lines 27 are selected (the on voltages (VGL) are applied to the gate signal lines 27) in accordance with start pulse positions in the shift register circuits.

### 2. Pixel Configuration

FIG. 3 shows an example of a pixel 26 configuration diagram of the EL display device. The pixels are formed in a matrix formation on the display screen 21. As one example, four transistors 31 configured of TFT's are formed in each pixel.

The configuration of the pixels 26 in the EL display device of the embodiment is not limited to the configuration of FIG. 3. Also, the embodiment is not limited to the quantity of transistors 31 formed in each pixel 26, either.

### 2-1. Wiring in Pixel

In FIG. 3, a gate terminal of the drive transistor 31a is connected to a source terminal of the switching transistor 31b. Gate terminals of the switching transistor 31b and switching transistor 31c are connected to the gate signal line 27a.

A drain terminal of the transistor 31b is connected to a drain terminal of the switching transistor 31c and a source terminal of the transistor 31d. A source terminal of the switching transistor 31c is connected to the source signal line 28.

A gate terminal of the transistor 31d is connected to the gate signal line 27b. A drain terminal of the transistor 31d is connected to an anode terminal of the EL element 35. A cathode terminal of the EL element 35 is connected to a cathode terminal (Vss). A source terminal of the drive transistor 31a is connected to an anode terminal (Vdd).

As one example, a cathode voltage Vss is −4.5V to −1.0V, while the anode voltage Vdd is 3.5V to 7.0V. Vss, Vdd, VGH, VGL and the like are supplied from the power supply circuit 12 of the embodiment, and a value of each voltage is changed and set when necessary.

The switching transistors 31b and 31c are on or off controlled so as to be turned on (a closed condition) and off (an open condition) by means of on and off control signals (VGH1 and VGL1) applied to the gate signal line 27a. The gate terminal of the transistor 31d is connected to the gate signal line 27b. The transistor 31d is controlled so as to be turned on and off by means of on and off control signals (VGH2 and VGL2) applied to the gate signal line 27b.

### 2-2. Illumination Area and Non-Illumination Area

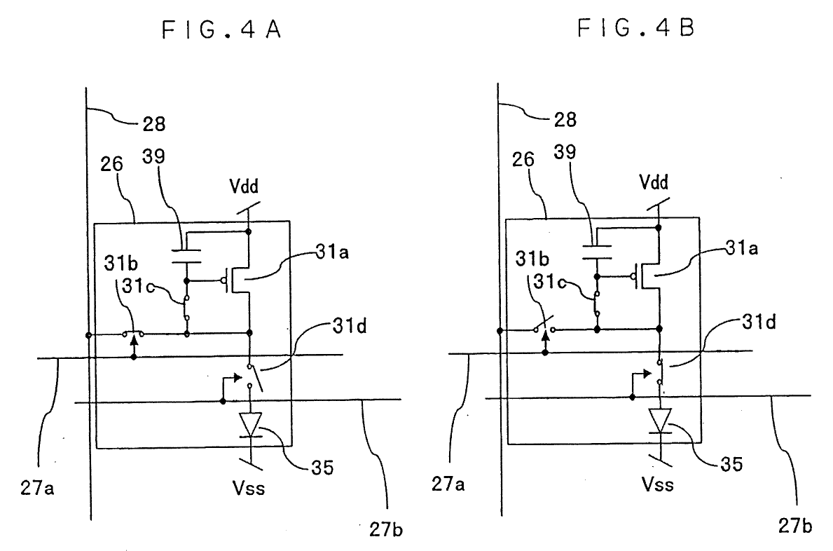

A condition in which a pixel to which the image signal is applied is selected is the condition of FIG. 4A. The switching transistor 31d is off, while the switching transistors 31b and 31c are on.

A condition in which the EL element 35 is caused to emit light is the condition of FIG. 4B. The switching transistor 31d is in the closed condition, while the switching transistors 31b and 31c are off.

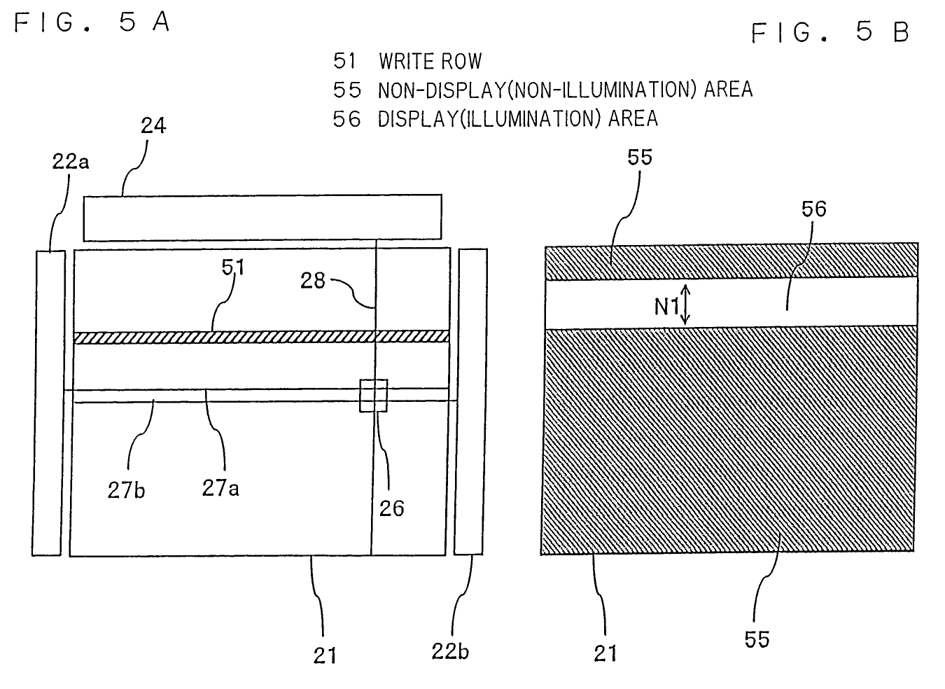

The heretofore described operation, when shown by the display screen 21, is as shown in FIGS. 5A and 5B. 51 of FIG. 5A indicates a pixel row (a write pixel row) selected in order to write the image signal or an image voltage. The write pixel row 51 is set to a non-illumination (a non-display pixel row). In order to set the non-illumination, it is sufficient to control the gate drive circuit 22b, and turn off the switching transistor 31d of the pixel 26.

In order to turn off the switching transistor 31d, it is sufficient to apply the off voltage (VGH1) to the gate signal line 27b. Positions in which the gate drive circuits 22 apply the off voltage (VGH) to the gate signal lines 27 are shifted in synchronism with the horizontal synchronization signal (HD).

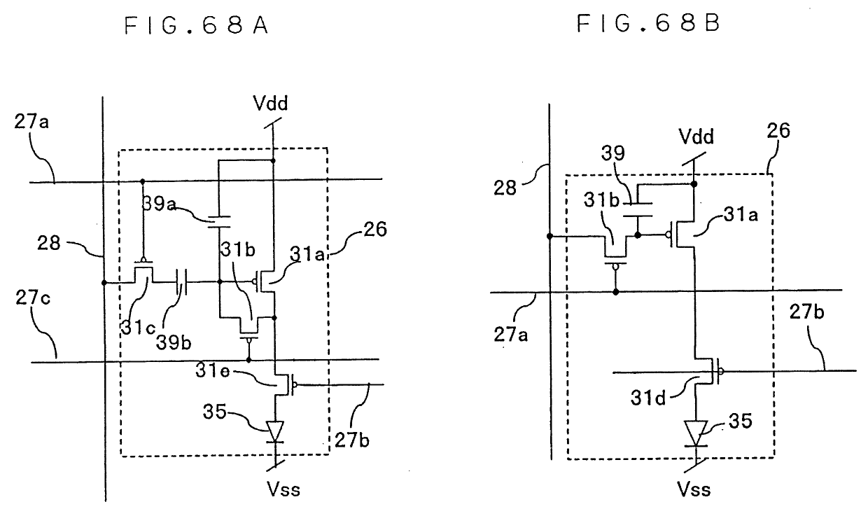

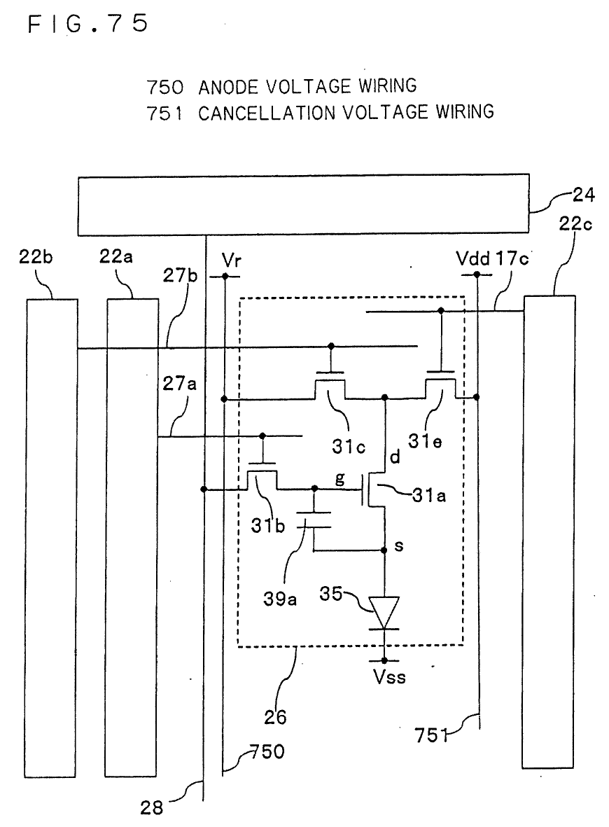

A peak current suppression drive (FIG. 69), and a duty drive and a voltage variable drive (FIG. 57), of the embodiment can be applied to any pixel configuration, whether it is of a current drive system (for example, FIG. 3) or of a voltage drive system (FIGS. 68A and 68B, 74 and 75).

A non-illumination condition refers to a condition in which no current is flowing through the EL element 35. Alternatively, it refers to a condition in which a small current of a certain value or smaller is flowing. That is, it is a dark display condition. A non-display (non-illumination) range of the display screen 21 is referred to as a non-illumination area 55. A display (illumination) range of the display screen 21 is referred to as a display (illumination) area 56. The switching transistor 31d of the pixel 26 in the illumination area 56 is turned on, and a current is flowing through the EL element 35. By the illumination area 56 or the non-illumination area 55 moving in an up and down direction of the screen 21, an image is displayed on the screen 21.

However, with an image display which is a black display, no current is flowing through the EL element 35. An area in which the switching transistor 31d is off becomes the non-illumination area 55.

In the EL display device of the embodiment, an image is displayed on the screen 21 by moving the illumination area 56 or the non-illumination area 55 in the up and down direction of the screen 21, but this is not limiting. For example, it is also acceptable that an image is displayed on the screen 21 by moving the illumination area 56 or the non-illumination area 55 in a left and right direction of the screen 21. Also, it is also acceptable that a moving direction of the illumination area 56 or the non-illumination area 55 is changed frame by frame. Also, it is also acceptable that the display area 56 or the non-display area 55 is divided into a plurality of pieces.

### 3. Timing Chart

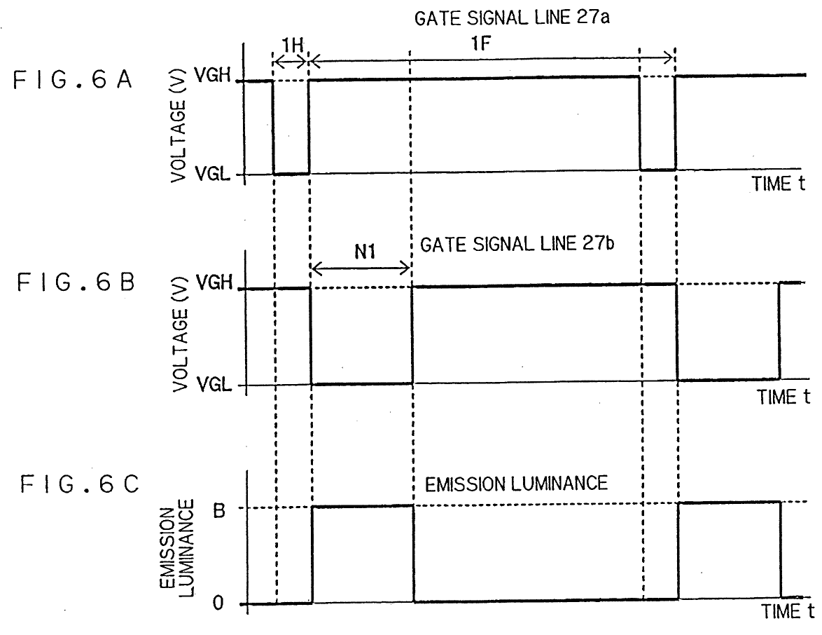

A timing chart is shown in FIG. 6. In the pixel 26 of a selected pixel row, when the on voltage (VGL1) is applied to the gate signal line 27a, the off voltage (VGH2) is applied to the gate signal line 27b (refer to FIG. 4A). In this period, no current is flowing through the EL element 35 of the selected pixel row (the non-illumination condition).

In a pixel row in which the on voltage is not applied to (that is, not selected for) the gate signal line 27a, and which is in an illumination condition, the on voltage (VGL2) is applied to the gate signal line 27b. A current is flowing through the EL element 35 of this pixel row, and the EL element 35 is emitting light. In C of FIG. 6, this emission luminance is taken as a luminance B (nt).

In a pixel row in which the on voltage is not applied to the gate signal line 27a, and which is in the non-illumination condition, the off voltage (VGH2) is applied to the gate signal line 27b. No current flows through the EL element 35 of this pixel row, and the EL element 35 is in the non-illumination condition.

FIGS. 5A, 5B and 6 show a condition in which the illumination area 56 with N1 (N1 is an integer of one to a pixel row quantity) pixel rows is generated. The illuminated area with the N1 pixel rows is moved from a top edge to a bottom edge of the display screen 21. The movement period depends on an operating frame rate (a frame period) of the gate drive circuit 22b. That is, the area moves in synchronism with a vertical synchronization signal.

Also, a period of rewriting the display screen 21 depends on an operating frame rate (a frame frequency) of the gate drive circuit 22a. An operating frame rate of NTSC is 60 Hz (60 screens for one second, a time to rewrite one screen is 1/60 seconds), and that of PAL is 50 Hz (50 screens for one second). In MPEG, a quantity of frames is 30 (30 screens for one second, a time to rewrite one screen is 1/30 seconds) or 15 (15 screens for one second, a time to rewrite one screen is 1/15 seconds).

In synchronism with the frame frequency, the start pulse (ST1) is applied to the gate drive circuit 22a. The start pulse (ST2), a frame rate period input pattern of which is generated, is applied to the gate drive circuit 22b.

It is preferable that a quantity of screens 21 rewritten for one second is 70 or more. Also, it is preferable that the quantity is 130 or less. That is, a frame rate is taken to be 70 Hz to 130 Hz.

In FIGS. 5A and 5B, it is taken that an area of the display screen 21 equivalent to the N1 pixel rows is continuously illuminated. It is also acceptable that the illuminated area (the illumination area 56) is divided as in FIGS. 7A and 7B. In the event that an area of the display screen 21 is taken as 100, an area of the illumination area 56 in FIGS. 5A and 5B as 20, and a display luminance thereof as 10, a display luminance ratio of the display screen 21 is 20×10/200=1. In FIGS. 7A and 7B too, in order to divide the illumination area 56 into four, and make a display luminance the same as that of FIGS. 5A and 5B, it is sufficient that a display luminance of each divided illumination area 56 is taken as 10, and an area of each illumination area 56 as N1/4.

### 4. Source Drive Circuit 24

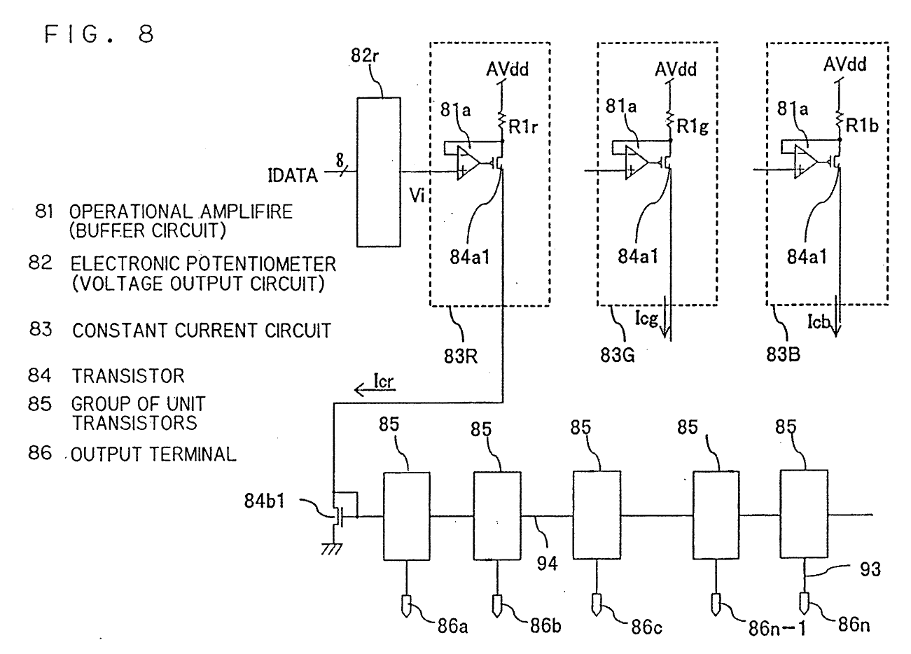

FIG. 8 is an illustration of a program current (image signal) generation circuit of the source drive circuit 24 of the EL display device of the embodiment. The source drive circuit 24 has reference current circuits (constant current circuits) 83 (83R, 83G and 83B) corresponding to red (R), green (G) and blue (B).

The reference current circuits 83 are configured of resistors R1 (R1r, R1g and R1b), operational amplifiers 81a and transistors 84a. A configuration is such that values of the resistors R1 (R1r, R1g and R1b) can be independently adjusted so as to correspond to gradation currents of R, G and B. The resistors R1 are external resistors disposed outside the source drive circuit 24.

A voltage V1 is applied to +terminals of the operational amplifiers by electronic potentiometers 86. The voltage V1 can be obtained by dividing a stable reference voltage Vb by a resistance R. The electronic potentiometers 86 change an output voltage V1 by means of a signal IDATA. A reference current Ic becomes (Vs−Vi)/R1. The reference currents Ic (Icr, Icg and Icb) of R, G and B are varied by the independent reference current circuits 83, respectively. The variation is implemented by the electronic potentiometer formed for each of R, G and B. Consequently, values of the voltages Vi transmitted from the electronic potentiometers 86 change depending on control signals applied to the electronic potentiometers 86. Magnitudes of the reference currents of R, G and B change depending on the voltages Vi, and magnitudes of the gradation currents (program currents) Iw transmitted from terminals 86 change in proportion.

The generated reference currents Ic (Icr, Icg and Icb) are applied to a transistor 84b from the transistors 84a. The transistor 84b and a group of transistors 85 configure a current mirror circuit. Although the transistor 84b1 is illustrated in such a way as to be configured of one transistor in FIG. 8, actually, in the same way as the group of transistors 85, it is formed as a collection of unit transistors 92 (a group of transistors).

The program currents Iw from the group of transistors 85 are transmitted from the output terminals 86. Gate terminals of the unit transistors 92 of the group of transistors 85, and a gate terminal of the transistor 84b, are connected by a gate wiring 94.

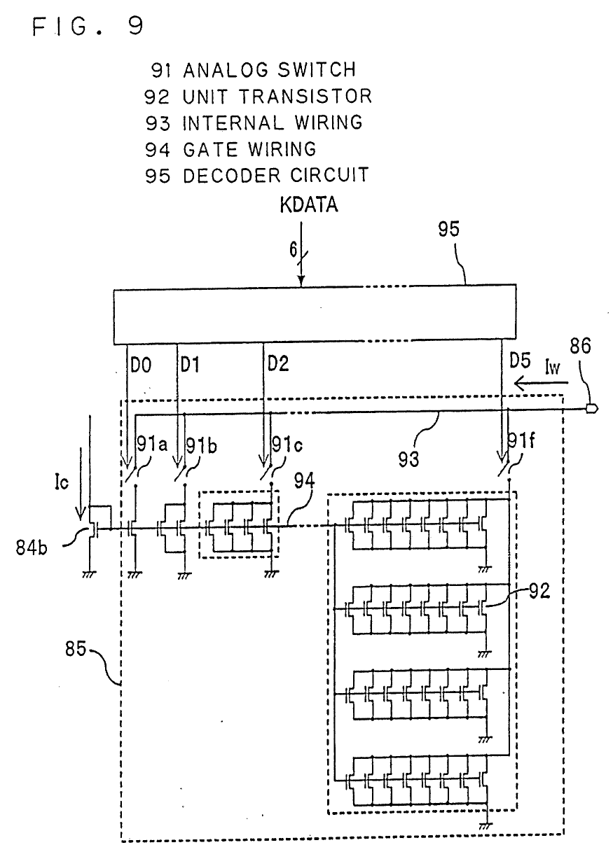

As shown in FIG. 9, the group of transistors 85 is configured as the collection of unit transistors 92. In order to facilitate understanding, a description will be given, taking image data and the program currents are to be converted in a proportional or correlational relationship. Switches 91 are selected by means of the image signal and, by means of the selection of the switches 91, the program currents Iw are generated as a collection (addition) of output currents of the unit transistors 92. Consequently, it is possible to convert the image signal into the program currents Iw. The embodiment is configured in such a way that unit currents of the unit transistors 92 correspond to a size of image data 1.

The unit current is a magnitude of one unit program current transmitted by a unit transistor 92 in response to a magnitude of a reference current Ic. When the reference currents Ic change, the unit currents transmitted by the unit transistors 92 also change in proportion. This is because the transistor 84b and the unit transistors 92 configure the current mirror circuit.

The group of transistors 85 of R, G and B being configured of the collection of unit transistors 92, the magnitudes of the output currents (unit program currents) of the unit transistors 92 are adjusted by means of the magnitudes of the reference currents Ic. By adjusting the magnitudes of the reference currents Ic, it is possible to vary the magnitude of the program current (constant current) Iw of each gradation for each of R, G and B. Consequently, in a kind of ideal condition in which characteristics of the unit transistors 92 of R, G and B are the same, by changing the magnitudes of the reference currents Ic of the reference current circuits 83 of R, G and B, it is possible to achieve the white balance of the display image of the EL display device.

Hereafter, in order to facilitate description, a description will be given, taking the group of transistors 85 of the source drive circuit (IC) 14 to be of six bits. In FIG. 9, the unit transistors 92 are disposed one for each item of constant current data (D0 to D5). One unit transistor 92 is disposed in a D0 bit. Two unit transistors 92 are disposed in a D1 bit. Four unit transistors 92 are disposed in a D2 bit, eight unit transistors 92 in a D3 bit, and 16 unit transistors 92 in a D4 bit. In the same way, 32 unit transistors 92 are disposed in a D5 bit.

Whether or not the output currents of the unit transistors 92 in the individual bits are transmitted to the output terminals 86 can be actualized by means of the on or off control by the analog switches 91 (91a to 91f). A decoder circuit 95 decodes input image data KDATA. The analog switches are on or off controlled in response to the image signal data KDATA.

The program current Iw flows through an internal wiring 93. A potential of the internal wiring 93 becomes a potential of the source signal line 28. The potential of the internal wiring 93 is from AVdd to a GND potential. When the constant current Iw is applied to the source signal line 28 and placed in a steady state, the potential of the source signal line 28 is a potential of the gate terminal of the drive transistor 31a of the pixel 26 (in the case of the pixel configuration shown in FIG. 3).

### 5. Gradation Voltage Output

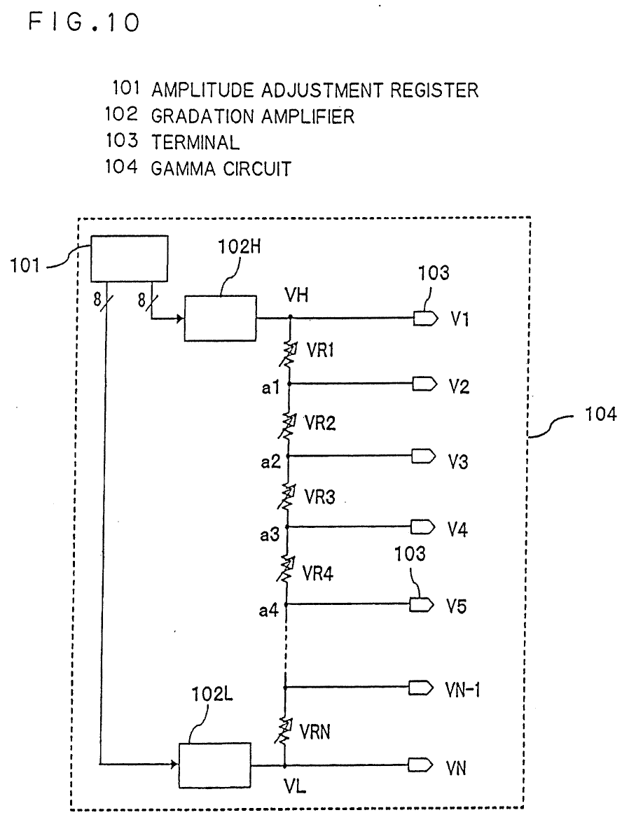

FIG. 10 is an illustration of a gradation voltage output circuit of a voltage program system. A minimum of a potential generated by the gradation voltage output circuit is 0V (the GND potential), while a maximum of the potential is the power supply voltage Avdd of the source drive circuit 24.

A low potential of a gamma curve is regulated by a gradation amplifier 102L. A high potential of the gamma curve is regulated by a gradation amplifier 102H. A voltage transmitted by the gradation amplifier 102H is taken as VH. A voltage transmitted by the gradation amplifier 102L is taken as VL. Consequently, a maximum value of an amplitude width is VH−VL.

The output voltages of the gradation amplifiers 102 are controlled by an amplitude adjustment register 101. An output bit of the amplitude adjustment register 101 is of 8 bits. Consequently, the gradation amplifiers 102 are capable of 256 stages of output changes. By increasing a potential value of the gradation amplifier 102H (to a high potential), an amplitude value of the gamma curve increases. By reducing a potential value of the gradation amplifier 102H (to a low potential), the amplitude value of the gamma curve decreases.

Also, by increasing the potential value of the gradation amplifier 102L (to the high potential), the amplitude value of the gamma curve decreases. By reducing the potential value of the gradation amplifier 102H (to the low potential), the amplitude value of the gamma curve increases. With the configuration of FIG. 10, it is also possible to operate the gradation amplifier 102H and the gradation amplifier 102L independently.

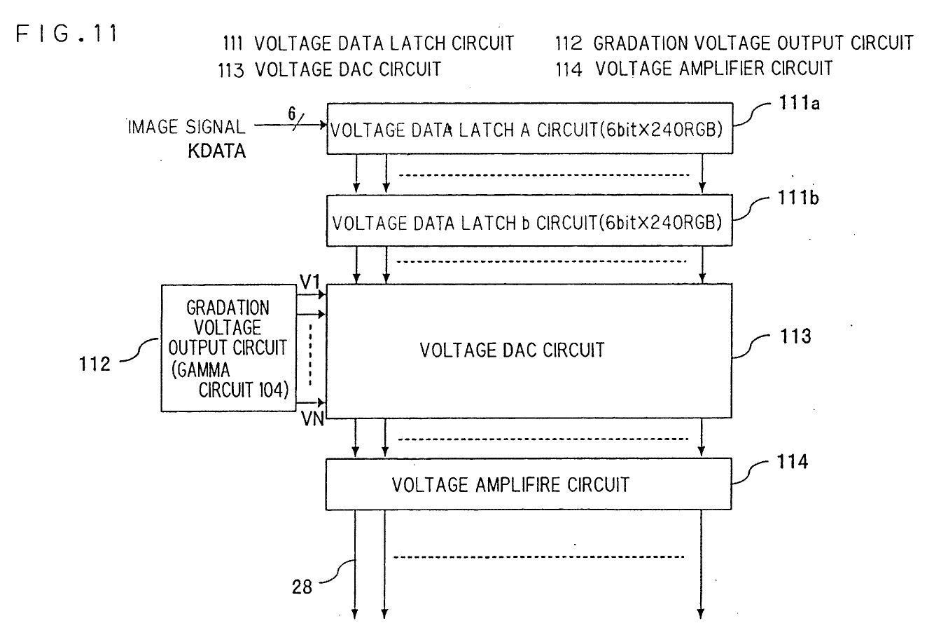

Resistors are connected in a ladder structure between the gradation amplifier 102H and the gradation amplifier 102L. Wiring terminals 103 are led out from between the resistors (VR1, VR2, VR3, VR4 . . . , and VRN). The wiring terminals 103 are connected to selector circuits of a voltage DAC circuit of FIG. 11. It is taken that, the drive transistor 31a of the pixel 26 being the P channel transistor, a low gradation side is close to AVdd, and a high gradation side close to GND.

A configuration is such that resistance values of the resistors (VR1, VR2, VR3, VR4 . . . , and VRN) of the resistor ladder can be varied by means of a command setting. The resistance values change by means of a command.

It is also acceptable that at least one of the VH and VL voltages is changed in response to an illumination ratio of FIG. 69 and a duty ratio of FIG. 57. When the illumination ratio is low, an absolute value of VH−VL is made large while, when the illumination ratio is high, the absolute value of VH−VL is made relatively small. Also, when the duty ratio is low, the absolute value of VH−VL is made large while, when the duty ratio is high, the absolute value of VH−VL is made relatively small.

Also, it is preferable that a gradation number displayed on the EL display device is changed in accordance with the illumination ratio. For example, when the illumination ratio is 50% or higher, an image is displayed in a range of a half of a full gradation (512 gradation in a case of 1024 gradation) while, when it is 50% or lower, an image is displayed in a range of the full gradation.

The illumination ratio is a ratio in a case in which a white raster display at a maximum gradation is taken as 100% in a normal drive system, such as the duty drive, which does not control a peak current. Consequently, the illumination ratio is 0% in a black raster display.

As shown in FIG. 11, the image signal data KDATA are held in voltage data latch circuits 111a. Each item of the data is of six bits. Also, a pixel column is of 240 dots, and there are three items of data for R, G and B in each dot. Consequently, 6 bits×240 RGB is obtained in line memories of a voltage data latch A circuit and a voltage data latch B circuit. The data of the voltage data latch A circuit 111a are synchronized with the horizontal synchronization signal (HD), and copied to the voltage data latch B circuit 111b.

The voltage DAC circuit 113 is configured of a switch circuit. Based on analog data of the voltage data latch B circuit 111b, one is selected from among the terminals 103 of a gradation voltage output circuit 112. A voltage of the selected terminal 103 is transmitted to the source signal line 28.

In the event that the operation frame rates of the gate driver circuits 22a and 22b are different, it may happen that the on voltage (VGL) is applied to the gate signal lines 27a and 27b connected to the same pixel 26.

Both the program current output circuit of FIGS. 8 and 9, and the program voltage output circuit of FIGS. 10 and 11, are configured in the source drive circuit 24. In a program current system, an image signal write deficiency occurs in a low gradation area while, in a program voltage system, it is possible to actualize an effective image signal write even in the low gradation area. However, in the program voltage system, a compensation for a variation characteristic of the drive transistor 31a is not complete. In the program current system, the compensation for the variation characteristic of the drive transistor 31a is good.

By configuring both the program current output circuit and the program voltage output circuit in the source drive circuit 24, and operating them, it being possible to compensate for a defect of the program current system and a defect of the program voltage system, it is possible to realize an effective image display.

In the embodiment, a drive method is employed in which the program voltage is applied to each pixel of the applied image signal in a first half of a period in which one pixel row is selected, and the program current is applied in a second half of the period. The program current is applied after the program voltage has been applied. The program voltage is not applied in a case in which a corresponding image signal is of a high gradation. This is because a target gradation signal can be sufficiently written with the program current. Of course, it is also acceptable that the image signal applied to the pixel 26 is configured only of a voltage signal. Also, it is also acceptable that the image signal applied to the pixel 26 is configured only of a current signal.

### 6. Power Supply Circuit

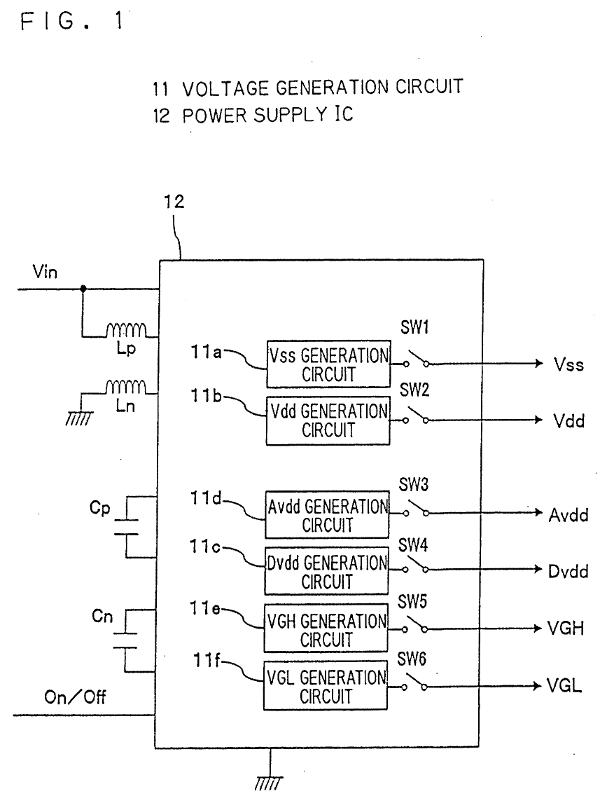

FIG. 1 is an illustration of the power supply circuit of the embodiment. By using the power supply circuit of the embodiment, it becomes possible to easily actualize an inspection, an aging, a luminance adjustment and the like.

A Vin voltage (a voltage of 2.3V to 4.6V) is applied to a Vin terminal of the power supply circuit 12 from a battery. The power supply circuit 12 generates a voltage necessary for the EL display device. Voltages (the anode voltage Vdd and the cathode voltage Vss), and their currents, supplied to the EL element are generated by a DCDC circuit.

In the DCDC circuit, a coil Lp is used for a positive voltage Vdd. A coil Ln is used for a negative voltage Vss. That is, a necessary voltage is generated by using the coils to cause a resonance.

Vdd is common to the analog voltage Avdd of the source drive circuit 24 (Vdd=Avdd). The Avdd voltage is a power supply voltage of the source drive circuit 24. The analog voltage Avdd is taken to be a reference voltage of the image signal. As the drive transistor 31a is the P channel transistor, the anode terminal is connected to an anode electrode (the voltage Vdd). That is, a reference voltage position of the drive transistor 31a is the anode voltage Vdd. The analog voltage of the source drive circuit 39 being taken as Avdd, Avdd is taken to be a reference (when the image signal voltage is the Avdd voltage, an amplitude voltage of the image signal is 0V). Also, by making Avdd equal to Vdd, it is easy to carry out a program setting of the drive transistor 31a by means of the image signal. Also, it is also possible to reduce a number of power supplies used in the EL display device.

The drive transistor 31a of the pixel 26 is the P channel transistor. By making Vdd equal to Avdd, as a potential of the gradation voltage and an anode potential Vdd change together, it is possible to realize the effective gradation display. Even when the anode voltage Vdd generated by the power supply circuit (IC) 12 changes due to a variation, the reference position of the amplitude voltage applied to the drive transistor 31a changes along with it. Consequently, an accuracy of the program setting of the drive transistor 31a by means of the image signal becomes higher.

In a case in which the drive transistor 31a of the pixel 26 is the N channel transistor, the reference voltage of the image signal is taken to be the ground (GND) voltage.

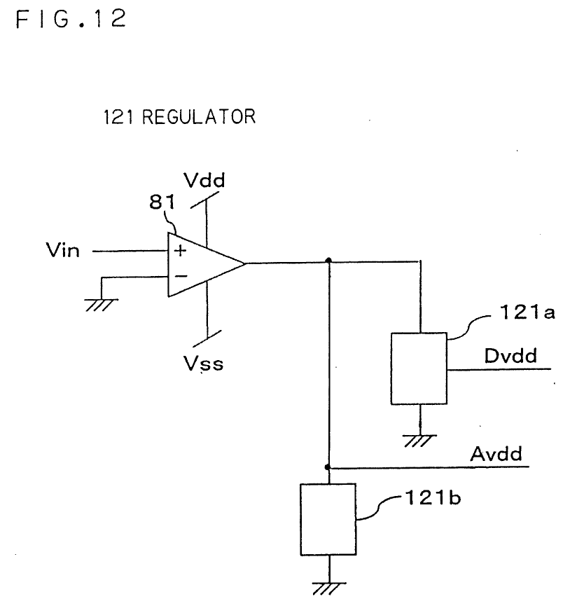

Also, the power supply circuit 12 generates a logic voltage Dvdd of the source drive circuit by means of a linear regulator circuit, where Dvdd=1.85 V. Also, the power sources (VGH and VGL) of the gate drive circuit 22 are generated by a charge pump circuit. In the charge pump circuit, a capacitor Cp is used for a positive voltage VGH. In the charge pump circuit, a capacitor Cn is used for a negative voltage VGL. That is, the charge pump circuit is configured of the capacitor and an oscillating circuit, generating a necessary voltage value. It is also acceptable that the Avdd voltage is also generated by a regulator circuit 121b, as shown in FIG. 12. Also, it is also acceptable to configure in such a way that Dvdd and Avdd can be on or off controlled individually.

It is also acceptable that voltages used in the gate drive circuits 22, such as VGH and VGL, are generated by the charge pump circuit formed in the source drive circuit 24. In this case, off switches are formed in the VGH and VGL output circuits of the source drive circuit 24 (the source drive circuit 24 is provided with an output off function).

In the following examples, a description will be given, taking the power supply circuit 12 to be equipped with VGH and VGL voltage generation circuits 11. In a case in which the VGL and VGH voltage generation circuits 11 are provided on the source drive circuit 24, it is sufficient to implement the embodiment even when obtaining synchronization between the source drive circuit 24 and the power supply circuit 12.

It is also acceptable that the Avdd and Dvdd voltages are generated by regulator circuits 121, as shown in FIG. 12. The battery voltage Vin is input into a regulator circuit 121a, generating the Dvdd voltage. Also, the battery voltage Vin is input into the regulator circuit 121b, generating the Avdd voltage.

### 7. Output Open Function

The embodiment has an output open function in order to respond to adjustments such as an ageing process, a defect inspection, and a luminance adjustment.

### 7-1. Details of Output Open Function

The output open function is configured of switches. As shown in FIG. 1, the switches (SW1, SW2, SW3, SW4, SW5 and SW6) are formed in output stages of the voltage generation circuits 11.

The output open function refers to a function in which, by turning the switches SW off (into a high impedance), it is possible to apply different voltages to output terminals of the power supply circuit 12. For example, by making Vdd equal to 5V, and turning off the switch SW2 of a Vdd output terminal, it is possible to apply a voltage of 7V to the Vdd output terminal. By making Vss equal to −3V, and turning off the switch SW1 of a Vss output terminal, it is possible to apply a voltage of −5V to the Vss output terminal.

A configuration is such that an off-state leakage current is 10 μA or lower when an external voltage is applied to each terminal by turning off the switch SW of each terminal. This configuration can be realized by employing a circuit configuration in which a voltage is applied, via a buffer circuit, to a gate terminal of an FET configuring each switch SW.

The switch SW1 has a function of turning the Vss voltage off (into a high impedance). The switch SW2 has a function of turning the Vdd voltage off (into a high impedance), and the switch SW3 has a function of turning the Avdd voltage off (into a high impedance). The switches are configured of analog switches, MOS switches or the like.

In the same way, the switch SW4 turns the logic voltage Dvdd used in the source drive circuit 24 off (into a high impedance), and the switch SW5 turns the VGH voltage off (into a high impedance). The switch SW6 has a function of turning the VGL voltage off (into a high impedance).

The switches (SW1 to SW6) do not have to clearly form a switch circuit. For example, by stopping an oscillation voltage applied to the Vdd generation circuit 31b, in a case in which the Vdd output is equivalently turned off, there is no need for a physical formation of the switch SW2. That is, it is also acceptable to consider that the switches SW are a function of stopping an operation of each voltage generation circuit 11.

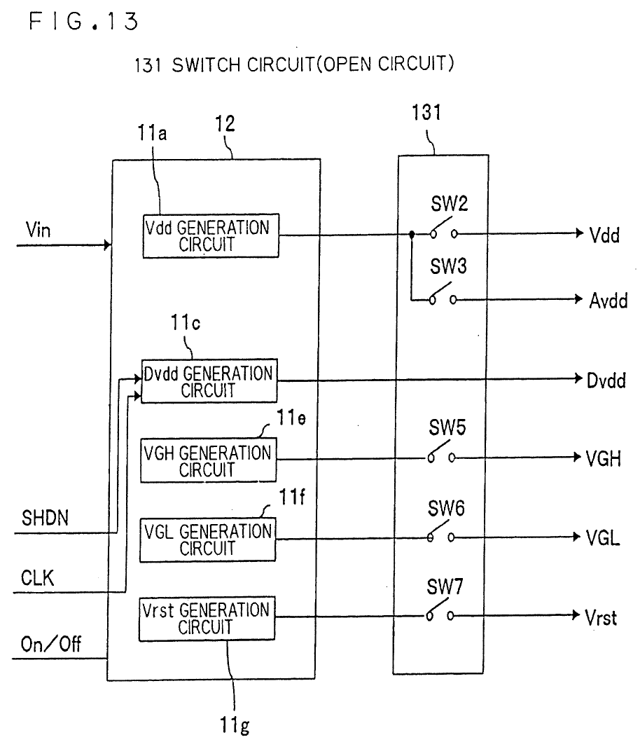

The transistors (FET's) being provided on the power supply voltage output circuit, a predetermined voltage is generated by resonating the FET's by means of the switches configured of the FET's, the diodes and the external coils (Ln and Lp). By applying the off voltage to the gate terminals of the resonated FET's, or turning them off, no voltage is transmitted from the FET's. As a result, the output terminals of the relevant power supply circuit 12 are turned off (into a high impedance). It is also acceptable that the diodes are turned off by applying a reverse bias to the diodes embedded in the power supply circuit 12. Also, it is also acceptable that a switch circuit 131 is externally disposed outside the power supply circuit 12, as shown in FIG. 13. The switches SW can also be configured of a relay circuit or the like.

Also, the off voltage is applied to the gate terminals of the transistors in the output stages of the power supply circuit 12, causing a high impedance between the channels of the transistors. Protective diodes being formed in the output stages of the power supply circuit 12, the protective diodes are connected to a sufficiently high voltage in such a way that no leakage occurs, maintaining an off condition.

The output open function is not limited to being embedded in the power supply circuit 12. For example, as shown in FIG. 13, it is also acceptable to provide the SW portions separately as the switch circuit 131. The switch circuit 131, being formed of silicon chips, is mounted on a flexible substrate or the like. The switch circuit 131 is configured of MOS-FET's or the like.

That is, it is sufficient that the turning off function (the function of causing the high impedance) of the embodiment is equivalently a function of causing a high impedance condition when looking at the terminals of the power supply circuit 12 from outside. Also, it is sufficient that a configuration is such that, when the high impedance condition is caused, or when the high impedance occurs, different voltages can be externally applied to the terminals of the power supply circuit 12.

### 7-2. Voltage Setting

The power supply circuit of the embodiment has the built-in, negative power source side diodes and EFT's. The power supply circuit, including a standard data bus such as an SMBus, can set output voltages or the like by means of a command transmitted to the standard data bus.

The voltages which can be set by means of the command are the VGH voltage, the VGL voltage and the Vss voltage. A configuration is such that these voltages can be set every 0.5V. It is also acceptable to generate two kinds of voltage, VGH1 and VGH2, for VGH, and generate two kinds of voltage, VGL1 and VGL2, for VGL.

A variation of the voltages can be easily realized by providing a DA conversion circuit inside the power supply circuit 12. Also, the output open function can also be controlled by means of the command. For example, the Vss voltage terminal can be turned off by a command control via the standard data bus (the SMBus, an I2CBus or the like). Which switch is to be turned on or off is designated by means of the command.

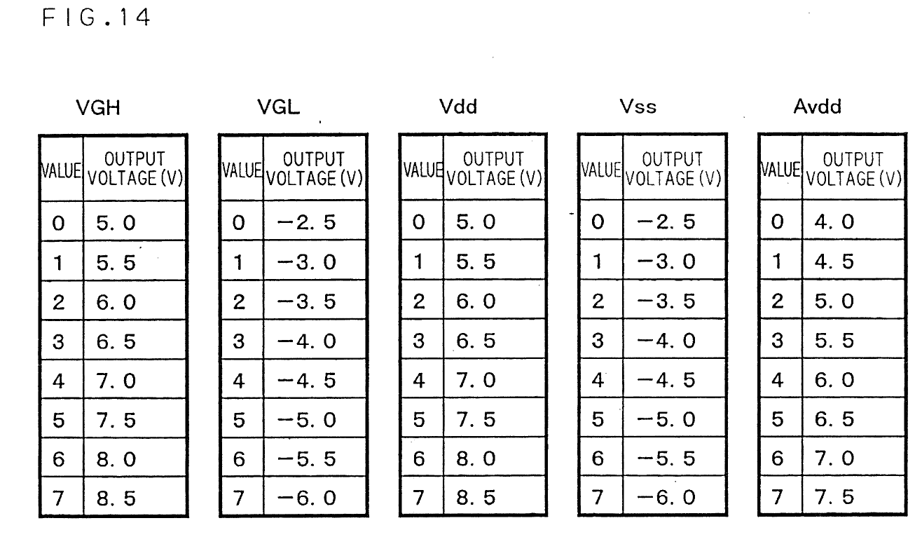

FIG. 14 shows setting values of the VGH voltage, VGL voltage, Vdd voltage, Vss voltage and Avdd voltage. The setting values are set every 0.5V in accordance with command ‘values’. A configuration is such that the setting value of the VGH voltage can be set to be higher than the Avdd voltage by 1.0V or more (at least 0.5V or more). A configuration is such that the setting value of the VGL voltage can be set to have the same value as the Vss voltage.

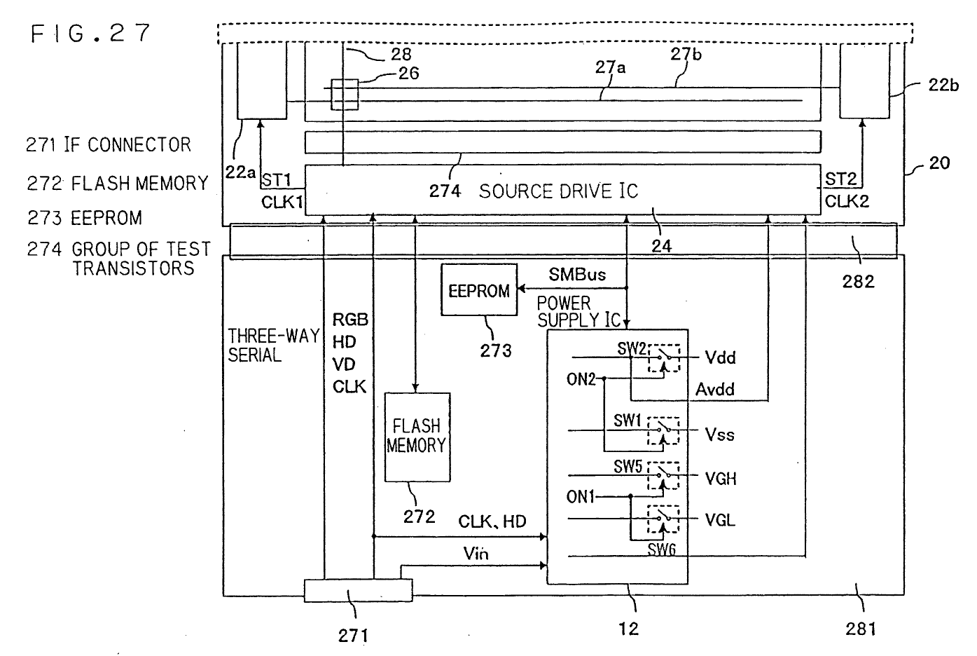

It is preferable to configure in advance in such a way that the values of the voltages in FIG. 14, being stored in an EEPROM 272 (FIG. 27), can be changed in accordance with a use condition. For example, in FIG. 14, although the output voltage is 5.0V at a value 0 of VGH, this value is retrieved from the EEPROM 272, and changed to 4.5V. It is preferable to configure in advance in such a way that the step value can also be changed by means of data stored in the EEPROM 272.

The VGH voltage, VGL voltage, Vdd voltage, Vss voltage and Avdd voltage are varied and used in a panel adjustment process of the embodiment. Also, they are varied and used in a peak current suppression drive.

The VGH voltage being 5.0V to 9V, this range can be set every 0.5V. Also, it is also possible to configure in such away that this range can be set on scale of 10 mV when necessary. The heretofore described item applies to other voltages in the same way. In the embodiment, in order to facilitate description, the voltage step value is taken to be basically 0.5V. However, this is not limiting.

As one example, the VGL voltage being −6.0V to −0.5V, this range can be set every 0.5V. The Vss voltage being −0.6V to −0.5V, this range can be set every 0.5V.

### 7-3. Modification Example of Output Open Function

It is also acceptable that the output open function is turned on or off by means of a control by hard terminals. For example, a first pin of the power supply circuit 12 is taken as TEST1, and a second pin as TEST2. By setting TEST1 to ‘H’, the Vdd terminal and the Vss terminal take on an output off condition. Also, by setting TEST1 to ‘L’, the Vdd terminal and the Vss terminal take on a voltage output condition. By setting TEST2 to ‘H’, the VGH terminal and the VGL terminal take on the output off condition. By setting TEST2 to ‘L’, the VGH terminal and the VGL terminal take on the voltage output condition.

The output open function mainly meaning a condition in which the voltage output terminals are separated from an exterior, even in the event that a voltage or current from another power supply is applied to the terminals or the like, the current from the other power supply does not flow into the power supply IC 12 or the like. Alternatively, it means a condition in which the current from the other power supply does not flow out, or a condition similar to this.

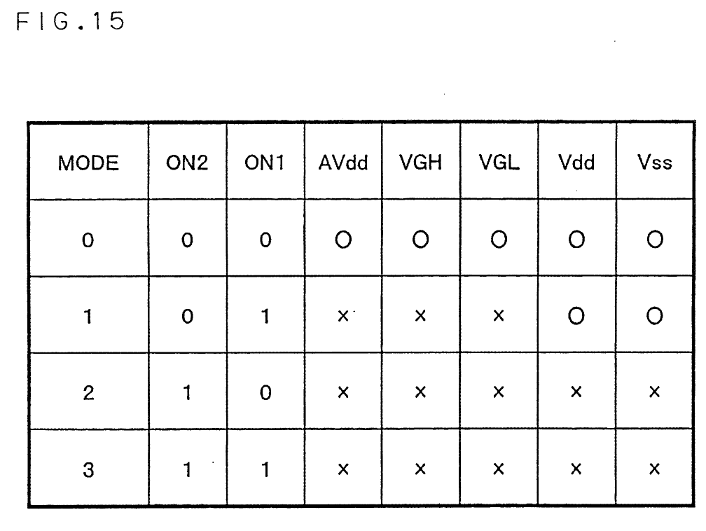

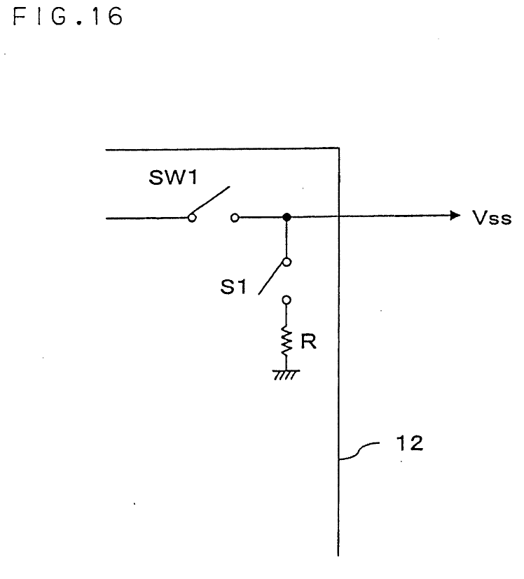

A configuration is such that, by setting logic voltages to a plurality of pins, the VGH voltage can be set at any one of 5.0V to 8.0V, and transmitted from the terminals. FIG. 15 illustrates a relationship between a TEST mode output voltage and a discharge circuit (FIG. 16).

The discharge circuit is formed for an output of each power supply. The discharge circuit is shown in FIG. 16. FIG. 16 shows a Vss output stage as one example, but the discharge circuits are also formed in the other output stages Vdd, Avdd, VGH and VGL. In a case in which the off switch SW1 is off, by turning on a switch S1, an electric charge charged in the Vss terminal is discharged via a resistor R. A resistance of the resistor R is taken to be 30 to 100Ω for outputs (Vss and Vdd) relating to the DCDC circuit. It is taken to be 20 to 1 kΩ for outputs (VGH and VGL) relating to the charge pump circuit. In the way heretofore described, the value of the resistor R is made greater for a voltage generated by the charge pump circuit than for a voltage generated by the DCDC circuit.

The switch S1 configuring the discharge circuit is also configured in such a way as to operate by means of the command setting. That is, whether or not to cause a discharge operation can be set by means of the command.

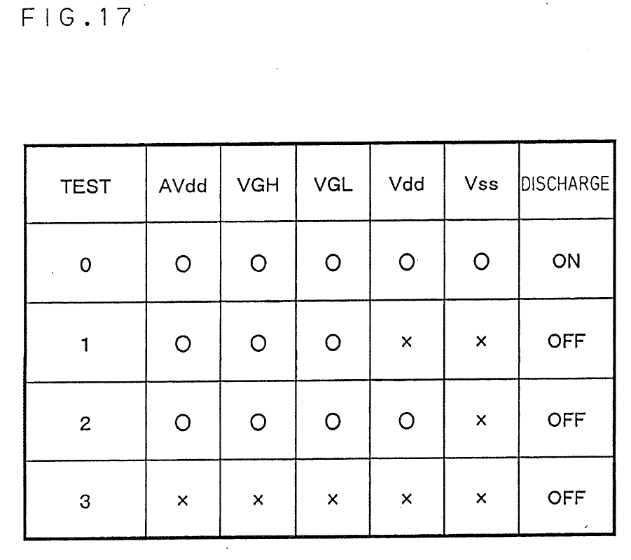

Also, it is also acceptable that Avdd is not discharged when TEST=3, as shown in FIG. 17. In FIG. 15, in MODE 0, the output terminals of all the voltages (Avdd to Vss) are maintained in a discharge condition. This matter is also important in protecting the EL display device from an external noise. Also, when only an ON1 command in MODE 1 is designated, it is also important to maintain the Vdd terminal and the Vss terminal in the discharge condition.

In the case of the ON1 command alone, the terminals of the voltages (Avdd, VGH and VGL) used in the source drive circuit 24 and the gate drive circuits 22 are not caused to discharge, while the terminal of the voltage applied to the EL element 35 is caused to discharge. None of the voltage terminals discharge when the ON1 and ON2 commands occur (MODE3).

A start-up of the power supply circuit (power supply IC) 12 is controlled in such a way that a rush current does not flow due to an operation or behavior of a soft start circuit. A soft start time is set at a time of 3 msec to 20 msec.

Also, an overcurrent protection circuit and a thermal shutdown circuit are formed in the power supply circuit (power supply IC) 12. A time for which the overcurrent protection circuit operates is set at a time of 50 msec to 200 msec.

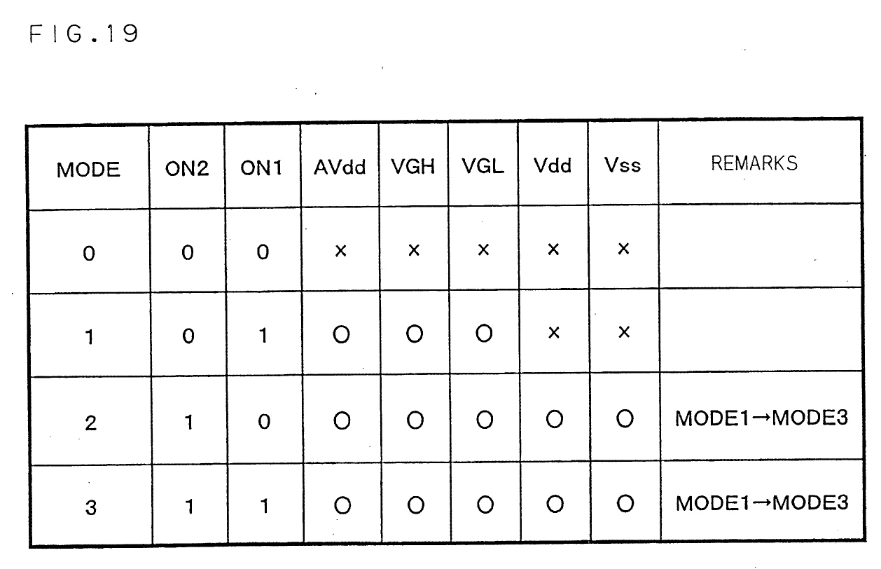

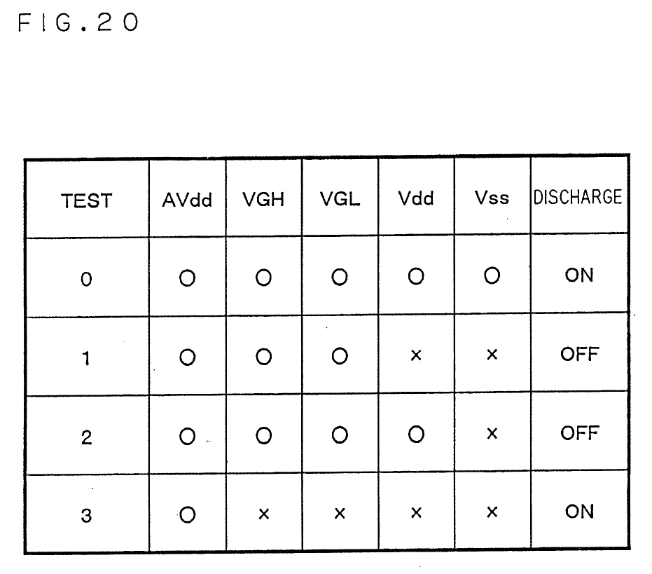

As heretofore described, the discharge is operated even in the TEST condition of FIG. 17. TEST 0 is in a normal operating condition. Regarding the outputs of Avdd, VGH, VGL, Vdd and Vss, the discharge circuit operates (the discharge circuit ON) in accordance with MODE's of FIG. 19. In TEST 1, TEST 2 and TEST 3, the discharge circuit does not operate (the discharge circuit OFF: a non-operating condition). As shown in FIG. 20, it is also acceptable, in TEST 3, to place the discharge circuit in an operable condition.

As shown in FIG. 16, the discharge circuit is configured of the switch S1 and the discharging resistor R. The discharging resistor R is used to discharge an electric charge charged in a terminal or wiring (in FIG. 16, the Vss terminal or Vss wiring as one example). The switch S1 operates when stopping an output voltage of the power supply voltage 12, or when changing a value of the power supply voltage.

### 8. Oscillating Frequencies of DCDC Circuit

In the power supply circuit 12 of the embodiment, oscillating frequencies of the DCDC circuit can also be set by means of the command from the source drive circuit 24.

Regarding the oscillating frequencies, one frequency is selected from a plurality of frequencies 0.6 MHz, 1.2 MHz and 1.8 MHz. An arrangement is such that the oscillating frequencies can be set at integral multitudes of 0.6 MHz, 1.2 MHz and 1.8 MHz. One of the oscillating frequencies is set within a range of 1.0 to 1.5 MHz (in the embodiment, 1.2 MHz applies).

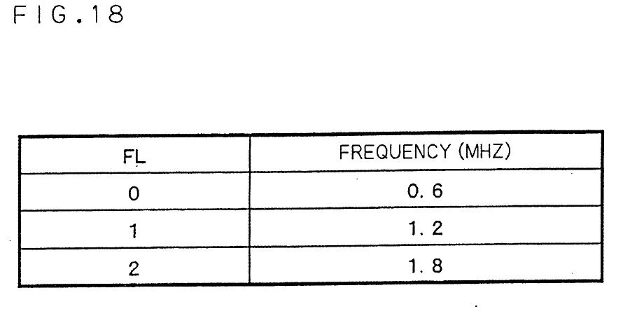

The oscillating frequencies are shown by the table in FIG. 18. The oscillating frequencies can also be easily actualized by selecting one from a plurality of resistors embedded in the power supply circuit. The oscillating frequencies can be changed by setting an FL command. When the oscillating frequency is low, a size of the external coils (Lp and Ln) of the power supply circuit increases. A conversion efficiency becomes higher. The size of the external coils of the power supply circuit increases. The conversion efficiency becomes higher. When the oscillating frequency is high, the size of the external coils of the power supply circuit decreases. The conversion efficiency often becomes lower.

The power supply circuit of the embodiment is used in a portable telephone. In the embodiment, the oscillating frequencies are switched and used depending on a communication system of the portable telephone. In a case of a CDMA system, the oscillating frequency of DCDC is taken as 0.6 MHz. In a case of a GSM system, the oscillating frequency is used at 1.2 MHz. In the embodiment, in the case of using the oscillating frequency in the CDMA system, and in the case of using it in the GSM system, the oscillating frequency is changed by means of the command. That is, the oscillating frequency is switched in response to a reception system of the portable telephone.

### 9. Test Modes

FIG. 15 shows test modes (TEST) which are operation modes of the power supply circuit of the embodiment, in which are described an existence or otherwise of the operation of the discharge circuit. In FIG. 15, “o” indicates that a corresponding voltage is transmitted, and “x” indicates that no corresponding voltage is transmitted. ON indicates that the discharge circuit is operating (in FIG. 16, the switch S1 is on), and OFF indicates that the discharge circuit is in the non-operating condition (in FIG. 16, the switch S1 is off).

For example, in a TEST mode value 1 (a setting value 1), Avdd, VGH, VGL, Vdd and Vss are being transmitted, indicating that the discharge circuit is on. In a TEST mode value 2 (a setting value 2), Avdd, VGH and VGL are being transmitted, indicating that the discharge circuit is off.

### 10. Start-Up Sequence and Shutdown Sequence

As shown in FIG. 19, there are MODE's in the power supply circuit 12 of the embodiment.

MODE's are for carrying out a start-up and shutdown sequence of the power supply circuit 12. In order to carry out the sequences, there are ON1 and ON2.

In MODE=0 (a value of a MODE command is 0, MODE 0), both ON1 and ON2 are 0 (off).

In MODE=1 (the value of the MODE command is 1, MODE 1), ON1=1(on), and ON2=0 (off).

In MODE=2 (the value of the MODE command is 2, MODE 2), ON1=0 (off), and ON2 is 1 (on). In MODE=3 (the value of the MODE command is 3, MODE 3), both ON1 and ON2 are 1 (on). In FIG. 19, “o” indicates that a corresponding voltage is being transmitted, and “x” indicates that no corresponding voltage is being transmitted.

In ON1=1, the power supply voltages (Avdd, VGH and VGL) of the source drive circuit 24 and gate drive circuits 22 are started up. In ON2=1 (on), the anode voltage Vdd and the cathode voltage Vss are supplied to the EL display device.

In the start-up sequence, in the embodiment, ON1 is set, and then ON2 is set. In the start-up sequence, after the gate drive circuits 22 and the source drive circuit 24 are operated first, the anode voltage and the like supplied to the EL element 35 are applied. When this condition is inverted, an unnecessary emission condition occurs in the EL display device.

In the shutdown sequence, in the embodiment, ON2 is cancelled (ON2=0), and then ON1 is cancelled (ON1=0). In the shutdown sequence, unless the voltages of the gate drive circuits 22 and source drive circuit 24 are turned off after the anode voltage Vdd and the cathode voltage Vss are cut off first, there is a case in which the source drive circuit or the like is broken due to a backward flow into the source drive circuit 24 from the anode terminal.

For the heretofore described reason, the condition of MODE=2 must not be caused to occur. In the start-up sequence, in the event that MODE=3 comes first due to a noise or the like, firstly, MODE 1 is set, and MODE 3 is executed. Also, in the start-up sequence, in the event that MODE=3 comes first due to a noise or the like, firstly, MODE 1 is set, and MODE 3 is executed. As heretofore described, the invention has a built-in logic which is self-corrected in the event that each operation occurs due to an abnormal condition.

In the case of the shutdown sequence, the condition becomes MODE 1, in which ON2=0, from the condition of MODE 3, and finally becomes MODE 0.

In MODE 0, all the output voltages are off. In MODE 1, the analog voltage Avdd of the source drive circuit 24, and the voltages (VGH and VGL) of the gate drive circuits 22, are in an on condition, while the anode voltage Vdd and the cathode voltage Vss are in an off condition. In MODE 2 and MODE 3, the analog voltage Avdd of the source drive circuit 24, and the voltages (VGH and VGL) of the gate drive circuits 22, are in the on condition, and the anode voltage Vdd and the cathode voltage Vss are in the on condition. However, MODE 2 is in a setting forbidden condition.

FIG. 20 shows setting conditions of the discharge operations (refer to FIG. 16) with respect to MODE's. In FIG. 20, “o” indicates that a discharge operation is being carried out (as in FIG. 16, a corresponding switch S (in FIG. 16, the switch S1) is on). “x” indicates that the switch S is off (no discharge operation is being carried out).

In MODE 0, as all the output voltages are off, all the terminals are in a discharged condition. In MODE 1, as the analog voltage Avdd of the source drive circuit 24, and the voltages (VGH and VGL) of the gate drive circuits 22, are in the on condition, and the anode voltage Vdd and the cathode voltage Vss are in the off condition, only the anode voltage Vdd and the cathode voltage Vss are in the discharged condition. In MODE 2 and MODE 3, the analog voltage Avdd of the source drive circuit 24, and the voltages (VGH and VGL) of the gate drive circuits 22, are in the on condition, and the anode voltage Vdd and the cathode voltage Vss are in the on condition. Consequently, the discharge of all the outputs is in a non-operating condition. MODE 2 is in the setting forbidden condition.

As heretofore described, by placing the terminals from which no voltage has been transmitted in the discharged condition, it is possible to prevent an unnecessary operation or malfunction of the EL display device, as well as preventing the EL display device from being electrically broken.

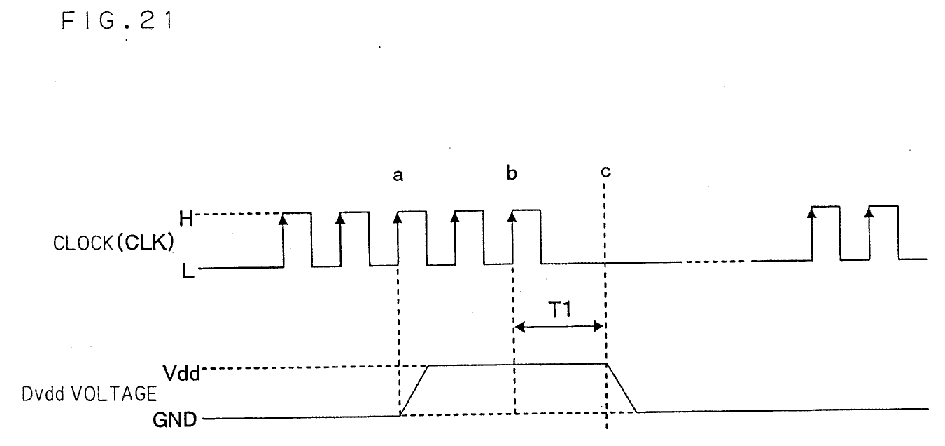

An on/off terminal is a terminal which starts up the power supply circuit. On a clock signal being applied to the on/off terminal, the Dvdd voltage is transmitted. Regarding the clock signal, its rise and decay are detected and, on detecting a plurality of rising or trailing edges of the clock signal, the logic voltage Dvdd is transmitted (refer to FIG. 21).

An image signal clock or a horizontal synchronization signal HD, which is applied to the EL display device of the embodiment, is used as the clock signal. The image signal is generated by a graphic controller of an instrument in which is incorporated the EL display device of the embodiment.

As shown in FIG. 21, a rise of a clock (CLK) signal is detected, and a counter 221 inside the power supply circuit 12 is added to (refer to FIGS. 21, 22 and 24). On three clocks being counted, the Dvdd voltage is transmitted. A configuration is such that a number of clocks required until this start-up of the power supply can be set by means of the command. In FIG. 21, as there are three clocks at a point a, Dvdd is transmitted. Of course, regarding the detection of the clock signal, it is also acceptable to detect a trailing edge of the clock. Also, it is also acceptable to detect both edges of the clock. When a clock interval is equal to or shorter than a certain interval, there is no count. This is set by a low-pass filter embedded in the power supply circuit 12.

When the clock is cut off for a certain period, an output of the Dvdd voltage is stopped. In FIG. 21, when a T1 period is 30 msec or more, the output is stopped. At the same time, a count value of the counter 221 is cleared. Consequently, the count of the counter 221 starts from 0.

In the example of FIG. 21, an arrangement is such as to turn on or off (transmit and stop) the Dvdd voltage by means of the clock, but this is not limiting. It is also acceptable to, for example, on or off control the Vdd and Vss voltages and the VGH and VGL voltages. Also, it is also acceptable to configure in such a way that voltages such as the VGH and VGL voltages, transmitted by a charge pump required in the gate drive circuits 22, are transmitted at a third clock, and DCDC voltages such as Vdd and Vss, supplied to the EL element 35, are transmitted at a 30th clock.

The shutdown is also done in the same way. It is also acceptable to configure in such a way that DCDC voltages such as Vdd and Vss, supplied to the EL element 35, are stopped in 30 msec, the discharging circuit (refer to FIGS. 16 and 20) is operated at the same time and, after 100 msec, the VGH and VGL voltages and the like are stopped by the charge pump required in the gate drive circuits 22 (the discharging circuit is operated at the same time). That is, the voltage output is controlled by means of the number of clocks or the clock interval.

The Dvdd voltage is a logic voltage of the source drive circuit 24. On the Dvdd voltage being started up, a power source of the I2CBus is supplied, enabling a command communication between the source drive circuit 24 and the power supply circuit 12. The source drive circuit 24 transmits an on sequence command (an on command) to the power supply circuit 12 via the I2CBus, and the power supply circuit 12 transmits the other voltages (VGH, VGL, Vss, Vdd and the like).

The shutdown of the power supply circuit 12 (the stop of the voltage output) is carried out by means of an off sequence command (an off command) issued from the source drive circuit 24 to the power supply circuit 12. The power supply circuit 12 also takes on the off condition by the clock signal (CLK) shown in FIG. 21 being interrupted.

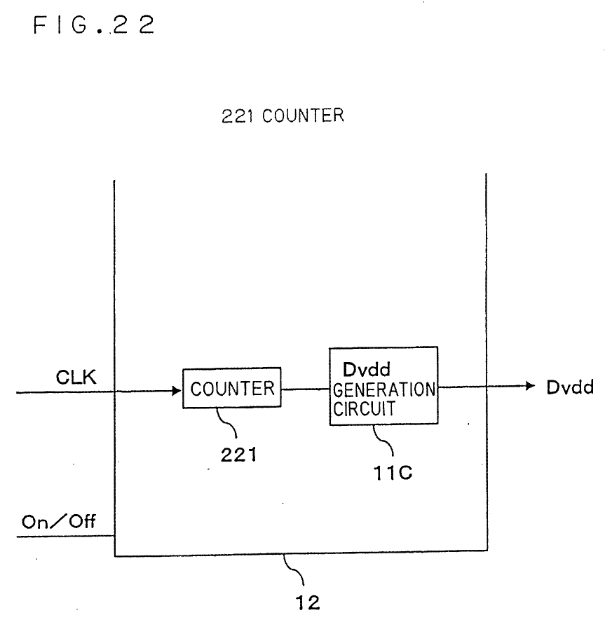

The Dvdd voltage is the logic voltage used in the source drive circuit 24. Firstly, when the logic voltage is not input first, a logic operation of the source drive circuit 24 is not started, and a start sequence of the EL display device is not implemented. However, when a Dvdd voltage generation circuit 11c remains activated at all times (even when the EL display device is not used), power is consumed. By configuring in such a way as to start up the Dvdd generation circuit by means of the clock, as in FIGS. 21 and 22, there is no unnecessary power consumption. Also, by configuring in such a way as to put the Dvdd circuit into the non-operating condition unless the clock is input for a certain period, there is no unnecessary power consumption.

In the example of FIG. 21, an arrangement is such that the Dvdd voltage is started up by means of the input of the clock but, the embodiment not being limited to this, it is also acceptable to start up another output voltage such as the Avdd voltage. Also, it is desirable to configure in such a way that a number of clocks with which the voltage is started up can be set by means of the command or the like. It is preferable to configure in such a way that the shutdown time T1 can also be set by means of the command or the like.

Also, it is preferable to configure in such a way that the value of the counter is cleared in a case in which there is no clock for a certain time or more. For example, a configuration is such that, even in the event that two clock signals (CLK) are input, when an interval up to a third clock signal (CLK) is 20 msec or more, the counter inside the power supply circuit 12 is cleared, and the counter is returned to 0. Also, in a case too in which the power supply circuit 12 accepts the off sequence, the counter is cleared. A configuration is such that a time required until the counter is cleared can be set by means of the command.

It is assumed that a vertical synchronization signal is used as the clock for a time T1 required until the counter is cleared. Consequently, in a case of 30 frames, it is necessary to take 35 msec or more. Also, in order to prevent a malfunction of the count up due to a noise, it is necessary to take 100 msec or less (0.1 Hz). Also, the display device is configured in such a way as to operate by means of a main clock of the image signal. In the event that an image clock of the display device is 3 MHz, the display device is configured in such a way as to operate at 3 MHz. However, when the display device is configured in such a way as to operate by means of too rapid a clock, it malfunctions easily due to an external noise. Consequently, the clock is taken to be 10 MHz or less. Consequently, the clock is taken to be 0.1 Hz to 10 MHz. It is preferable that the horizontal synchronization signal (HD) is used as the clock. The horizontal synchronization signal is around 8 KHz to 30 KHz. Consequently, the display device is configured in such a way as to operate by means of a clock of 8 KHz to 10 MHz.

Also, in order to prevent a malfunction due to an abnormal clock (the external noise) in a short time, a low-pass filter is formed by means of a capacitor or the like.

When the power supply IC 12 is turned off, the counter 221 is cleared. Also, it is cleared when a software reset or hardware reset of the EL display device is input. Also, when the power supply IC 12 is turned on, the counter is cleared to default.

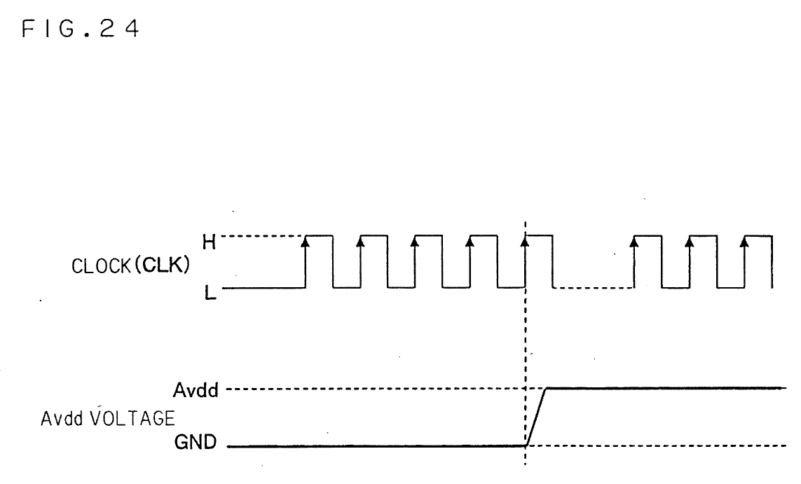

Also, it is also acceptable to configure in such a way that the Dvdd voltage is transmitted by means of three clock signals (CLK) and, as shown in FIG. 24, the Avdd voltage is transmitted by means of five clock signals (CLK). That is, a configuration is such that a start-up voltage can be designated depending on a number of clock signals (CLK). It is also acceptable to configure in the same way for a shutdown voltage too. It is preferable that a number of clocks counted and set is two to five. This is for the purpose of preventing the malfunction due to the noise, and shortening a start-up time.

Also, it is also acceptable to configure in such a way that, after the count has once reached a regulation value, the voltage output is not stopped unless a reset signal is input into the power supply circuit 12 from the source drive circuit 24.

As shown in FIG. 12, the Dvdd voltage is generated using a regulator 121. When the regulator 121 is in an operating condition, a leakage current flows, consuming power. No leakage current occurs in the event of configuring in such a way as to detect a clock and start up the regulator 121, as in FIGS. 21 and 22. Consequently, when the EL display device is in the non-operating condition, no power is consumed.

The power supply circuit 12 of the embodiment is configured in such a way that a voltage is transmitted by the on command being input when the clock signal (CLK) is being input. Also, the voltage output is stopped by the on command being input when the clock signal (CLK) is being input. Also, the output terminal is turned off.

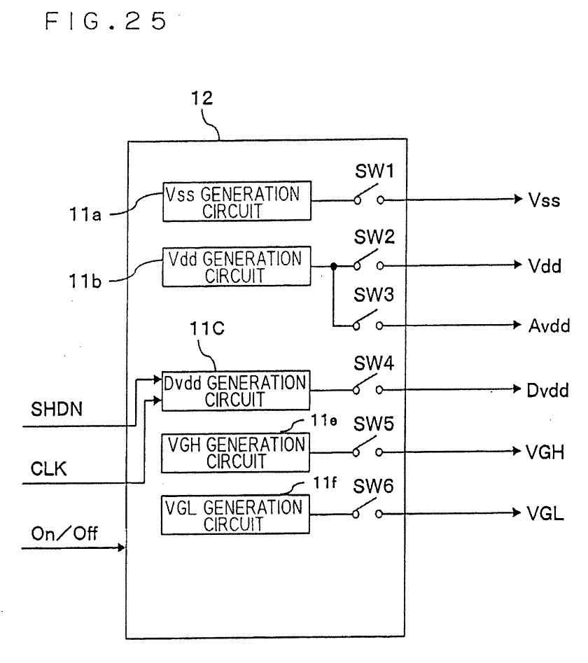

However, the embodiment is not limited to this. It is also acceptable to, for example, provide an on/off terminal (a hard pin) from which a voltage is compulsorily transmitted, as shown in FIG. 25.

### 11. Start-Up Sequence

Next, a description will be given of a start-up sequence, using FIG. 27.

When the horizontal synchronization signal (HD) or the main clock (CLK) is input into the power supply circuit 12, clocks are counted by the Dvdd generation circuit 11c (FIG. 22) and, when a regulation number of clocks is counted, a regulator of the Dvdd generation circuit operates. The regulator circuit regulates the input battery voltage Vin, and transmits 1.85V (1.8V system).

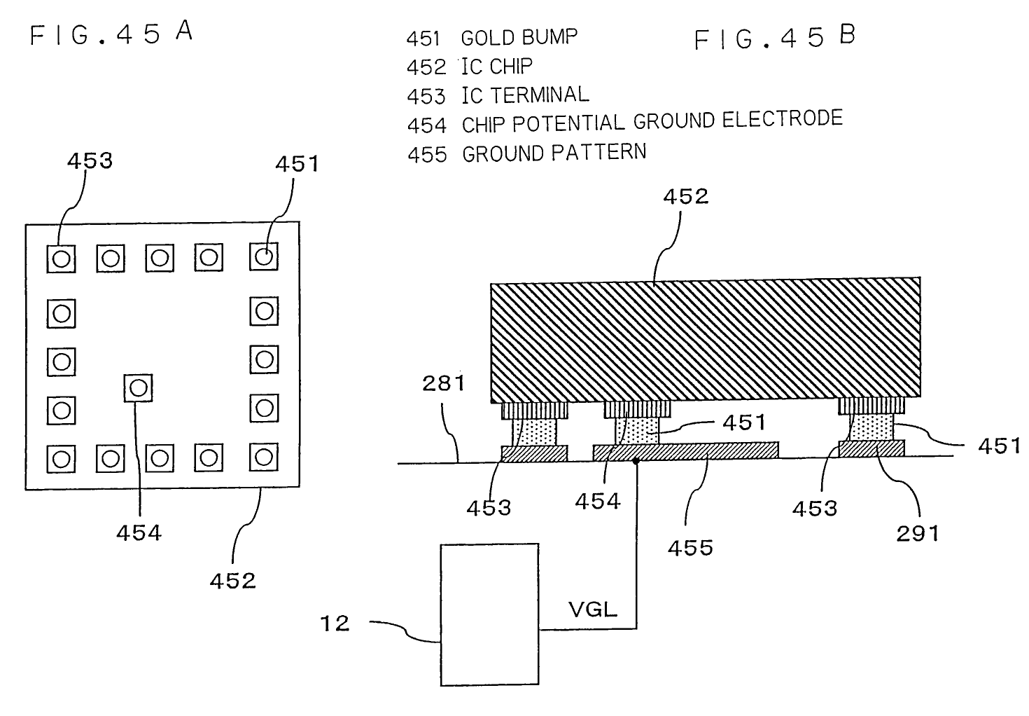

As heretofore described, a signal and a voltage, supplied to the power supply circuit 12 from a connector 271, are only CLK or HD and Vin. A panel 20 and a flexible substrate 281 are brought into electrical connection by an ACF 282. Consequently, even in the event that a power supply voltage outputted from the power supply circuit 12 is large, it does not happen that a cost becomes high. As shown in FIGS. 45A and 45B, the power supply circuit 12 is flip-chip mounted (COF mounted).

1.85V is a logic voltage of the source drive circuit 24 or the like. The logic voltage Dvdd is a power source of the SMBus, and a power supply voltage of the EEPROM 273 and flash memory 272. Consequently, by the Dvdd voltage being generated, a logic system of the EL display device is placed in a start-up condition.

When the logic voltage Dvdd is input into the source drive circuit 24, and a reset signal command is input into it from an external three-way serial bus, the source drive circuit 24 starts the start-up sequence.

When the source drive circuit 24 receives the reset signal command, and an initialization of the power supply circuit 12 is completed (in FIG. 19, MODE 0), the source drive circuit 24 sends the on command (ON1, ON2: FIG. 19) to the power supply circuit 12 via the SMBus. Basically, the on sequence is MODE 0 (ON1 and ON2 are off)→MODE 1 (only ON1 is on)→MODE 3 (ON1 and ON2 are on).

The AVdd voltage (the analog voltage of the source drive circuit 24), VGH and VGL are transmitted in response to the ON1 command. AVdd and the anode voltage Vdd being the same voltage (refer to FIG. 13, etc.), AVdd is transmitted by means of ON1 but, as SW2 is in the off condition, the anode voltage Vdd is not transmitted. SW2 is placed in the on condition by means of the ON2 command. In response to the ON1 command, VGH is transmitted by SW5 being turned on, and VGL is transmitted by SW6 being turned on.

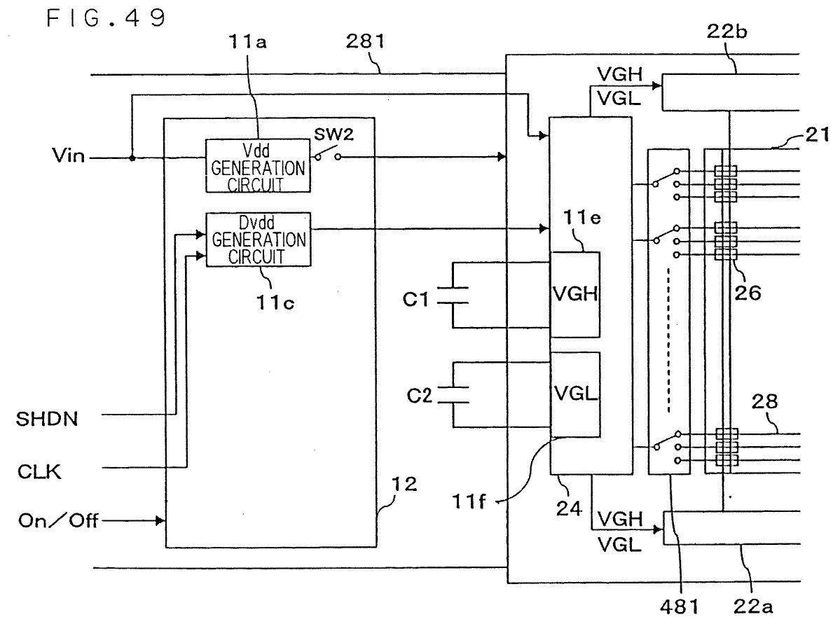

By the AVdd voltage being applied to the source drive circuit 24, it becomes possible that the circuits of FIGS. 10, 11, etc. are started up, and the gradation voltage or the like is transmitted. The VGH and VGL voltages are applied to the gate drive circuits 22 (refer to FIG. 49). A potential of the gate signal lines 27 of the gate drive circuits 22 is set based on the VGH and VGL voltages. Also, the source drive circuit 24 applies a start (ST) signal and the clock (CLK) signal to the gate drive circuits 22, and also applies an image voltage signal of a black gradation or the like to the source signal line 28, and the gate drive circuits 22 control the pixel 26 into the black display condition (refer to FIG. 2).

A transition time from the ON1 command (MODE 1 in FIG. 19) to the ON2 command (MODE 3 in FIG. 19) is taken to be one frame period or longer. Preferably, it is taken to be two frame periods or longer. This is done in order to apply the anode voltage Vdd and the cathode voltage Vss after placing the display screen 21 in the black display condition. This is because it may happen that an unnecessary image display is caused unless the anode voltage Vdd and the cathode voltage Vss are applied after the display screen 21 is placed in the black display condition.

Next, the source drive circuit 24 transmits the image signal to the source signal line 28 in response to the input image signal (RGB), horizontal synchronization signal (HD), vertical synchronization signal (VD) and clock (CLK).

The source drive circuit 24 sends the ON2 command to the power supply circuit 12. In response to the ON2 command, SW1 and SW2 are turned on, and the anode voltage Vdd and the cathode voltage Vss are applied to the display screen 21. By means of the application of the anode voltage Vdd and the cathode voltage Vss, an image is displayed on the EL display device.

Hereafter, the source drive circuit 24 obtains the illumination ratio from the image signal by, for example, calculating a current flowing through the display screen 21 (FIG. 69), and implements a duty ratio drive in such a way that a peak current is not exceeded (FIG. 57). Also, when necessary, the source drive circuit 24 sends a command to the power supply circuit 12, and changes the anode voltage Vdd and the cathode voltage Vss. In FIG. 57, the cathode voltage Vss is dropped (to a GND side) at an illumination ratio of 75% or more.

As shown in FIG. 19, in a case of a start with MODE 2 due to a malfunction, MODE 1 is executed, and then MODE 3 is executed. In a case of a start with MODE 3 due to a malfunction, MODE 1 is executed, and then MODE 3 is executed.

In the off sequence (the shutdown sequence), MODE 1 is executed. Before the execution of MODE 1, the source drive circuit 24 places the display screen 21 in the black display. The black display is realized by applying a black gradation signal (a low gradation) to the source signal line 28, and writing this signal to the pixel 26. After the black display, the source drive circuit 24 sends a command to the power supply circuit 12, and puts its condition into MODE 1 (turns off ON2).

In response to an off directive of the ON2 command, SW1 and SW2 are turned off, and the application of the anode voltage Vdd and cathode voltage Vss to the display screen 21 is stopped.

Next, the source drive circuit 24 sends a command to turn off ON1 to the power supply circuit 12 in order to put its condition into MODE 0.

A transition time from MODE 1 in FIG. 19 to MODE 0 in FIG. 19 is taken to be one frame period or longer. Preferably, it is taken to be two frame periods or longer. This is done in order to stop the gate drive circuit 22 after completely discharging the anode voltage Vdd and cathode voltage Vss from the terminals or the like. By turning the ON2 command off (into 0), SW2 and SW1 are turned off. At this time, the discharging circuit is operated as shown in FIGS. 16 and 20. This is because, unless the gate drive circuit is stopped after the anode voltage Vdd and the cathode voltage Vss are completely discharged, it may happen that an unnecessary image display is caused.

By turning off the ON1 command, SW5 and SW6 are turned off, and the AVdd voltage (the analog voltage of the source drive circuit 24), VGH and VGL are stopped. Finally, CLK or HD applied to the power supply circuit 12 is stopped, and Dvdd is stopped.

In the examples of FIGS. 13, 25, etc., the shutdown terminal (SHDN) is disposed. The SHDN terminal is a terminal which causes a voltage to be transmitted (or a terminal which causes a voltage not to be transmitted) when the on/off command is input, even in a condition in which no clock signal (CLK) is input. When the logic voltage applied to the SHDN terminal is of an L level, the power supply operation described in FIGS. 21 and 24 is implemented. When the logic voltage applied to the SHDN terminal is of an H level, the SHDN terminal comes to receive the on/off command even in a condition in which there is no clock signal (CLK). The shutdown terminal (SHDN), with 0 (GND) as a normal condition, is set to the Dvdd output condition by means of the external clock, and the shutdown terminal (SHDN) is at H, taking on a condition in which Dvdd is being transmitted although no clock is input.

The disposition of the shutdown terminal (SHDN) is effective in a case of using the power supply circuit 12 of the embodiment in an inspection process. In the inspection process (a point defect detection or a characteristic evaluation), the frame rate is reduced, or an image is displayed using test transistors 295. For this reason, there is a case in which there is no image signal (main clock or horizontal synchronization signal clock) used as the clock. Also, a clock period being very long, it reaches the T1 period shown in FIG. 21 or longer, stopping the voltage output. In this case, naturally, it is impossible to use the clock to turn on or off the voltage output. For this reason, in the embodiment, the voltage transmission is compulsorily controlled using the shutdown terminal (SHDN).

In FIGS. 13, 25, etc., the shutdown terminal (SHDN) is disposed only in the Dvdd generation circuit but, without being limited to this, it is also acceptable to dispose the shutdown terminal (SHDN) in another voltage generation circuit 11. Also, it is also acceptable to configure in such a way that a whole of the power supply circuit 12 can be on or off controlled by the shutdown terminal (SHDN).

### 12. Modification Example of Output Voltage of Power Supply Circuit 12

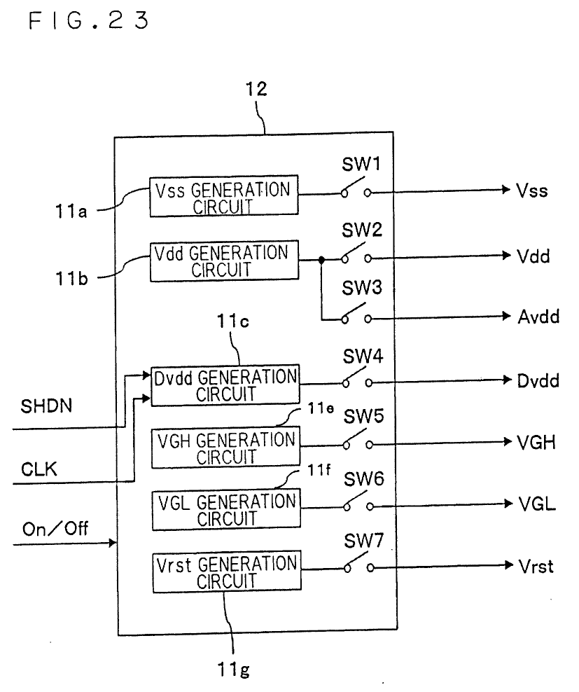

In the power supply circuit 12 of the embodiment, voltages to be transmitted are not limited to those of FIGS. 3, 25, etc. For example, as shown in FIG. 23, it is also acceptable to incorporate a reset voltage Vrst generation circuit 11g. Also, it is also acceptable that a predetermined voltage is generated by a Vdd voltage generation circuit lid, SW3 is turned on by means of the ON1 command (refer to FIG. 19) (at this time, SW2 is off), and both SW2 and SW3 are turned on by means of the ON2 command. In MODE 0 of FIG. 19, both SW2 and SW3 are off.

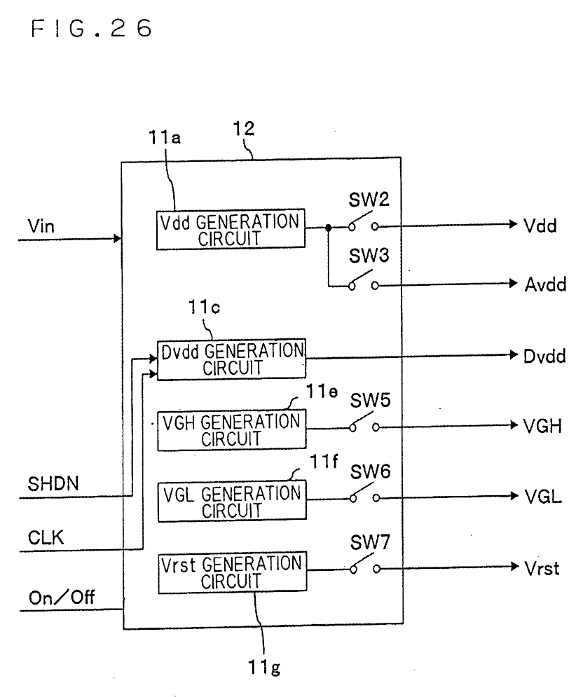

Also, a configuration is also acceptable in which there is no Vss voltage generation circuit, as shown in FIG. 26. In this case, the cathode voltage of the EL display device is the GND voltage. No switch is disposed for the output of the Dvdd voltage generation circuit 11c. This is because an output/non-output of Dvdd can be controlled by means of CLK or a logic signal of SHDN. Also, this is because, a control of each SW being carried out by the source drive circuit 24, unless there is a supply of the Dvdd voltage, the logic of the source drive circuit 24 does not operate, and it is impossible to generate an SW control command.

### 13. Modification Example of Power Supply Circuit 12

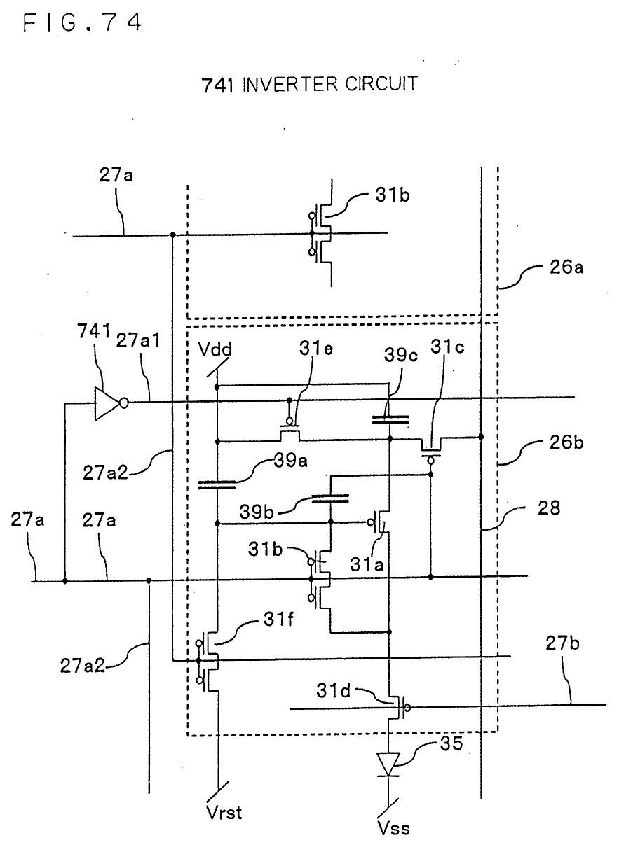

Also, in the embodiment, the power supply circuit 12 is described as an IC, but the embodiment is not limited to this. It is also acceptable to configure the power supply circuit 12 of, for example, discrete parts. The reset voltage Vrst is used in an EL display device having the pixel configuration of FIG. 74, or the like.

When Dvdd is started up, as well as a logic circuit of the source drive circuit 24 being started up, it becomes possible to send data to a standard data bus such as the SMBus. The source drive circuit 24, using the standard data bus (the SMBus or the like), sets values of voltages (VGH, VGL and Vss) transmitted by the power supply circuit. Also, it sets oscillating frequencies. Also, it causes Avdd (Vdd), VGH and VGL to be transmitted from the power supply circuit 12.

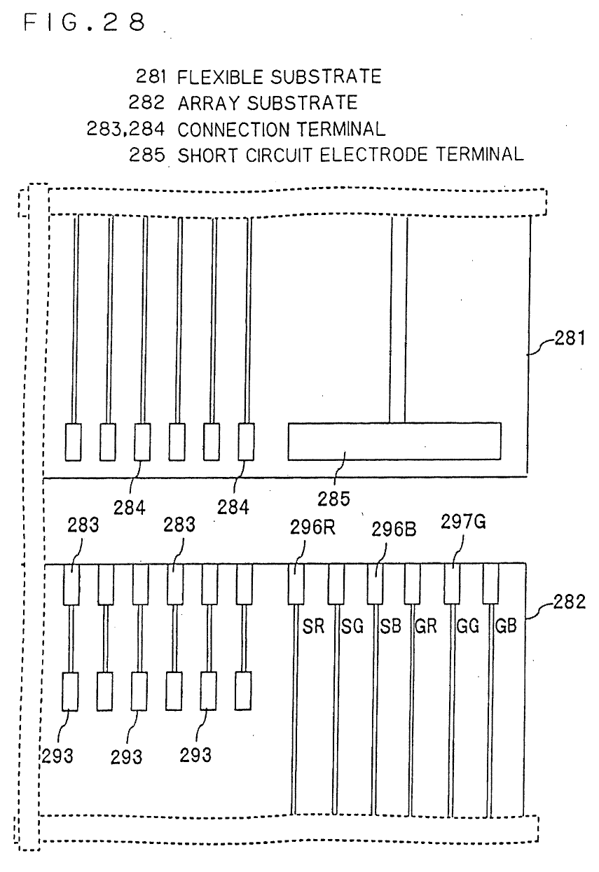

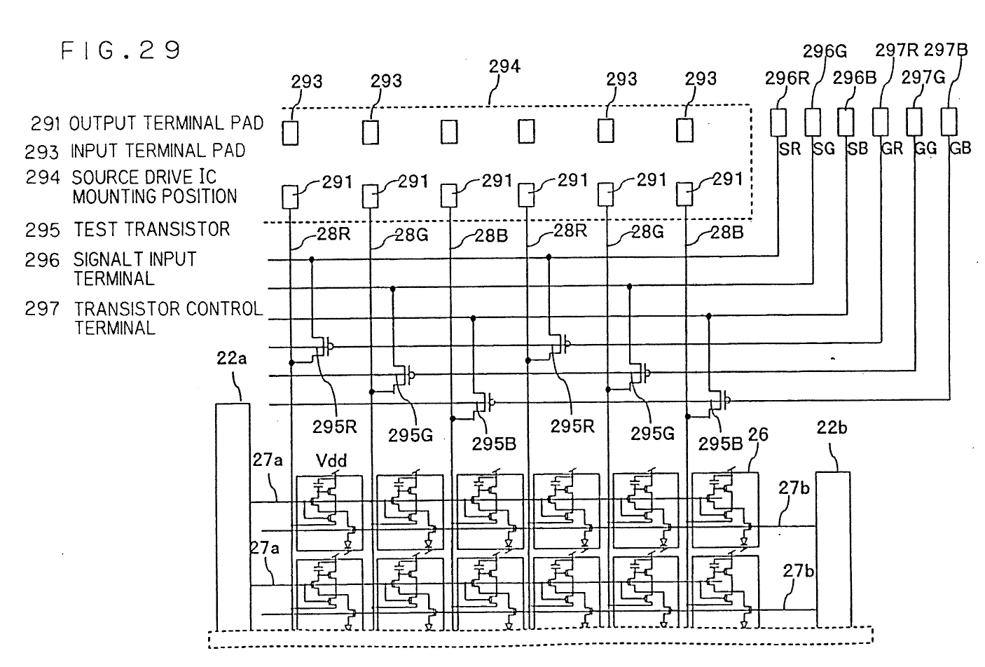

As shown in FIG. 27, the power supply circuit 12 is mounted on the flexible substrate 281 (refer to FIG. 28). In this condition, terminals (signal input terminals 296 and transistor control terminals 297) of an array substrate 282 are short-circuited by a short circuit electrode terminal 285 of the flexible substrate (FIG. 29, etc.). Also, the VGH voltage (an off voltage of the test transistors 295) is applied to the short circuit electrode terminal 285.

The power supply circuit 12, having a gold bump formed on each output terminal, is flip-chip mounted by means of ACF (a connection by an anisotropic conductive film).

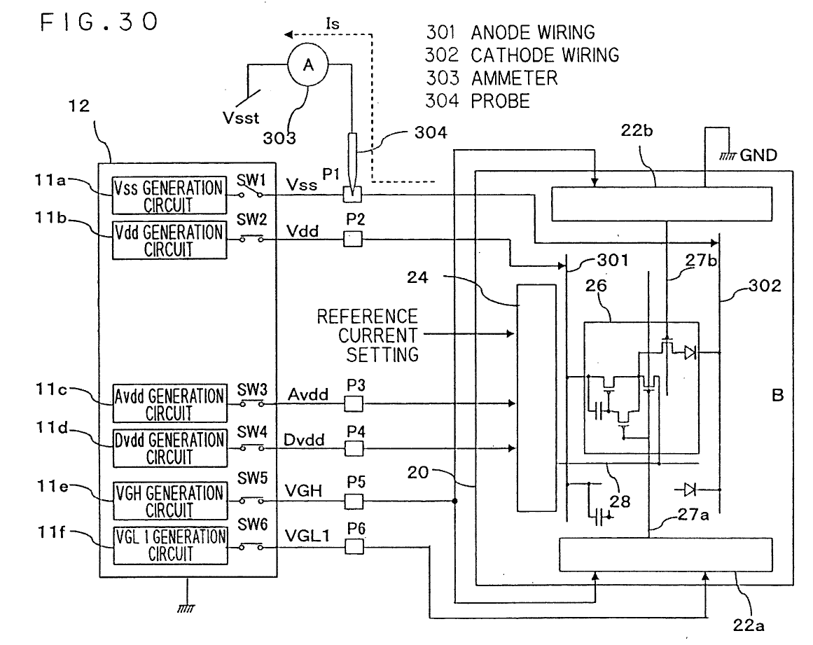

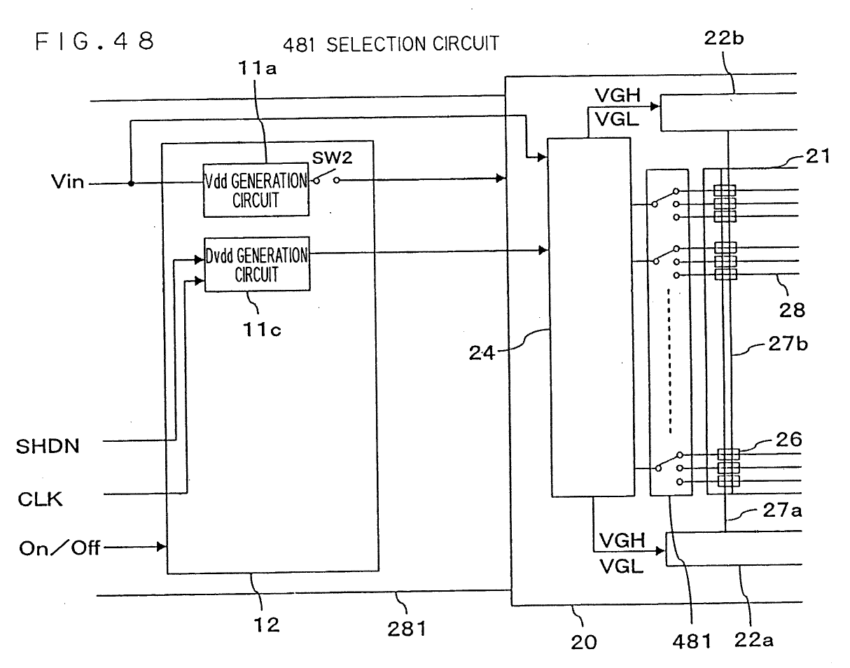

274 of FIG. 27 is a group of the test transistors. The test transistor 295 is formed in each source signal line 28. It is also acceptable to form the test transistors 295 on a side (in a B position) opposite to the side on which the source drive circuit 24 is mounted, as shown in FIGS. 30 and 31. The source drive circuit 24 not being limited to the IC, it is also acceptable that it is a source drive circuit formed by a low-temperature polysilicon technology or the like. Also, it is also acceptable to form a three-selection circuit 481 shown in FIG. 48, etc.

The switches SW3, SW4 and SW6 are not actually formed. Alternatively, they can be omitted. Dvdd=1.85V is transmitted in response to the clock signal of the image signal. Consequently, there is no need for the switches. Also, AVdd is also transmitted at the same time as an oscillation of the DCDC circuit. AVdd, as well as being an analog power source of the source drive circuit 24, becomes a power source voltage of the internal shift register of the gate drive circuits 22.

Each power source on/off control signal is sent to the power supply circuit 12 from the source drive circuit 24 by a standard data bus such as the SMBus or the I2CBus. A configuration is such that an operating speed of the SMBus and I2CBus is 10 KHz to 10 MHz.

The switch SW5 of VGH and the switch SW6 of VGL are turned on by means of the ON1 command. By the switches SW5 and SW6 being turned on, VGH and VGL (VGL1) are transmitted, and the gate drive circuits 22 are synchronized. The start pulses (ST1 and ST2), the clocks (CLK1 and CLK2), and up/down signals (UD), which are applied to the gate drive circuits 22, are controlled by the source drive circuit 24. Particularly, the internal shift register of the gate drive circuit 22b is cleared, and all the gate signal lines 27b are placed in a non-selection condition.

Next, the switch SW2 of Vdd and the switch SW1 of Vss are turned on by means of the ON2 command. By the switches SW1 and SW2 being turned on, the anode voltage Vdd and the cathode voltage Vss are transmitted.

The voltage Vin from the battery of a main body is supplied to the power supply circuit 12. The Vin voltage is supplied to the power supply circuit 12 via the connector 271. The power supply circuit 12 generates the voltages (the anode voltage Vdd, the cathode voltage Vss, VGH, VGL, AVdd, Dvdd=1.85V), necessary for the EL display panel, from one Vin voltage. The flexible substrate 281 and the array substrate 282 are brought into the ACF (anisotropic conductive film) connection. That is, as the flexible substrate 281 and the array substrate 282 are bonded together, naturally, there is no need for a connector in order to apply the voltages transmitted by the power supply circuit 12 to the EL display panel.

### 13-1. Heretofore Known Problems

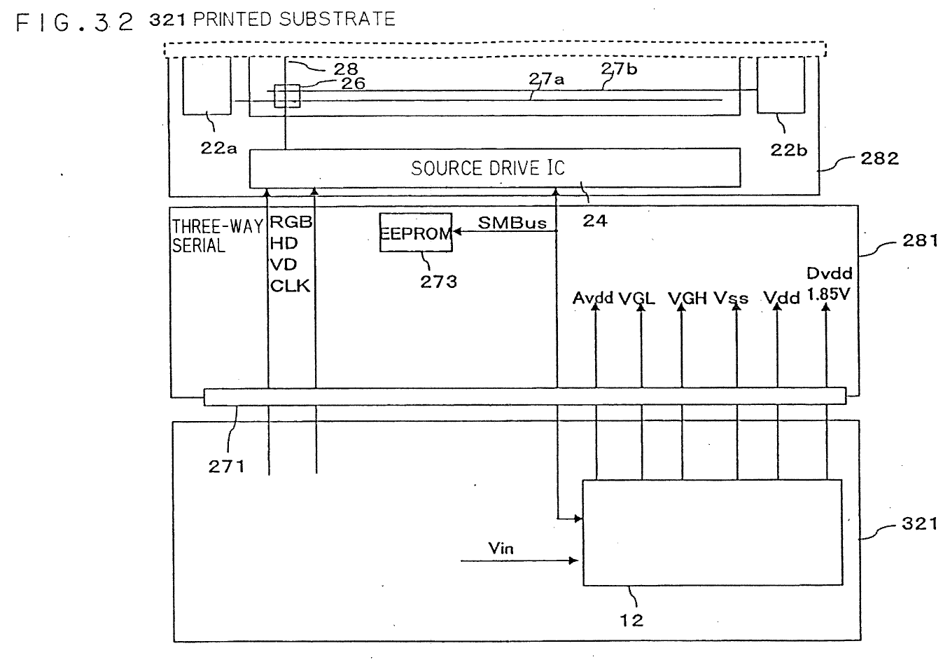

FIG. 32 is a configuration diagram of a heretofore known EL display device. The flexible substrate 281 and the array substrate 282 are brought into the ACF connection. The power supply circuit 12 is mounted on a printed substrate 321 of the main body. The battery voltage Vin is applied to the power supply circuit 12. The power supply circuit 12 generates the voltages (the anode voltages Vdd, the cathode voltage Vss, VGH, VGL, AVdd, and Dvdd=1.85V), necessary for the EL display panel, from one Vin voltage. The generated voltages (the anode voltages Vdd, the cathode voltage Vss, VGH, VGL, AVdd, and Dvdd=1.85V) are delivered to the flexible substrate 281 via the connector 271, and supplied to the EL display panel. Consequently, as there are many kinds of voltage generated by the power supply circuit 12, a necessary number of pins of the connector 271 becomes large. Also, the source drive circuit 24 transmits signals which turn on or off the power supply circuit 12. The connector also needs pins for these signals.

For the reason heretofore described, with a configuration in which the power supply circuit 12 of the heretofore known configuration is mounted on the printed substrate 321 of the main body, the necessary number of pins of the connector 271 is large in comparison with the configuration (FIG. 27) of the embodiment. Consequently, a contact failure is likely to occur, and a cost also becomes higher.

There is a certain range of variations in the voltages generated by the power supply circuit 12. For example, although Vdd=5.5V is taken to be an ideal value, a variation of about ±0.2V occurs. When the voltages transmitted by the power supply circuit 12 change, the emission luminance of the EL display panel changes. For example, a display luminance adjustment is carried out on the EL display panel at an anode voltage of 5.5V, which is the ideal value, by means of an adjustment method of the embodiment. However, in the event that the anode voltage Vdd transmitted by the power supply circuit 12 mounted on the printed substrate 321 of the main body is 5.7V, the emission luminance of the EL display panel deviates from the adjusted value.

That is, with the configuration of FIG. 32, even when the adjustment is carried out on the EL display panel, unless the voltages transmitted by the power supply circuit 12 are the ideal values, the adjustment is rendered ineffectual.

### 13-2. Solution in the Embodiment

In the example of FIG. 27, the power supply circuit is mounted on the flexible substrate 281 and, by operating the power supply circuit 12, the luminance adjustment, the white balance adjustment and the like are implemented. Consequently, even in the event that variations occur in the individual voltages generated by the power supply circuit 12, it matters nothing because the adjustment of the EL display panel is implemented in consideration of the variations. Also, in the aging too, by using the actually used voltages VGH, VGL, etc., it is possible to effectively implement the aging. However, at a time of the aging, an absolute value (a potential difference) of VGH- and VGL is made greater than at a time of the normal display.

### 14. Current Limit Function

A current limit function is used for an inspection of the operation of the EL display device of the embodiment.

The current limit function is a function which sets a maximum output current of Vss or Vdd. For example, in the event that a limit current of the Vss voltage is 0.5 A, when an output current of Vss exceeds 0.5 A, an internal oscillating frequency drops, and the output current is adjusted in such a way as not to reach 0.5 A. Generally, in a case of this condition, the output voltage Vss drops. In the event that the limit current of the Vss voltage is set at 1.0 A, when the output current of Vss exceeds 1.0 A, the internal oscillating frequency drops, and the output current is adjusted in such a way as not to reach 1.0 A. Generally, in a case of this condition, the output voltage Vss drops.

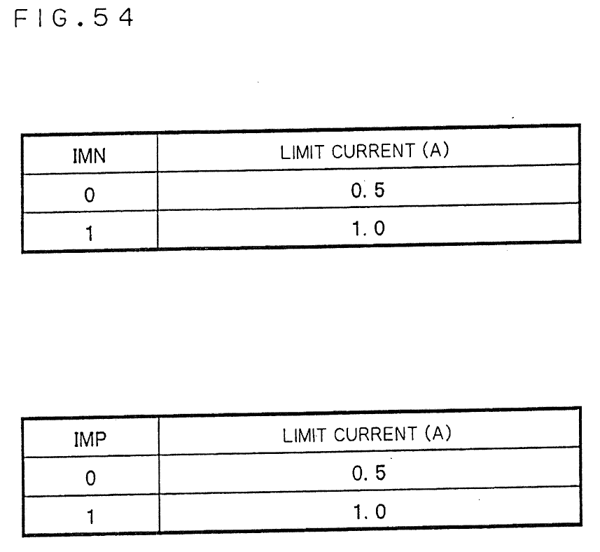

The power supply circuit 12 of the embodiment is configured in such a way that each of the Vss voltage and the Vdd voltage can be subjected to two stages of current limit settings. The two stages are 0.5 A and 1.0 A in the example of FIG. 54. Current limit values are switched and set in the aging process and a module final inspection process.

When a command IMN is 0, a limit current (A) of the Vss voltage, set by the current limit function, is 0.5 A and, when the command IMN is 1, the limit current (A) of the Vss voltage, set by the current limit function, is 1.0 A.

When a command IMP is 0, a limit current (A) of the Vss voltage, set by the current limit function, is 0.5 A and, when the command IMP is 1, the limit current (A) of the Vss voltage, set by the current limit function, is 1.0 A.

As heretofore described, the limit currents can be set individually for Vdd and Vss. Also, in the example, the setting values of the limit currents are two stages of 0.5 A and 1.0 A but, the embodiment not being limited to this, it is also acceptable that they are of three stages or more.

The current limit function is used in a process which inspects or adjusts the EL display device. For example, in a shipping inspection of the EL display device, the limit current is set at 0.5 A. A setting value of a normal operation is set at 1.0 A. The limit current is set at 0.5 A, and an adjustment image is displayed on the EL display device.

In the EL display device, a current flowing through the illumination area changes in response to the display image. For example, with the black raster display, ideally, a current flowing through the display screen is 0 A. In a case of the white raster display, and in a case in which the peak current suppression drive is not set, a maximum current flows. In a case in which the peak current suppression drive is operating, no current higher than a setting current flows.

In the EL display device, a magnitude of the current flowing through the display screen changes depending on a kind of the image. Consequently, in the inspection configuration of the EL display device, by sequentially displaying images, of which currents are known, on the EL display device, it is possible to determine whether the current limit function is operating.

When the limit current is set at a smaller value (in the embodiment, 0.5 A) than normal, for example, in an image 1, the current flowing through the display screen is 0.6 A and, in an image 2, the current flowing through the display screen is 0.4 A.

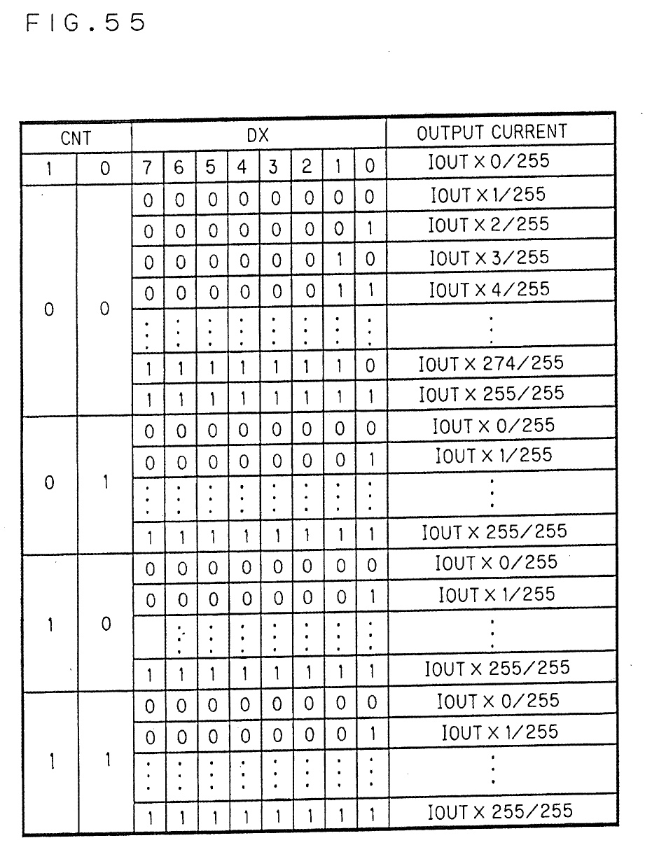

When the image 1 is displayed on the EL display device, in the event that the current limit function does not operate, it is possible to determine that the current limit function is defective in operation. Meanwhile, when the image 2 is displayed on the EL display device, in the event that the current limit function operates, it is possible to determine that there is a possibility that an abnormality of the current limit function or a defective operation in another portion is occurring. Also, it is possible to determine whether the peak current suppression drive is operating normally. The current limit value can be changed and set by means of the command. During the inspection, the current limit value is varied by means of the command, enabling an inspection of an operating condition of the EL display device. That is, a plurality of limit setting values are formed in the power supply IC 12, one current limit value is set from the plurality of limit values, and a flowing current displays a given image, ascertaining the operation of the current limit function. At this time, it is preferable to carry out a duty ratio setting of FIG. 57, and a CNT setting (including a DX setting) of FIG. 55. In the event that the duty ratio is made higher, a current flowing through the power supply circuit 12 becomes larger while, in the event that the duty ratio is made lower, the current flowing through the power supply circuit 12 becomes smaller, and changes, too. In the event that a DX value is changed, the reference current changes, and the current flowing through the power supply circuit 12 becomes smaller or larger.

Particularly, in the embodiment, the adjustment, the aging and the like are carried out by the power supply circuit 12 and the EL display panel being operated integrally (operated at the same time). The EL display device of the embodiment is one into which the power supply circuit 12 and the EL display panel are integrated (in which their connection is complete). With this kind of configuration, the number of pins of the connector 271 decreasing, it is possible to realize a reduction in costs. Also, it is possible to realize an ideal adjustment of the luminance variations and white balance. In order to realize this, the embodiment effectively uses the output open function of the power supply circuit 12.

### 15. Modification Example of Output Open Function

In the heretofore described example, the output open function is mounted on the power supply circuit 12, but the embodiment is not limited to this. It is also acceptable that, for example, an analog switch or a relay circuit is disposed between an anode output terminal of the power supply circuit 12, and an anode wiring 301 of the EL display panel. That is, it is also acceptable that a switch circuit or the like is disposed or formed outside the power supply circuit 12.

The source drive circuit 24 controls the start pulses (ST1 and ST2), clocks (CLK1 and CLK2) and up/down signal (UD) which are applied to the gate drive circuits 22, and an image is displayed. One start signal ST1 is applied to the gate drive circuit 22a for one frame period, and the start pulse ST2 is applied to the gate drive circuit 22b in such a way as to respond to the duty drive.

The EL display device is completed by ACF connecting the flexible substrate 281 to the array substrate 282 (the EL display panel) (refer also to FIG. 27). The power supply circuit 12, the EEPROM 273 and the flash memory 272 are mounted on the flexible substrate 281. The voltage VGH which turns the test transistor 295 off (the voltage VGL in a case in which the test transistors 295 are the N channel transistors) is supplied from the power supply circuit 12.

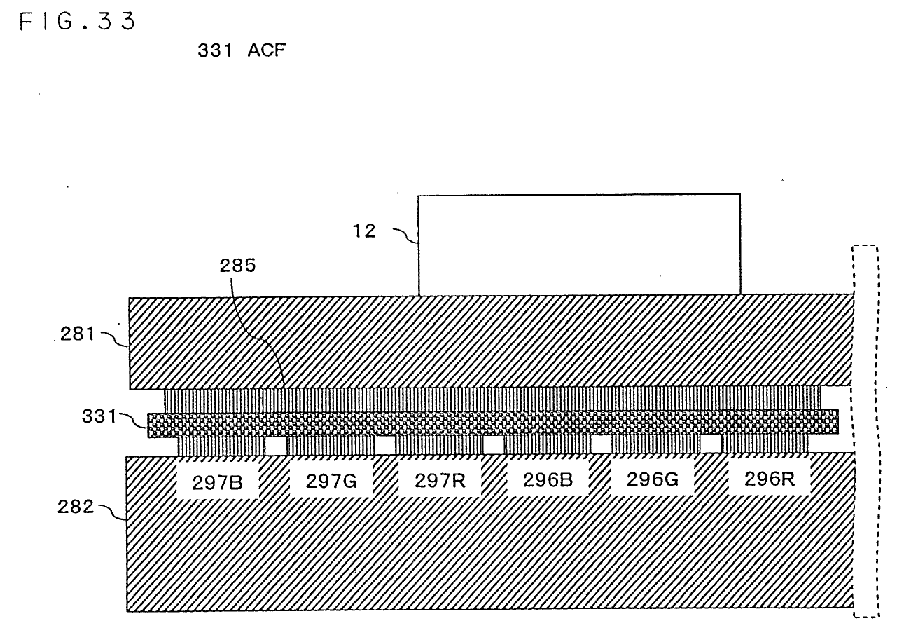

FIG. 33 is a sectional view in which the terminals of the array substrate 282 and the flexible substrate 281 are connected by an ACF 331. The terminals 297 and 296 of the array substrate 282, and the short circuit wiring 285 of the flexible substrate 281, are connected by the ACF 331.

The inspection mode of FIG. 29 is carried out without the flexible substrate 281 connected to the array substrate 282. Alternatively, the inspection mode is carried out with the flexible substrate 281 connected to the array substrate 282, but without the source drive circuit 24 mounted on the array substrate 282.

In the inspection mode, probes are inserted into the transistor control terminals 297 and signal input terminals 296 of the array substrate 282. The VGH or VGLt voltage is applied to the transistor control terminals 297.

After the inspection, the flexible substrate 281 is ACF connected to the array substrate 282. Connection terminals 284 of the flexible substrate 281, and connection terminals 283 of the array substrate 282, are connected. The transistor control terminals 297 and the signal input terminals 296 are electrically short-circuited by the short-circuit electrode terminal 285 of the flexible substrate 281. The VGH voltage is applied to the short-circuit electrode terminal 285. As the power supply circuit 12 is mounted on the flexible substrate 281, VGH is applied to the short-circuit electrode terminal 285 from the power supply circuit 12.

281 is taken to indicate the flexible substrate, but the embodiment is not limited to this. It is also acceptable that 281 is, for example, a printed substrate. Also, in the embodiment, the transistor control terminals 297 and the signal input terminals 296 are electrically connected, before the shipping of the EL display instrument, using the short-circuit electrode terminal 285 or the like. Also, it is also acceptable that the transistor control terminals 297 and the signal input terminals 296 are electrically connected by another method. It is also acceptable that the transistor control terminals 297 and the signal input terminals 296 are electrically short-circuited by means of, for example, an application of a copper paste.

Also, in the embodiment, the transistor control terminals 297 and the signal input terminals 296 are caused to have electrically the same potential before a product shipping of the EL display instrument. Also, the test transistors 295 are placed in the off condition. Consequently, it is also acceptable that a predetermined potential is applied to each of the terminals of the test transistors 295, and the test transistors 295 are placed in the off condition. For example, a method is exemplified in which a VGH potential transmitted by the power supply circuit 12 is applied directly to both the transistor control terminals 297 and the signal input terminals 296.

### 16. Inspection and Adjustment Methods

FIGS. 30 and 31 are illustrations of inspection and adjustment methods of the EL display device using the output open function of the power supply circuit of the embodiment. In the following examples too, the pixel configuration will be described with FIG. 3 illustrated by an example, but without being limited to this, it is also acceptable that it is any one of pixel configurations of the current drive system, voltage drive system and the like.

### 16-1. White Balance and Contrast Adjustment Methods

FIG. 30 shows methods of adjusting the luminance, white balance and contrast of the EL display device. In FIG. 30, the switch SW1 is turned off using the output open function of the power supply circuit 12. That is, the cathode voltage Vss is not transmitted, and the output terminals take on the high impedance condition. A probing is done into a pad P1 of the output terminal of the cathode voltage Vss with a probe 304. An ammeter 303 which measures a current is disposed between the probe 304 and an external power supply Vsst. An adjustment time cathode voltage Vsst is made equal to an image display time cathode voltage Vss.

In a case in which the drive transistor 31a of the pixel 26 is the P channel transistor, a current of a cathode wiring 302 is measured with a cathode electrode turned off. In a case in which the drive transistor 31a of the pixel 26 is the N channel transistor, a current of the anode wiring 301 is measured with the anode electrode turned off.

The source drive circuit 24 controls the gate drive circuits 22 to cause the image display condition. The magnitude of the reference current Ic is taken to be double a normal one. Regarding the reference current Ic, as described in FIG. 8, the emission luminance of the display screen 21 changes in proportion to the magnitude of the reference current. This is because the transistor 84b and the unit transistors 92 configure the current mirror circuit. The transistor 84b is configured of a plurality of transistors. When the reference current changes from 1 to 2, the luminance of the display screen 21 becomes twice as high. The power used in the display screen 21 also becomes twice as high.

In the EL display device, a cathode current Is of the display screen 21 flows through the cathode wiring 302. An anode current of the display screen 21 flows through the anode wiring 301.

With the configuration of FIG. 30, the output terminal of the cathode voltage of the power supply circuit 12 is off and, as the external cathode voltage Vsst is connected thereto, the current flowing through the cathode wiring 302 flows into the external cathode voltage Vsst via the probe 304 and the ammeter 303. Consequently, the current used in the display screen 21 can be measured with the ammeter 303. The reason for measuring the cathode current Is is that the current flowing through the cathode wiring 302 is the current flowing through the display screen 21. One portion of the anode current Ip flowing through the anode wiring 301 flows through the program current and output stage circuit in/to the source drive circuit 24.

Vddt and Vsst are voltages from an instrument which, having the inspection or aging configuration, sets them from the exterior or generates them in the exterior. Vddt and Vsst have a function of varying voltage values.

In the EL display device, the magnitude of the cathode current Is and the emission luminance are in a proportional relationship. Consequently, by measuring the cathode current, it is possible to grasp the emission luminance of the display screen 21. For the heretofore described reason, by adjusting the cathode current in such a way as to reach the predetermined current, it is possible to adjust the emission luminance of the display screen 21.

Regarding a current, such as the cathode current, flowing through the display screen, it is also acceptable to configure in such a way that a pickup resistor is disposed in a wiring through which the current flows, enabling a measurement of voltages at both ends of the pickup resistor. The heretofore described item can also be similarly applied in another method of the invention which measures a current.

### 16-2. Modification Examples

In the example of FIG. 30, the cathode current flowing through a whole of the display screen 21 is measured, but the embodiment is not limited to this. It is also acceptable to, for example, measure a cathode current of a pixel included in one portion, or a predetermined area, of the display screen 21. This is because it is possible, from this cathode current, to estimate the cathode current flowing through the whole of the display screen 21. Also, this is because, with the white raster display, as the whole screen is displayed at the same luminance, it is easy to estimate the whole of the display screen 21 even from one portion.

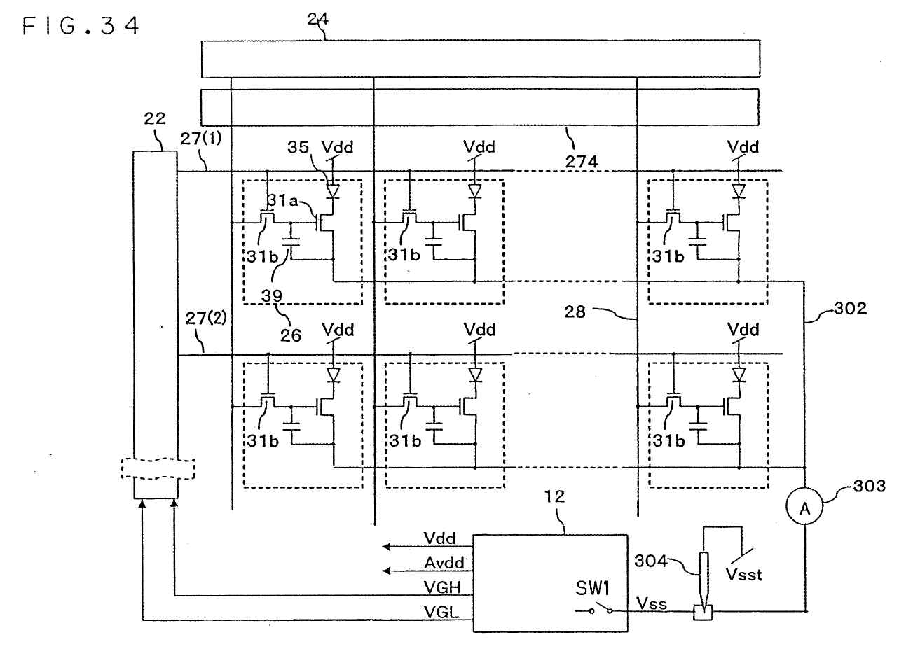

Also, by dividing the display screen 21 into predetermined areas, and measuring a cathode current in each divided area, it is possible to measure a characteristic distribution of the display screen 21. Pixel columns, pixel rows and a matrix formation are exemplified as the division. This example is described in FIGS. 34, 35, 36, etc., too.

### 16-3. Case of Voltage Program System

A description will be given of a case in which the pixel 26 is of the voltage program system. The adjustment of the magnitude of the cathode current (the adjustment of the display luminance) is carried out by setting a gradation number of the image signal (the magnitude of the image signal) applied to the display screen 21 at a certain value, and controlling the amplitude adjustment register 101 described in FIG. 10. The power supply (circuit) IC 12 appropriately sets the Avdd voltage, the VGH and VGL voltages and the like. Also, the cathode voltage Vss terminal is turned off in such a way that the cathode voltage can be measured.

The gradation amplifiers 102H and 102L are changed by the control of the amplitude adjustment register 101. By setting the gradation amplifier 102H to a high value (close to the Vdd voltage), it is possible to adjust a black level corresponding to the low gradation. By setting the gradation amplifier 102L to a low value (close to the GND voltage), it is possible to adjust a white level corresponding to the high gradation. In the embodiment, the output gradation is set at a maximum gradation, and a value of the gradation amplifier 102L is changed. The value of the gradation amplifier 102L is adjusted in such a way that a value of the cathode current reaches a desired value.

When the gradation amplitude 102L is set to the low value, the cathode current Is also becomes high, and the emission luminance also becomes high. Consequently, the magnitude of the cathode current is measured with the ammeter 303 and, when the current reaches the predetermined value, the adjustment is complete. By carrying out the heretofore described matter for R, G and B, it is possible to adjust the white balance.

The voltages VGH, VGL and Vdd transmitted by the power supply circuit 12 are set at the normal display time voltages. Also, in the embodiment, the gate drive circuit 22a is operated by means of the VGH1 and VGL1 voltages, and the gate drive circuit 22b is operated by means of the VGH2 and VGL2=GND voltages, establishing VGH1=VGH2.

By means of the heretofore described adjustment, it is possible to actualize the white balance adjustment, and also, it is possible to actualize the emission luminance adjustment of the display screen 21. The contrast adjustment of the EL display device can be actualized by adjusting the cathode current flowing at a time of the black display.

The adjustment of the magnitude of the cathode current Is (the adjustment of the display luminance) is carried out by setting a lowest gradation number applied to the display screen 21, and controlling the amplitude adjustment register 101 described in FIG. 10. A value of the gradation amplifier 102H is changed by means of the control of the amplitude adjustment register 101. When the gradation amplifier 102H is set to a high value (close to the Vdd voltage), the cathode current Is at the black level decreases. When the gradation amplifier 102H is set to a low value, the cathode current increases. When the value of the cathode current Is reaches the desired value, the adjustment is complete.

### 16-4. Case of Current Program System

Next, a description will be given of a case in which the pixel 26 is of a current program system. The adjustment of the magnitude of the cathode current Is (the adjustment of the display luminance) is carried out by setting a gradation number of the image signal (a size of the image signal) applied to the display screen 21 at a certain value, and changing the magnitude of the reference current. The certain value of the gradation number of the image signal (the size of the image signal) is normally a maximum gradation number. When the magnitude of the reference current is made greater, the cathode current Is also becomes high, and the emission luminance also becomes high. Consequently, the magnitude of the cathode current Is is measured with the ammeter 303 and, when the current reaches the predetermined value, the adjustment is complete.

By carrying out the heretofore described matter for R, G and B, it is possible to adjust the white balance. Reference currents for which the white balance adjustment is completed are taken as Ik. The reference currents Ik are individually set for R, G and B (red (R) is Ikr, green (G) is Ikg, and blue (B) is Ikb).

Regarding the adjustment of the magnitude of the cathode current Is (the adjustment of the display luminance), the gradation number of the image signal (the size of the image signal) applied to the display screen 21 is set at a certain value.

The adjustment of the magnitude of the reference current is carried out while maintaining (holding) the setting values Ik (red (R) is Ikr, green (G) is Ikg, and blue (B) is Ikb) with which the white balance has been adjusted.

The gradation number of the image signal (the size of the image signal) at the black level is a lowest gradation. In the current drive, the program current is 0 at the lowest gradation. Regarding the adjustment of the black level, a voltage of the lowest gradation is applied to the pixel 26 from the voltage generation circuits 11 in FIG. 10. The adjustment of the voltage of the lowest gradation is carried out by changing a potential transmitted by the gradation amplifier 102H. In this condition, the magnitude of the cathode current is measured with the ammeter 303 and, when the current reaches the predetermined value, the adjustment is complete.

The EL display device of the embodiment includes both the current drive circuit of FIGS. 8 and 9, and the voltage output circuit of FIGS. 10 and 11. In a case of including both the current drive circuit and the voltage output circuit, in a first half of one horizontal scanning period (a period in which one pixel row is selected), a program voltage is applied to the pixel 26 from the voltage drive circuit and, in a second half of the one horizontal scanning period (the period in which one pixel row is selected), a program current is applied to the pixel 26 from the current drive circuit.

### 16-5. Determination Circuit

The embodiment has a determination circuit (not shown) which determines whether the program voltage is applied to each pixel, the program current is applied, or both the program voltage and the program current are applied. The determination circuit, from a size (a gradation number) of the image signal, and a size (a gradation number) of an image signal applied to a source signal line S, determines whether the program voltage is applied to each pixel, the program current is applied, or both the program voltage and the program current are applied.

### 16-6. Modification Examples

In FIG. 30, the cathode current is measured with the ammeter 303, but the embodiment is not limited to this. It is also acceptable that, for example, a pickup resistor is disposed in series in a current pathway of the cathode current, and a terminal voltage of the pickup resistor is measured with the ammeter.

Also, in FIG. 30, the cathode terminal of the power supply circuit 12 is turned off, and the cathode current is measured, but the embodiment is not limited to this. It is also acceptable that the anode terminal of the power supply circuit 12 is turned off, and the anode current is measured. Also, it is also acceptable that the current or voltage is measured at both the anode terminal and the cathode terminal.

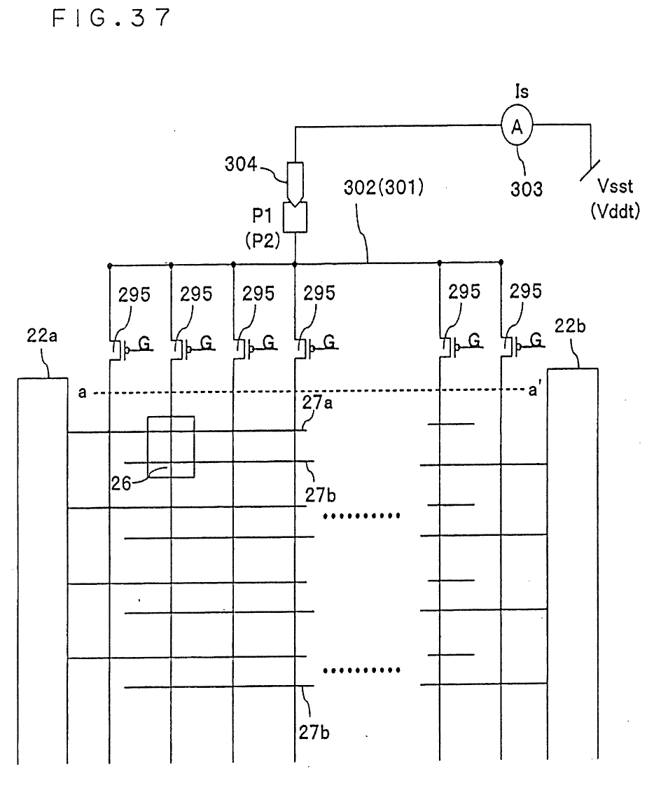

The heretofore described item is the same in FIG. 37 too. A technological idea of the embodiment is that, in the cathode wiring, the anode wiring or the like, a current flowing through the display screen 21 is measured or obtained, and caused to reach a predetermined value. The current flowing through the display screen 21 is a current which not only flows through the whole of the display screen, but sometimes flows through one portion of the display screen.

### 17. Aging Method

In the embodiment, an inspection, evaluation, aging and the like of the panel can be implemented in a condition in which the power supply circuit 12 is mounted on the flexible substrate 281 or the like, and in a condition in which a wiring (a cathode wiring or an anode wiring), through which is supplied the current flowing through the EL element 35, and the output terminals of the power supply circuit 12, are connected.

The output open function of the power supply circuit 12 is used for this purpose. Regarding a terminal which is turned off, a voltage is supplied to the panel from the exterior. Each terminal of the power supply circuit 12, when necessary, changes and transmits a voltage value, using the reference data bus (the SMBus or the like). Also, the test transistors 295 are used.

FIGS. 31 and 12 are illustrations of the aging method. In the aging process, the display screen 21 of the EL display device is caused to emit light at a higher luminance than a normal display luminance. As one example, the emission luminance of the display screen 21 is doubled or quadruplicated. This is in order to suppress a ‘seizure’ which causes an initial degradation of the EL element.

A setting of the doubled or quadruplicated display luminance is carried out by means of a change of the reference current. A setting of the reference current is carried out by means of a CNT register and DX register of FIG. 55. The setting values Ik (red (R) is Ikr, green (G) is Ikg, and blue (B) is Ikb) of the reference current, with which the white balance has been adjusted, are doubled or quadruplicated. For example, in order to double the display luminance, the reference currents Ik are multiplied by 2. n-fold (n is a real number of 1 to 4) reference current setting values used at a time of the aging are taken as Ikm (red (R) is Ikmr, green (G) is Ikmg, and blue (B) is Ikmb).

When the reference current is made larger, the currents (the anode current Ip and the cathode current Is) flowing through the anode wiring 301 and the cathode wiring 302 increase. When the anode current Ip and the cathode current Is increase, the voltage between the terminals of the EL element 35, and the channel voltage of the drive transistor 31a, become higher.

In the aging process, in order to cause the EL display device to emit light at a high luminance, it is necessary to enlarge the amplitude of the image signal written to the pixel. In the embodiment, in order to enlarge the amplitude of the image signal written to the pixel, the reference current of the source drive circuit 24 is made larger than with the normal display.

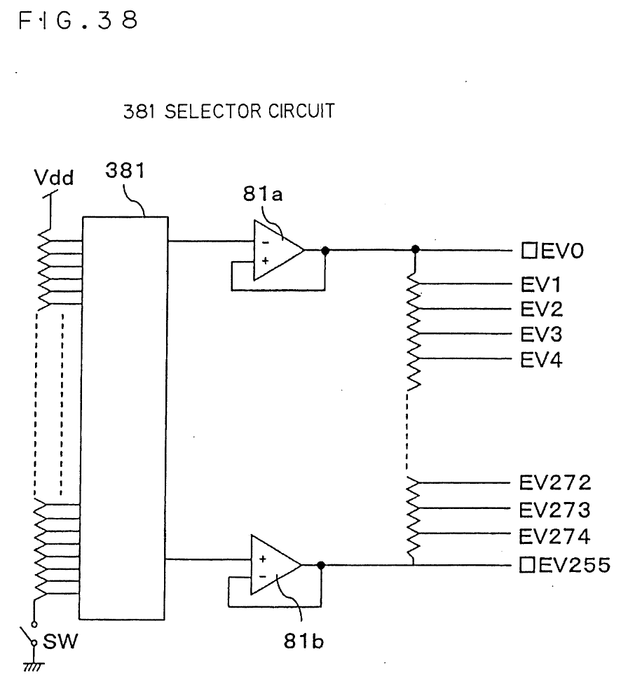

In the heretofore described example, by making the reference current larger, the amplitude of the image signal written into the EL display device is enlarged, but the embodiment is not limited to this. For example, in the voltage program system, it is also acceptable to enlarge the gradation signal (make the gradation higher, or the like), and enlarge the amplitude of the image signal written to the pixel. In this operation, it is sufficient that, for example, in FIG. 10, a higher gradation number is selected, or the output voltage of the gradation amplitude 102 is changed. For example, voltage values of EV0 and EV255 are set or changed by adjusting the selector circuit 381 of FIG. 38. Also, it is sufficient to increase a gain of a voltage DAC of FIG. 11. In this case too, the output open function of the power supply circuit 12 of the embodiment is used.

The change or setting of the reference current is carried out by operating the electronic potentiometers 86 of FIG. 8. The embodiment is configured in such a way that the reference current can be set by means of a CNT command, as shown in FIG. 55. A normal setting of the reference current is carried out by means of 8 bits of a DX command. As 8 bits are used, there are 256 stages of normal reference current settings. In the aging process, the current of twice to four times the magnitude in the normal display condition is caused to flow through the image illumination area, causing the EL element 35 to emit light. The display image is set to the white raster.

At the aging time, the setting is carried out by means of the CNT command. When the CNT command is ‘00’=0, the condition is normal. That is, the reference current is set by means of a value of the DX command (the DX register), and the amplitude of the image signal applied to the pixel is set in accordance with the reference current.

When the CNT command is ‘01’=1, ‘10’=2 and ‘11’=3, the setting is carried out at a time, such as in the aging process, when a larger current is applied to cause the EL element to emit light at a high luminance. When the CNT command (the CNT register) is ‘01’=1, a reference current of twice the value of the DX register is set. That is, the EL element 35 carries out a high luminance emission of twice the luminance in the normal mode. When the CNT command (the CNT register) is ‘10’=2, a reference current of three times the value of the DX register is set. That is, the EL element 35 carries out a high luminance emission of three times the luminance in the normal mode. When the CNT command (the CNT register) is ‘11’=3, a reference current of four times the value of the DX register is set. That is, the EL element 35 carries out a high luminance emission of four times the luminance in the normal mode.

That is, the value of the DX register is multiplied by the CNT register value+1. The heretofore described operation or setting is easily comprehensible when it is understood that the reference current is set by means of 10 bits resulting from CNT 2 bits+DX register 8 bits.

The magnitude of the reference current is proportional to the amplitude of the image signal. Consequently, by doubling the reference current, the magnitude of the image amplitude applied to the pixel 26 is doubled (a case of the ideal condition). Also, the reference current is proportional to the luminance of the EL element 35. By doubling the reference current, the emission luminance of the EL element 35 is doubled (in a case of an ideal condition). Also, the enlargement of the reference current means that the emission luminance or maximum gradation luminance of the EL element 35 is made higher.

The DX registers are disposed independently for an R color, a G color and a B color. The R, G and B DX registers are set or adjusted in accordance with a luminous efficiency of the EL element 35 of each of R, G and B. A value of the CNT register is set by multiplying the DX register value by 1 to 4. 0 of the CNT register is the normal display condition, and 1 to 3 of the CNT register are 2 to 4 times the normal display condition. The aging process is carried out with the CNT register set at 1 to 3. In the aging process too, the DX registers are adjusted in such a way that an emission luminance in a predetermined illumination area in the aging process, or a consumption current used in the illumination area, reaches a predetermined value.

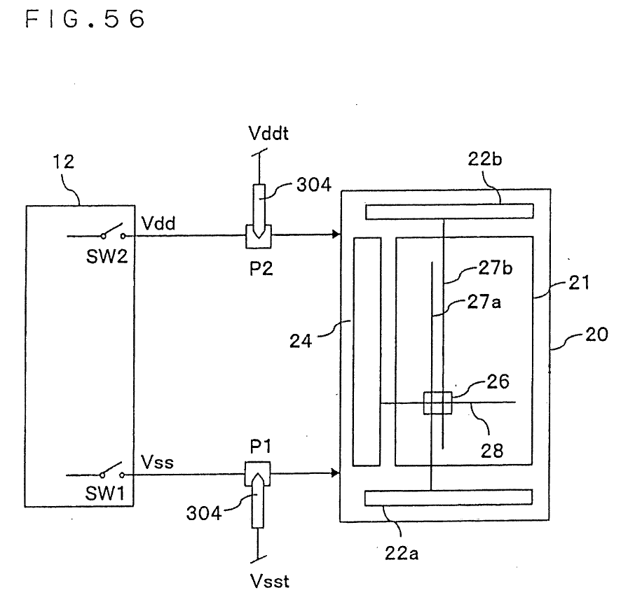

FIG. 56 is an illustration at a time of the aging process. The switch SW2 of the anode voltage Vdd, and the switch SW1 of the cathode voltage, of the power supply circuit 11 are turned off. A probe 234 is pressed against a pad P2 formed partway through a wiring which supplies the anode voltage Vdd to the EL display panel, supplying the voltage Vddt to be applied at the aging time. In the same way, the probe 234 is pressed against a pad P1 formed partway through a wiring which supplies the cathode voltage Vss to the EL display panel, and supplies the voltage Vsst to be applied at the aging time.

At the aging time, a color bar is displayed, and the color bar is displayed scrolling in order that the seizure does not occur in the EL display device.

Also, it is also acceptable that the luminance setting and the consumption current setting are carried out by varying the duty ratio. Supposing that a duty ratio of 1/2 is used in the normal display condition, taking the duty ratio to be 1/1 at the aging time, the emission luminance of the EL element 35 is doubled. Also, the consumption current (power consumption) is doubled. That is, in the embodiment, the duty ratio is varied or set in a case of emitting light at a higher luminance than in the normal display, or applying a larger current.

In a case of lowering the duty ratio or enlarging the reference current, it is necessary to raise the anode voltage or the cathode voltage, or both of them. This is because the interchannel voltage of the drive transistor 31a and the interterminal voltage of the EL element 35 rise. Also, it is necessary to increase the absolute values of the anode voltage and cathode voltage. Consequently, at the aging time or the like, the power supply circuit 12 is controlled to change the anode voltage and the cathode voltage. Also, the voltages (VGH and VGL) used in the gate drive circuit are changed. For example, the output voltage of the power supply circuit 12 is set in such a way that the anode voltage−the cathode voltage=7V in the case in which the CNT register is 0, and the anode voltage−the cathode voltage=10V in the case in which the CNT register is 3. Also, regarding Avdd too, its voltage value is changed. This is in order to secure the amplitude value of the image signal. The output voltage of the power supply circuit 12 is set in such a way that the VGH voltage is also the anode voltage+A (A is 0.5V to 3.0V).

It is also acceptable that the anode voltage, the cathode voltage and the like are changed in accordance with the illumination ratio, as shown in FIG. 57. Also, it is also acceptable that the duty ratio is also changed in accordance with the illumination ratio. The anode voltage, the cathode voltage and the like are set in such a way as to respond to the reference current.

At the aging time, the reference current is made larger than at the normal display time. Consequently, the anode voltage Vdd is made higher (for example, 5V (Vdd) at the normal image display time is changed to 7V (Vddt) at the aging time), and the cathode voltage Vss is made lower (for example, −3V (Vss) at the normal image display time is changed to −5V (Vsst) at the aging time). When the anode voltage is made higher, it is also necessary to change the voltages (VGH1 and VGL1) applied to the gate signal line 27a. The VGH1 voltage is made higher (for example, VGH=6.5V at the normal image display time is changed to 7.5V at the aging time), and the VGL1 voltage is made lower (for example, VGL1=−3V at the normal image display time is changed to −5V at the aging time).

At the aging time, in the case in which the pixel configuration is of the current drive, the image (the white raster) is displayed by means of the current drive system. In the case in which the pixel configuration is of the voltage drive, by controlling the amplitude adjustment register 101, the potential of the gradation amplitude 102L is made lower (closer to GND, or equal to or lower than GND), causing the white raster display.

The power supply circuit 12 supplies VGL, VGH, Avdd and Dvdd to the EL display panel. Vddt and Vsst are supplied from the external power supply. During the aging, the luminance of the display screen 21 is monitored with a photosensor and, at a time when the luminance drops from the initial luminance by a certain value, the aging is finished.

### 18. Case of Single Power Supply

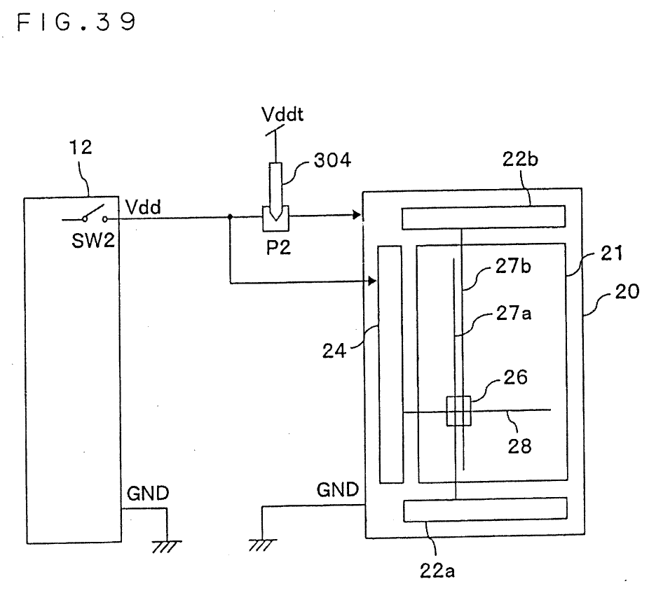

FIG. 39 shows a case in which the power supply of the EL display panel 20 is single. For example, in the pixel configuration of FIG. 3, a configuration is such that Vss is the ground (GND). Also, in the example of FIG. 39, the analog voltage Avdd and anode voltage Vdd of the source drive circuit 24 are in common.

In the heretofore described example, Vdd and Vss are supplied from the exterior and, by changing the output voltage, VGH and VGL are supplied from the power supply circuit 12. However, the embodiment is not limited to this. It is also acceptable to, for example, supply Vdd, Vss, VGH and VGL from the exterior, and supply only Avdd and Dvdd from the power supply circuit 12.

Although the image display is carried out by operating the source drive circuit 24, it is also acceptable that it is carried out by controlling the test transistors. The voltages applied to the test transistors are supplied from the power supply IC 12.

FIGS. 29, 40 and 41 show examples in which the test transistors 295 are formed in the source signal lines 28. Regarding the test transistors 295, it is also acceptable that the test transistors 295 are formed on the cathode wiring 302 or the anode wiring 301, as shown in FIG. 37. By turning on the test transistors 295, a current flows through the cathode wiring 302, and also, the flowing current can be measured by the ammeter 303. The image signal (the program current or the program voltage) is applied to the source signal lines 28 from the source drive circuit 24.

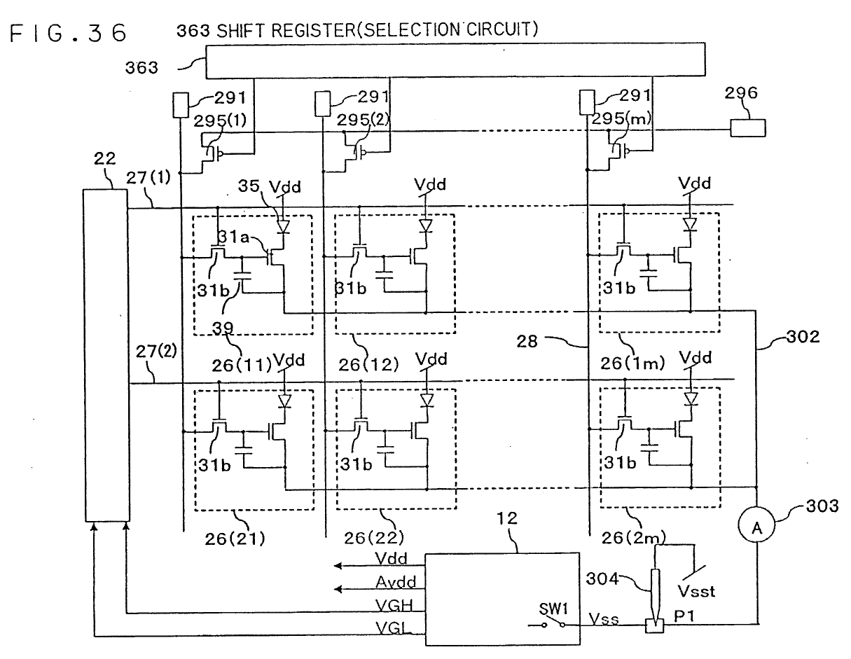

Regarding the gate terminals of the test transistors 295, in the same way as the gate drive circuits 22, it is also acceptable to configure in such a way as to add the shift register 363 (refer to FIG. 36, etc.), and sequentially select one or a plurality of test transistors 295 by means of the function of the shift register. By configuring in the way heretofore described, it is possible to on or off control the test transistors 295 independently.

Consequently, by turning on or off the test transistors 295 separately from the gate drive circuit 22a, it is possible to select the pixels 26 disposed in the matrix formation individually or by pixel column, and it is possible to measure or control the cathode current or the anode current. It is also acceptable that the test transistors 295 are formed on the anode wiring 301. Also, it is also acceptable that the test transistors 295 are formed on any two or more of the anode wiring, the cathode wiring and the source signal lines 28. The heretofore described matter can be similarly applied in other examples of the embodiment.

### 19. Measurement of Characteristic of Pixel 26

It is possible, using the power supply circuit 12 of the embodiment, to measure or grasp a characteristic of the pixel 26.

### 19-1. Outline

FIG. 37 is an illustration thereof.

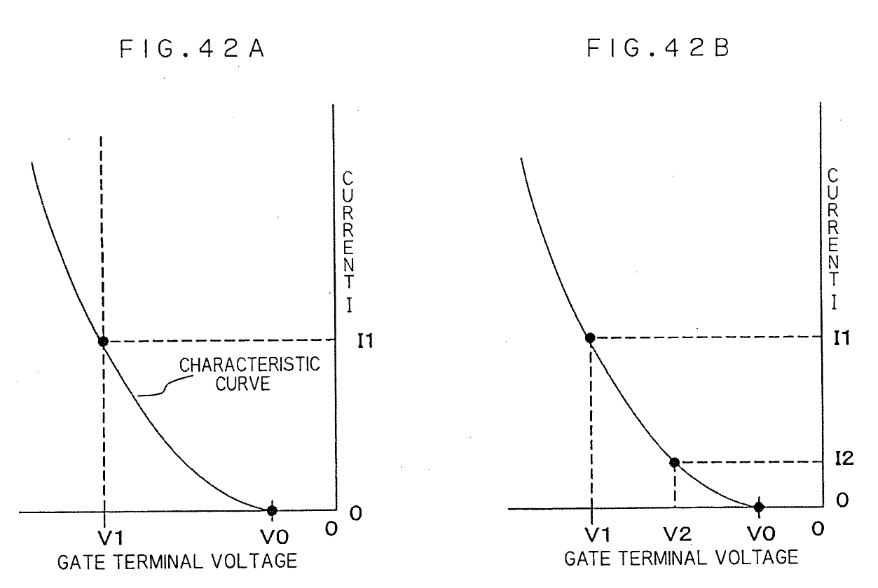

The drive transistor 31a of the pixel 26 has the characteristic of FIG. 42A. The drive transistor 31a will be described as the P channel transistor. In FIGS. 42A and 42B, the horizontal axis is the gate terminal voltage of the drive transistor 31a. The vertical axis is a current flowing between the channels of the transistors (a current flowing though the EL element 35). In the event that the gate terminal voltage is V1, the current is I1. In the event that the gate voltage is V0, the current is 0. That is, in the event that the current I1 flows, the gate terminal voltage is V1. Conversely, in the event that V1 is applied to the gate terminal, the output current is I1.

For example, a constant current I1, such as 1 μA or 0.5 μA, is supplied to a specific drive transistor 31a of FIG. 42A from the source drive circuit (IC) 24, and the gate terminal voltage of the drive transistor 31a of the pixel 26 is measured. A characteristic curve of this measured V1 drive transistor 31a is obtained, and voltage program data corresponding to each gradation are created. The characteristic curve is an approximately squared curve. As final data, V0 is obtained at which the current is 0. This V0 is stored in an ROM 272, such as the flash memory, as characteristic variation data of each pixel.

By adding gradation data of the image signal to the stored V0 data or calculating them, an image signal (the program voltage or the program current) is generated, taking into account a characteristic variation of the pixels (a characteristic variation of the drive transistor 31a). The generated image data program voltage or program current is applied to an appropriate pixel. For this reason, a defective display due to the characteristic variation of the drive transistor 31a is not carried out.

Also, it is also acceptable that, as shown in FIG. 42B, an I2 current is supplied to the drive transistor 31a of the pixel 26, a gate terminal voltage V2 with respect to the I2 current is measured, and a gradation voltage is obtained from V2 and V1. That is, a potential of the source signal line 28 is measured from at least one constant current (including the current 0), and a voltage (the program voltage) corresponding to the gradation is obtained from the measured potential. Alternatively, predetermined voltages (V2 and V1) are applied to the gate terminal of the drive transistor 31a, a characteristic of the drive transistor 31a is estimated or obtained from the transmitted currents (I2 and I1), and held in the memory as the V0 data, and an image signal (the program voltage or the program current) is obtained from the data held.

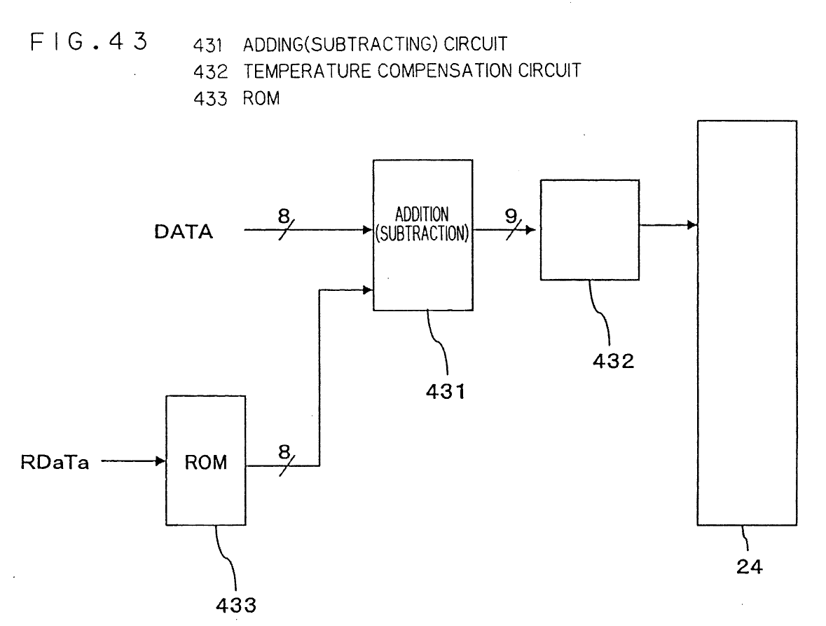

FIG. 43 is an illustration of a method of correcting the image data DATA from the acquired V0 voltage, and acquiring an appropriate image signal (the program voltage or the program current). The V0 voltage can be considered to be a correction amount indicating the characteristic variation of the drive transistor 31a of the pixel 26.

The magnitude V0 to be corrected is held in a flash ROM 433. ROM data, as RDaTa, can be rewritten from the exterior.

The data held in the ROM 433 are also 8 bits. The ROM data and the gradation data DATA are added by an addition (there is also a case of subtraction) circuit 431. Generally, in the addition process, the gradation data DATA are potentially shifted to the anode voltage side by means of the correction data V0.

The added data become 9 bits. The data are temperature-compensated by a temperature compensation circuit 432 which detects a panel temperature, and applied to the source drive circuit (IC) 24. The temperature compensation circuit 432 is required because the correction data stored in the ROM 433 have a temperature dependence.

As heretofore described, by applying the constant voltage to the gate terminal of the drive transistor 31a, and measuring the current transmitted from the drive transistor 31a, it is possible to acquire the characteristic variation of the drive transistor 31a. The acquired characteristic variation data are stored in the ROM 433 or the like as the compensation data and, by correcting the gradation data, received from the exterior of the EL display device, using the compensation data in the ROM 433, there being no characteristic variation of the drive transistor 31a of the pixel 26, it is possible to realize an effective image display.

### 19-2. Method of Measuring Characteristics of Pixel 26

FIG. 34 is an illustration of a method of measuring the characteristic of the pixel 26.

The Vss output terminal of the power supply circuit 12 is turned off, and the probe 304 is connected to the terminal pad P1. The anode voltage Vdd is supplied from the power supply circuit. The test cathode voltage Vsst and anode voltage Vdd are set at voltage values at which the normal image display is carried out.

In this condition, the predetermined voltage V1 is transmitted to each source signal line 28 from the source drive circuit 24. Also, the on voltage (VGH) which turns on the N channel transistor 31b is applied to the gate signal line 27(1), and the off voltage (VGL) is applied to the other gate signal lines 27. As described in FIGS. 42A and 42B, when the voltage V1 is applied to the gate terminal of the drive transistor 31a, a current of the magnitude I1 is transmitted. In the event that one pixel row has m pixels 26, when the V1 voltage is applied to each source signal line 28, a current of m×I1 is transmitted to the cathode wiring 302. However, actually, there being the pixel characteristic variation in a plane of the display screen 21, the current flowing through the cathode wiring 302 does not reach m×I1.

In the embodiment, by changing the voltage V1 applied to each source signal line 28, the current flowing through the cathode wiring 302 is adjusted in such a way as to reach m×I1. A voltage at which the current has reached m×I1 is taken as Vx. The voltage Vx indicates a characteristic of one pixel row selected. The Vx voltage, by being AD converted (analog-digital converted), and subjected to a predetermined calculation process, becomes correction data, and the correction data are stored in the ROM 433.

Next, the off voltage (VGL) which turns off the N channel transistor 31b is applied to the gate signal line 27(1), the on voltage (VGH) is applied to a gate signal line 27(2), and the off voltage (VGL) is applied to the other gate signal lines 27.

In this condition, a predetermined voltage is transmitted to each source signal line 28 from the source drive circuit 24. By changing the voltage V1 applied to each source signal line 28, the current flowing through the cathode wiring 302 is adjusted in such a way as to reach m×I1. A voltage at which the current has reached m×I1 (m is an integer, and a number of pixels in one pixel row) is taken as Vx. The voltage Vx indicates a characteristic of a second pixel row selected. The Vx voltage, by being AD converted (analog-digital converted) and subjected to a predetermined calculation process, becomes correction data, and the correction data are stored in the ROM 433. The heretofore described operation is repeated as far as a final pixel row.

In the way heretofore described, by adjusting the voltage applied to each source signal line 28 from the source drive circuit 24 in such a way that the current flowing through the cathode wiring 302 reaches a certain value, it is possible to acquire a characteristic variation of all the pixel rows. The acquired data are subjected to the calculation process or the like, and stored in the ROM 433 as the correction data. Hereafter, as the method described in FIGS. 42A, 42B and 43 is implemented, a description will be omitted.

### 19-3. Inspection Method

In the heretofore described example, the characteristic variation of the pixel 26 or the pixel rows is measured, but it can also be applied to the inspection method. In the example of FIG. 34, the method is described in which the V1 voltage is applied to each source signal line 28 and, by adjusting the V1 voltage in such a way that the current flowing through the cathode wiring 302 reaches the predetermined value, the Vx voltage indicating the characteristic is acquired. However, even in the event that the V1 voltage is changed in a certain range, there is a case in which the current flowing through the cathode wiring 302 does not reach the predetermined value. In this case, almost always, a defect occurs in the pixel 26. Consequently, in a case in which a voltage applied to a source signal line 28 is out of the range, it is possible to detect that a defect or the like of a pixel 26 in a selected pixel row has occurred. Also, a degree of the defect can also be grasped from a size of the voltage variable range.

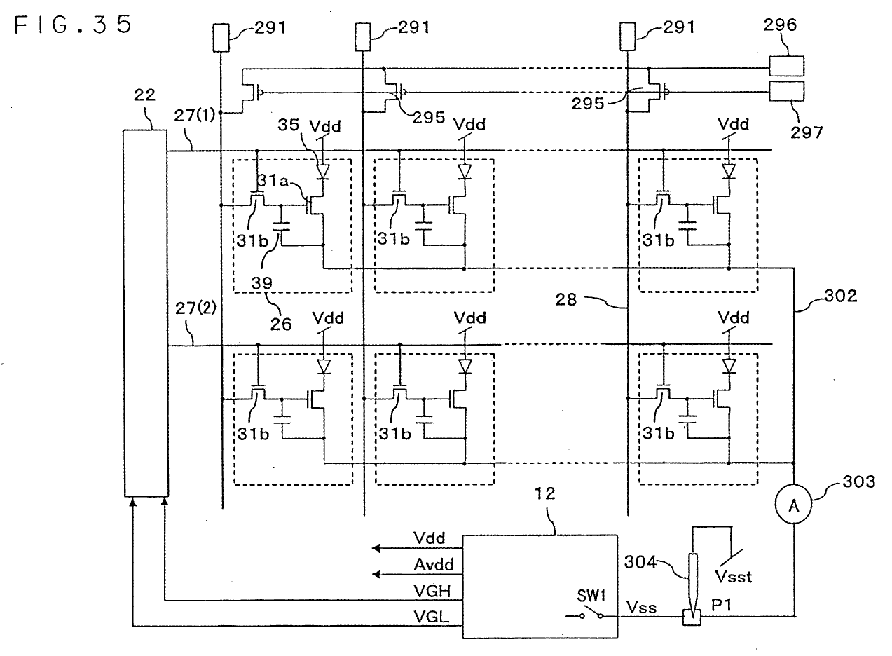

For example, it is taken that an initial voltage V1is 2.0V, and the variable range is 0.5V. In the event that the current flowing through the cathode wiring 302 cannot be set to m×I1 in a range of 1.5V to 2.5V, it is taken that the defect has occurred. Furthermore, the variable range being ±0.8V, in the event that the current flowing through the cathode wiring 302 cannot be set to m×I1 even in this range, it is taken that a serious defect has occurred. The heretofore described item can also be applied to FIG. 35, etc.

FIG. 34 shows a method using the source drive circuit 24 as a device which applies the voltages to the source signal lines 28. FIG. 35 shows an example using the test transistors 295 in place of the source drive circuit 24. By using the test transistors 295, the source drive circuit 24 becomes unnecessary at the inspection time.

### 19-4. Another Method of Measuring Characteristic of Pixel 26

FIG. 35 is an illustration of a method of measuring the characteristic of the pixel 26 in the same way as FIG. 34. Also, in the same way as FIG. 34, the defect detection can also be actualized. The Vss output terminal of the power supply circuit 12 is turned off, and the probe 304 is connected to the terminal pad P1. The anode voltage Vdd is supplied from the power supply circuit. The test cathode voltage Vsst and anode voltage Vdd are set at voltage values at which the normal image display is carried out.

In this condition, a predetermined voltage V1 is applied to a terminal 296, and the V1 voltage is applied to each source signal line 28 via the test transistors 295. Also, the on voltage (VGH) which turns on the N channel transistors 31b is applied to the gate signal line 27(1), and the off voltage (VGL) is applied to the other gate signal lines 27. As described in FIGS. 42A and 42B, when the V1 voltage is applied to the gate terminals of the drive transistors 31a, the current of the magnitude I1 is transmitted. However, actually, there being a characteristic variation of the pixel in a plane of the display screen 21, the current flowing through the cathode wiring 302 does not reach m×I1.

By changing the voltage V1 applied to each source signal line 28 via the test transistors 295, the current flowing through the cathode wiring 302 is adjusted in such a way as to reach m×I1. The voltage at which the current has reached m×I1 is taken as Vx. The voltage Vx indicates a characteristic of one pixel row selected. The Vx voltage, by being AD converted (analog-digital converted), and subjected to a predetermined calculation process, becomes correction data, and the correction data are stored in the ROM 433. Hereafter, as the operation is the same as that of FIG. 34, a description will be omitted.

### 19-5. Modification Example 1

In the examples of FIGS. 34 and 35, the characteristic variation of the drive transistor 31a or the pixels 26 is obtained by using the power supply circuit 12, and measuring the current flowing through the cathode wiring 302 line. However, the embodiment is not limited to this. It is also acceptable to obtain the characteristic variation of the drive transistor 31a or the pixels 26 by measuring the current flowing through the anode wiring 301 line. In this case too, it can be realized using the power supply circuit 12. This is because it is sufficient to activate the function of turning off the switch SW2.

Regarding the characteristic variation, by causing a constant current to flow through the drive transistor 31a and, in a condition in which the constant current is caused to flow, measuring the gate terminal voltage of the drive transistor 31a, it is also possible to obtain the characteristic variation of the drive transistor 31a or the pixels 26.

For example, with the configuration of FIG. 36, the test transistors 295 are configured in such a way as to be able to be independently on or off controlled via the shift register circuit 363 or the like. The anode voltage Vdd is set to a constant voltage. The on voltage (VGH) which turns on the N channel transistor 31b is applied to the gate signal line 27(1), and the off voltage (VGL) is applied to the other gate signal lines 27. In this condition, by operating the test cathode voltage Vsst, the current flowing through the cathode wiring 302 is set to a predetermined value. The predetermined value is a current value for one pixel row selected.

In FIG. 36, 363 is the shift register circuit, but this has a function of selecting the test transistors 295 (turning on the test transistors 295). Consequently, it has a function of sequentially selecting one test transistor 295. Furthermore, it has a function capable of selecting an optional test transistor 295. Also, a number of test transistors 295 is not limited to one. It is also acceptable to select a plurality of test transistors 295 at the same time. For example, a method is exemplified in which a red (R) pixel 26 is selected, and G and B pixels are not selected.

It is also acceptable that at least one of the EV0 and EV255 voltages is changed in response to the illumination ratio of FIG. 69 and the duty ratio of FIG. 57. When the illumination ratio is low, the absolute value of EV0-EV255 is made greater while, when the illumination ratio is high, the absolute value of EV0-EV255 is made relatively small. Also, when the duty ratio is low, the absolute value of EV0-EV255 is made greater while, when the duty ratio is high, the absolute value of EV0-EV255 is made relatively small.

In a condition in which the cathode current has reached the predetermined value, a test transistor 295(1) is turned on, and the other test transistors 295 are maintained in the off condition. By turning on the test transistor 295(1), the gate terminal voltage of the drive transistor 31a of a pixel 26(11) is transmitted to the terminal 296. A voltage transmitted to the terminal 296 is AD converted (analog-digital converted), and becomes data indicating a characteristic variation of the pixels 26(11).

Next, by turning on a test transistor 295(2), and turning off the other test transistors 295, the gate terminal voltage of the drive transistor 31a of a pixel 26(12) is transmitted to the terminal 296. The voltage transmitted to the terminal 296 is AD converted (analog-digital converted) into data indicating a characteristic variation of the pixels 26(12).

In the same way, in a condition in which the gate signal line 27(1) is selected, the test transistors 295 are sequentially turned on and, by turning off the test transistors 295 other than one test transistor 295, the gate terminal voltage of the drive transistor 31a of the pixel 26 is transmitted to the terminal 296. The voltage transmitted to the terminal 296 is AD converted (analog-digital converted) into the data indicating the characteristic variation of each pixel 26.

When the test transistor 295(m) is completed, the gate signal line 27(2) is selected, and the off voltage (VGL) is applied to the other gate signal lines 27. In this condition, in the same way as the previous first pixel row, by operating the test cathode voltage Vsst, the current flowing through the cathode wiring 302 is set to reach the predetermined value.

In the condition in which the cathode current has reached the predetermined value, the test transistor 295(1) is turned on, and the other test transistors 295 are maintained in the off condition. By turning on the test transistor 295(1), the gate terminal voltage of the drive transistor 31a of a pixel 26(21) is transmitted to the terminal 296. The voltage transmitted to the terminal 296 is AD converted (analog-digital converted) into data indicating a characteristic variation of the pixel 26(21).

Next, the test transistor 295(2) is turned on and, by turning off the other test transistors 295, the gate terminal voltage of the drive transistor 31a of a pixel 26(22) is transmitted to the terminal 296. The voltage transmitted to the terminal 296 is AD converted (analog-digital converted) into data indicating a characteristic variation of the pixel 26(22).

In the same way, in the condition in which the gate signal line 27(2) is selected, by sequentially turning on the test transistors 295, and turning off the test transistors 295 other than one test transistor 295, the gate terminal voltage of the drive transistor 31a of the pixel 26 is transmitted to the terminal 296. The voltage transmitted to the terminal 296 is AD converted (analog-digital converted) into data indicating the characteristic variation of each pixel 26.

In the way heretofore described, by selecting pixels in order, and measuring the gate terminal voltage of the drive transistor 31a of the pixel 26, it is possible to acquire the characteristic variations of all the pixels. The acquired data are subjected to the calculation process or the like, and stored in the ROM 433 as the correction data. Hereafter, as the methods described in FIGS. 42A, 42B and 43 are implemented, a description will be omitted.

### 19-6. Modification Example 2

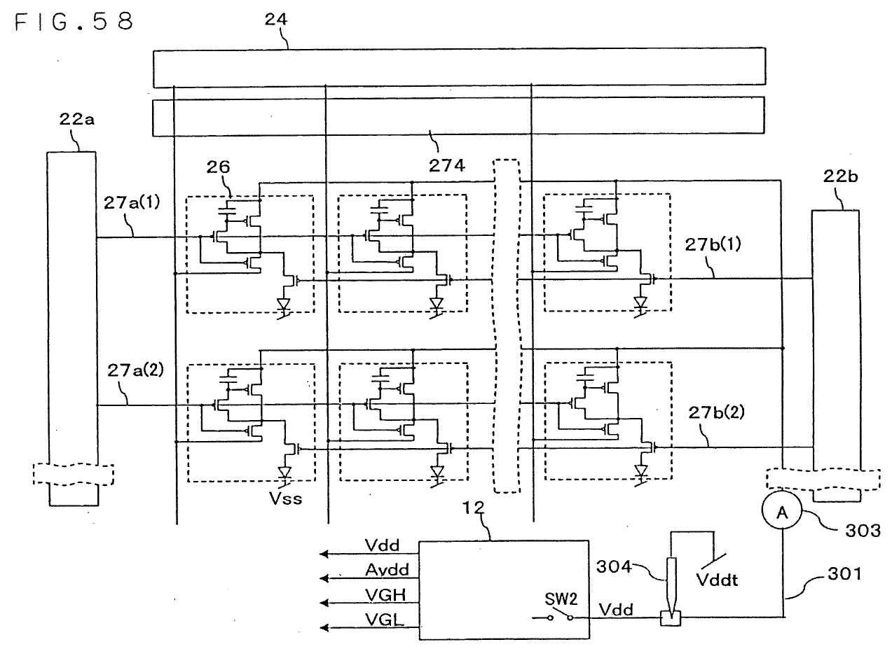

In FIG. 36, the current of the cathode wiring 302 is measured, and the pixels are also of the voltage drive pixel configuration. In FIG. 58, the current of the anode wiring 301 is measured, and the pixels are of the current drive pixel configuration described in FIG. 3. As the method (operation) of FIG. 58 is the same as that of FIG. 36, a description will be omitted. As heretofore described, the embodiment can respond to any pixel configuration.

The examples of FIGS. 34 and 36 have been described, taking them to be applicable to the inspection method. The method described in FIG. 36 can also be applied to the inspection method.

In FIG. 36, by operating the test cathode voltage Vsst, the current flowing through the cathode wiring 302 is set to reach the predetermined value. However, there is a case in which, even by changing Vsst in a predetermined range, the current flowing through the cathode wiring 302 does not reach the predetermined value.

In this case, most often, a defect is occurring in a pixel 26. Consequently, in a case in which a change or adjustment range of Vsst is out of the range, it is possible to detect that a defect is occurring in any one pixel 26 in the selected pixel row. Also, a degree of the defect can also be grasped from a size of the voltage variable range.

For example, it is taken that the initial voltage Vsst is −3.0V, and the variable range is 0.5V. Unless the current flowing through the cathode wiring 302 can be set to m×I1 in a range of −3.5V to −2.5V, it is taken that a defect is occurring. Furthermore, taking the variable range to be 0.8V, unless the current flowing through the cathode wiring 302 can be set to m×I1 even in this range, it is taken that a serious defect is occurring.

In FIGS. 27, 35 and 36, by on or off controlling the test transistors 295 in a pulse formation, or turning them on or off periodically, it is possible to carry out a greater variety of inspections. In FIG. 27, in the case of turning on the test transistors 295, the switch formed in the final output stage of the source drive circuit 24 is switched off (turned to the high impedance), and the source drive circuit 24 is disconnected from the source signal line, and protected from the voltage (current) applied to the source signal lines 28 by the test transistors 295.

Also, in FIGS. 27, 35, 36, etc., the Vdd and Vss voltages transmitted from the power supply circuit 12, or the external power sources Vddt and Vsst, are varied or adjusted and, by synchronizing the varied or adjusted condition and the turning on or off of the test transistors 295, it is possible to actualize a greater variety of inspections or adjustments. For example, in the aging process, Vddt and Vsst are applied, and the voltage or current, which turns on (displays) and off (non-displays) the pixels 26 in one frame period or a plurality of frame periods by the test transistors 295, is applied. By so doing, the EL display panel takes on a flash display with the aging configuration and, as it is possible to apply a great stress, it is possible to shorten the aging process. By carrying out the flash display on the EL display panel, it is possible to generate a defect, which can occur in an EL component film of the EL element 35, with the aging configuration. The heretofore described system can be realized not only by controlling the test transistors 295, but also by controlling the source drive circuit 24.

### 20. Adjustment of Whole of Display Screen

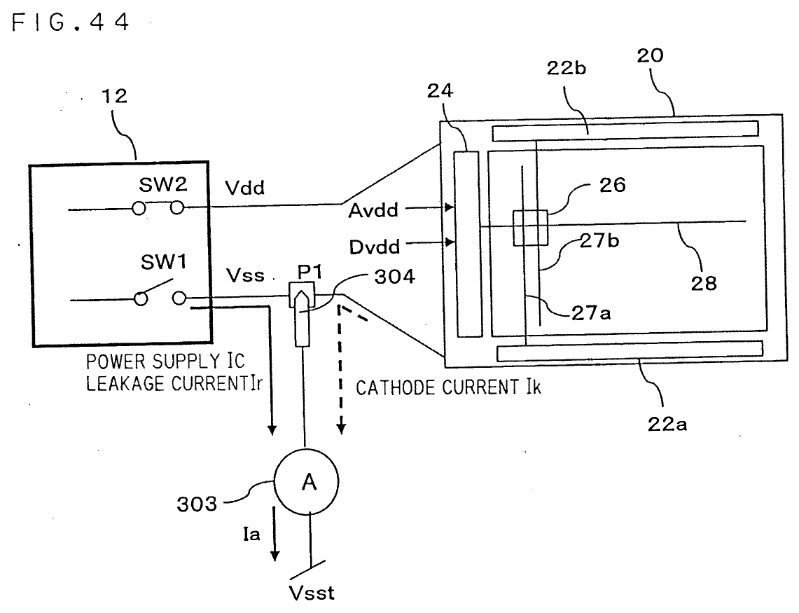

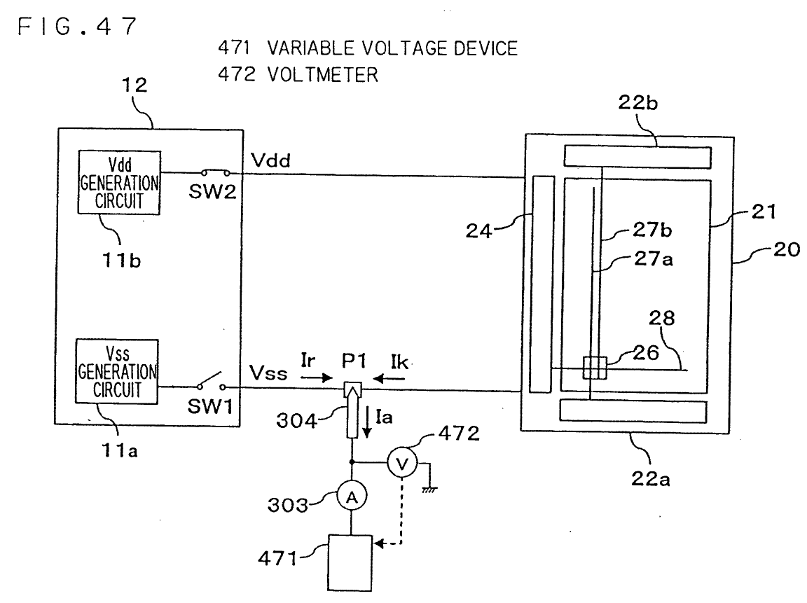

The heretofore described example relates to the system of measuring the characteristics of the pixels, or the like. The embodiment is not limited to this. Naturally, it is also possible to implement the adjustment of a whole of the display screen. FIGS. 44, 47, etc. are illustrations thereof.

FIG. 44 is an illustration for adjusting the black level of the image display. When the black level is deepened, the display contrast becomes high, but a gamma curve is distorted. When the black level is shallowed, the display contrast is deteriorated. Consequently, the black level requires an appropriate adjustment. In the case in which the drive transistor 31a of the pixel 26 is the P channel transistor, the black level is adjusted by measuring the cathode current. In the case in which the drive transistor 31a is the N channel transistor, the black level is adjusted by measuring the anode current. In FIG. 44, a description is given, taking the drive transistor 31a to be of the P channel.

In FIG. 44, the power supply circuit 12, by turning on the switch SW2, supplies the anode voltage Vdd to the display panel 12a. Meanwhile, the switch SW1 being turned off, the cathode terminal (the Vss terminal) is placed in the high impedance condition. The pad P1 is formed partway through the cathode wiring connecting the display panel 20 and the power supply circuit 12. An electrical contact such as the probe 304 is connected to the pad P1. The electrical contact not being limited to the pad, it is also acceptable that it is, for example, a contact terminal of a connector. In this case, the connector corresponds to the probe 304.

A feature of the EL display device (the EL display module) of the embodiment lies in the electrical contact (the pad) being formed on the cathode wiring or the anode wiring, or both wirings. Also, a feature lies in the off circuits (the switches SW) being embedded in the power supply circuit 12. Gold bumps 451 are formed on IC terminals 453 of an IC chip 452. Also, a feature lies in the voltage to be supplied to the EL display panel 20 being supplied from the power supply circuit 12, and the power supply circuit 12 being flip-chip mounted (gold-bump mounted) on the flexible substrate 281. Also, a feature lies in a gold bump terminal 451 of a chip potential ground electrode (a ground pattern) 455, which fixes a chip potential of the power supply circuit 12, being provided, configuring in such a way that an electrode 454 can be grounded (GND), or a minus potential (VGL) can be applied (refer to FIGS. 45A and 45B).

In FIG. 44, the anode voltage Vdd is supplied to the EL display panel 20 from the power supply circuit 12, and the switch SW1 is turned off. That is, an arrangement is such that the voltage from the power supply circuit 12 is not supplied to the cathode wiring. Also, a configuration is such that, even in the event that the voltage is applied to the cathode wiring, the voltage is not applied to an internal circuit of the power supply circuit 12.

The ammeter 303 is connected to the pad P1 via the probe 304. The other terminal of the ammeter (a current measuring instrument) 303 is connected to the test (adjustment) voltage Vsst. The Vsst voltage value is made the same as the Vss output voltage of the power supply circuit 12. By using the Vsst voltage to adjust the EL display panel 20, it is possible, even when SW1 of the power supply circuit 12 is placed in the on condition (the normal operation condition) after the adjustment, to make the display luminance or the like the same as at the time of the adjustment.

The Vss voltage transmitted from the power supply circuit 12 also has a variation. In order to absorb the variation, the Vss voltage transmitted from the power supply circuit 12 is measured with the ammeter, and the measured voltage is applied as the Vsst voltage. The heretofore described item is also the same for the other voltages (Vdd, VGL, VGH, Avdd and the like).

In the embodiment of the invention, the probe 304 is connected to, or pressed against, the pad P but, the embodiment not being limited to this, it is also acceptable to use, for example, the connector in place of the pad P. It is also acceptable to configure in such a way as to be able to measure a current by connecting the probe to a wiring, in which the current is measured, by means of a connecting terminal of the connector. The heretofore described item can be applied in other examples of the invention.

Normally, in order to measure the current flowing through the cathode wiring, it is necessary to cut off the cathode wiring, and insert the ammeter in a portion in which the cathode wiring has been cut off. As heretofore described, by turning off the Vss output of the power supply circuit 12, and connecting one terminal of the ammeter 303 to an adjustment potential Vsst, it is possible, merely by connecting the other terminal of the ammeter to the pad P1, to measure the current flowing through the illumination area 34 of the EL display panel 20.

On SW1 of the power supply circuit 12 being put in an off position, ideally, the high impedance condition is caused, and the leakage current Ir from the Vss terminal of the power supply circuit 12 does not occur. However, in practice, a leakage current Ir of a microampere (μA) order is generated. Consequently, an addition of the cathode current Ik and the leakage current Ir from the power supply circuit 12 is measured with the ammeter. In the black level adjustment, as the cathode current Ik is also of the microampere order, in the event that there is a leakage current Ir, it is not possible to adjust the black level.

In order to respond to this problem, in the adjustment method of the embodiment, the cathode current Ik is set completely at 0 (Ik=0 μA). By making the cathode current Ik equal to 0, only the leakage current Ir of the power supply circuit 12 is connected. Next, the EL display panel 20 is set in such a way that the cathode current Ik takes on the normal condition (becomes a cathode current corresponding to the black level which should by right be set). In this condition, Ia=cathode current Ik+leakage current Ir is measured with the ammeter 303. By subtracting the previously measured Ir from the measured Ia, it is possible to quantitatively measure only the cathode current Ik. That is, regarding a value to be adjusted by the ammeter 303, it is sufficient that, setting the measured current value Ir at 0, the adjustment is completed at a time of adding Ik, which is a value which should be adjusted.

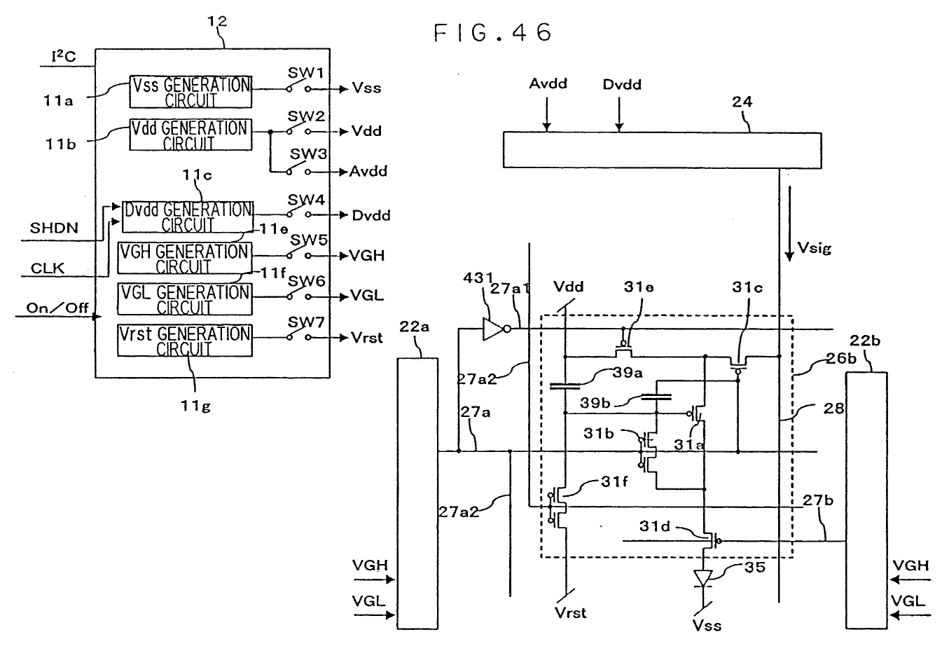

Making the cathode current Ik equal to 0, as shown in FIG. 46 is carried out by applying a voltage in a vicinity of the anode voltage Vdd, or a voltage Vsig equal to or higher than the Vdd voltage, to the source signal line 28 from the source drive circuit 24. As previously described, the voltage applied to the source signal line 28 is applied to the gate terminal of the drive transistor 31a. In order to apply a high voltage Vsig (close to, or equal to or higher than, the anode voltage) to the source signal line 28, the Avdd voltage of the power supply circuit 12 is raised by means of the command setting (refer to FIG. 14). Alternatively, when necessary, the EV0 voltage illustrated in FIG. 38 is set to be high (in a vicinity of, or equal to or higher than, the anode voltage).

The switch Vsig voltage, by turning on the switching transistors 31c and 31b, is applied to the gate terminal of the drive transistor 31a. By setting the potential of the gate terminal of the drive transistor 31a to be in the vicinity of, or equal to or higher than, the anode voltage, the current flowing through the drive transistor 31a decreases. The Vsig voltage is applied to the gate terminals of all the drive transistors 31a in the illumination area 34.

In order to set an optimum cathode voltage, a configuration (a setting) is such as in FIG. 47. A variable voltage device 471 is connected to one end of the ammeter 303. A voltage of the variable voltage device 471 is changed, and the voltage Vsst is measured with a voltmeter 472. Also, the current Ia is measured with the ammeter 303.

In the event that the cathode voltage Vsst is not sufficient, Ik also becomes lower. However, the low Ik in this case means that a sufficient voltage is not applied to the drive transistor 31a of the pixel and the EL element 35. The cathode voltage Vsst being reduced, Ik is changed by the variable voltage device 471 while monitoring the change of Ik with the ammeter 303. By keeping on reducing the cathode voltage Vsst, the Ik current also increases but, when the cathode voltage Vsst is reduced beyond a certain level, the Ik voltage is saturated, and will not increase any more. A voltage Vsst in this saturation position is measured with the voltmeter 472. The measured Vsst is set in the power supply circuit 12 as the Vss voltage of the power supply circuit 12.

The heretofore described item being the case in which the drive transistor 31a is the P channel transistor and, in the case in which the drive transistor 31a is the N channel transistor, the cathode voltage or a voltage equal to or lower than that is applied as the Vsig voltage.

The Vsig voltage described in FIG. 46 means a voltage which is not in the normal condition (which is not a voltage at which the normal black level is set). That is, the Vsig voltage is a voltage which is applied to the EL display panel 20 in order to make the cathode current as low as possible to measure the leakage current of the power supply circuit 12.

Also, in a case in which the variation of the leakage current Ir of the power supply circuit 12 is not large (for example, in a case in which the leakage current is 5 μA, and a variation 3a is 0.5 μA), it is not necessary to measure the leakage current Ir of the power supply circuit 12. It is sufficient to use a mean value as the leakage current Ir. In this case, a need for a process of making Ik equal to 0 is also eliminated.

### 20-1. Modification Example 1

In the heretofore described example, all the voltages (Vdd, Vss, VGH, VGL, Avdd and the like) are generated by the power supply circuit 12, but the embodiment is not limited to this. For example, as shown in FIG. 48, it is also acceptable that the voltages (VGH and VGL) used by the gate drive circuits 22 are generated by the source drive circuit 24. The battery voltage Vin is input into the source drive circuit 24 and the power supply circuit 12.

### 20-2. Modification Example 2

In FIG. 49, external capacitors (C1 and C2) being added for charge pump circuits (11e and 11f) of the source drive circuit 24, the source drive circuit 24 is mounted on the panel 20 by means of COG (Chip On Glass), and the capacitors C1 and C2 are mounted on the flexible substrate 281.

FIGS. 48, 49 and 50 show a case in which the EL display panel 20 is of a single power source in the same way as in FIG. 39. Also, the logic voltage Dvdd used in the source drive circuit 24 is generated by the power supply circuit 12. This is because the source drive circuit 24 cannot be operated unless the Dvdd voltage is supplied. Also, in FIGS. 48, 49 and 50, it is also acceptable to employ the two-voltage system (a system having the Vdd voltage and the Vss voltage) in the same way as in FIGS. 3, 23, etc.

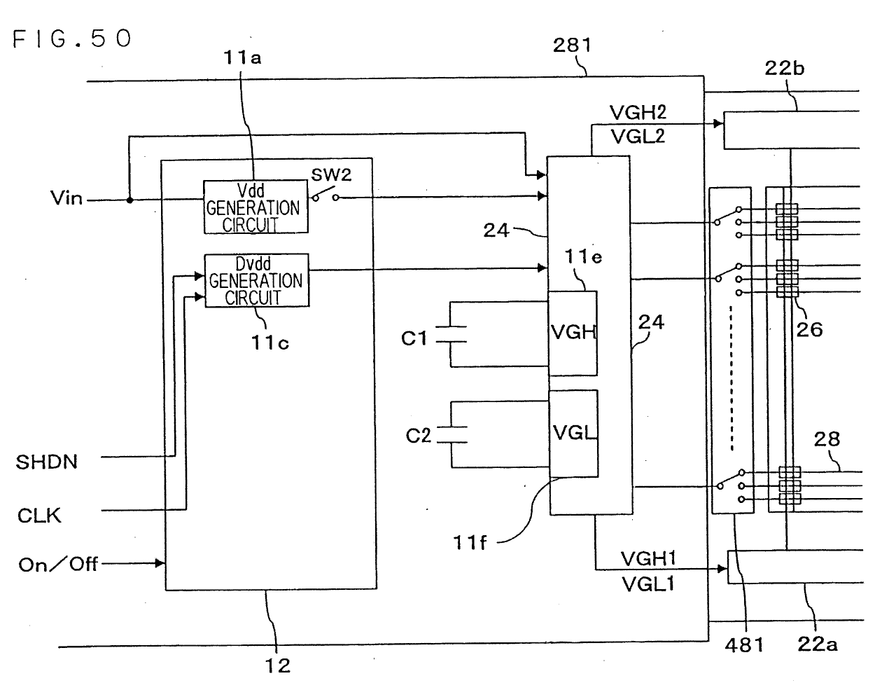

FIG. 49 shows a configuration in which the source drive circuit 24 is mounted on a glass substrate by means of the COG technology, and the power supply circuit 12 is mounted on the flexible substrate 281. FIG. 50 shows a configuration in which both the source drive circuit 24 and the power supply circuit 12 are mounted on the flexible substrate 281. The power supply circuit 12 and the source drive circuit 24, each having the gold bumps formed on the terminals, are mounted on the flexible substrate by means of a COF (Chip On Flexible Substrate) technology.

In FIGS. 49 and 50, the power supply circuit 12 is mounted on the flexible substrate as just a chip (without using an IC package). For this reason, it is important to maintain a potential of a chip substrate (a wafer substrate). In the embodiment, as shown in FIGS. 45A and 45B, an electrode (the chip potential ground electrode 454) connected to a wafer potential is formed on a surface of the IC chip 452. The IC chip and the potential ground electrode 454 are connected by means of an IC circuit patterning. The gold bumps 451 are also formed on the chip potential ground electrode 454, and connected to the flexible substrate 281, by means of the COF mounting, at the same time as another IC terminal 713. The chip potential ground electrode 454 is connected to the ground (GND) potential. Preferably, a negative potential is applied. In the embodiment, the VGL potential transmitted by the power supply circuit 12 is connected.

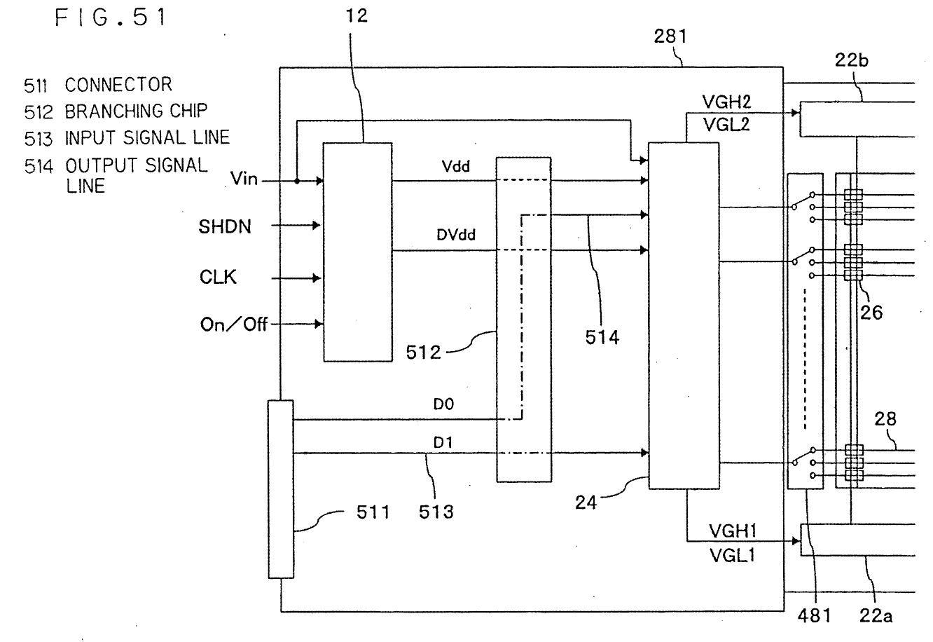

FIG. 51 is a diagram in which are described the electric wiring connection relationship of FIG. 50 and a branching chip 512. A difference from FIG. 50 is that the branching chip 512 is mounted on the flexible substrate 281.

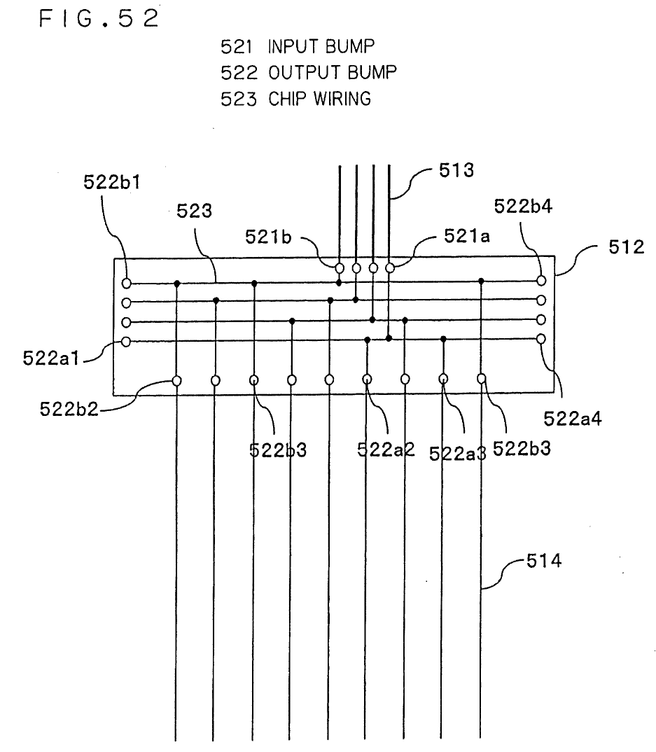

The branching chip 512 is configured as in FIG. 52. The branching chip 512, in the same way as the source drive circuit 24, is formed of a silicon chip. Of course, it is also acceptable that it is other than a silicon chip as long as it has a shape of, or is similar to, a chip or the like. It is also acceptable that it is, for example, one in which a metal wiring is patterned on a glass substrate.

In the same way as the source drive circuit 24, gold bumps (an input bump 511 on an input side, and an output bump 512 on an output side) are formed on the branching chip 512. A difference from the source drive circuit 24 is that no image signal etc. output circuit is formed, and only a chip wiring is formed. That is, the chip wiring 513 is formed of semiconductor metal wiring layers.

Input signal lines 512 (signal lines such as D0 and D1 in FIG. 51) from the connector 511 are branched by means of chip wirings 513 formed in the branching chip 512, and also, the input signal lines are intersected or switched using the branching chip 512.

In the EL panel module of the embodiment, a one-side flexible substrate is used as the flexible substrate 281. Consequently, it is inexpensive. However, as it is the one-side flexible substrate, it is not possible to branch or switch (intersect) the wirings. In response to this problem, in the embodiment, the chip wirings 513 are formed by means of the branching chip 512, the branching, intersection and the like of the input signal lines 513 are realized by means of the chip wirings 513, and the input signal lines 513 are connected to output signal lines 514. The branching chip 512 is mounted on the flexible substrate 281 by means of the COF technology at the same time as the source drive circuit 24.

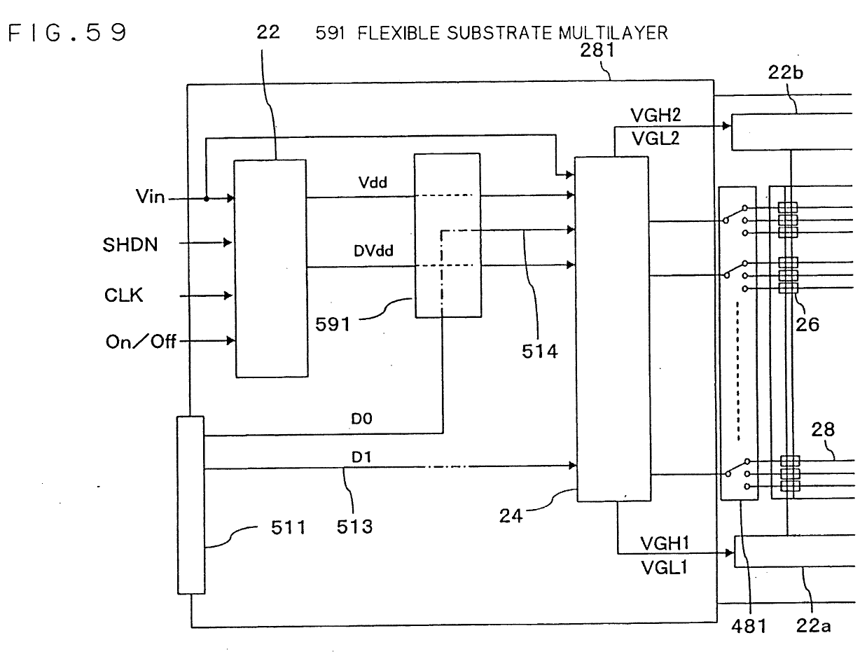

In FIG. 59, a flexible substrate multilayer 591 is formed in one portion of the flexible substrate 281. That is, the flexible substrate multilayer 591 has a configuration of a two-layer flexible substrate. Through holes being formed in this flexible substrate multilayer 591, the signal lines, power wirings and the like are intersected.

The source drive circuit 24 generates the power supply voltages VGH (VGH1 and VGH2) and VGL (VGL1 and VGL2) to be used in the gate drive circuits 22. The voltages VGH and VGL are generated by the charge pump circuit. The power supply circuit 12 generates the anode voltage Vdd, and the logic voltage Dvdd used in the source drive circuit 24. The EL display panel uses the ground (GND) voltage as the cathode voltage Vss. The source drive circuit 24 also generates the clock signals (CLK), the start signals (ST) and the like which are used in the gate drive circuits 22. The start signal (ST) is level shifted in the source drive circuit 24, and applied to the gate drive circuits 22.

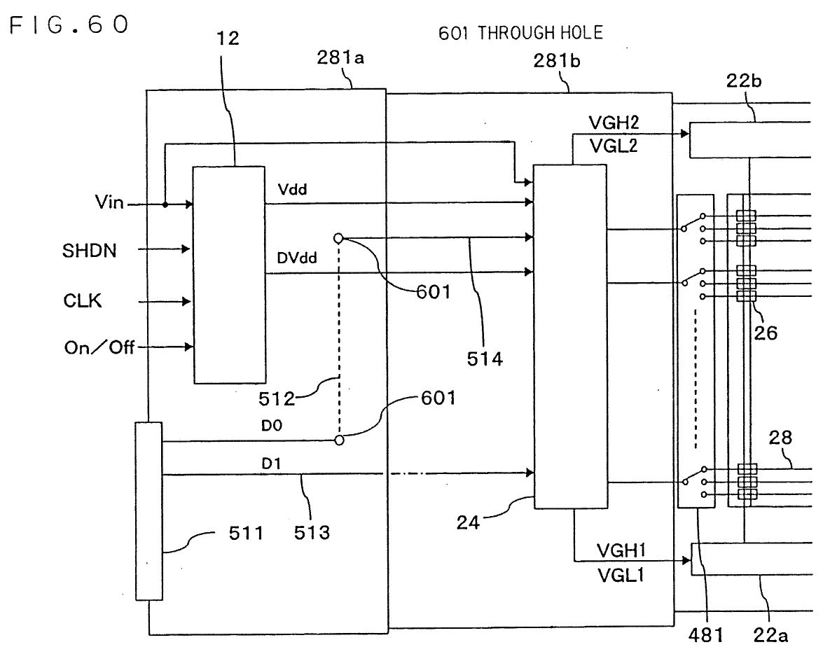

In FIG. 60, flexible substrates 281a and 281b are bonded together. The flexible substrate 281a is a two-layer flexible substrate. A through hole 601 is formed in the flexible substrate 281a, causing signal lines, power wirings or the like to intersect.

### 21. Level Shift Function

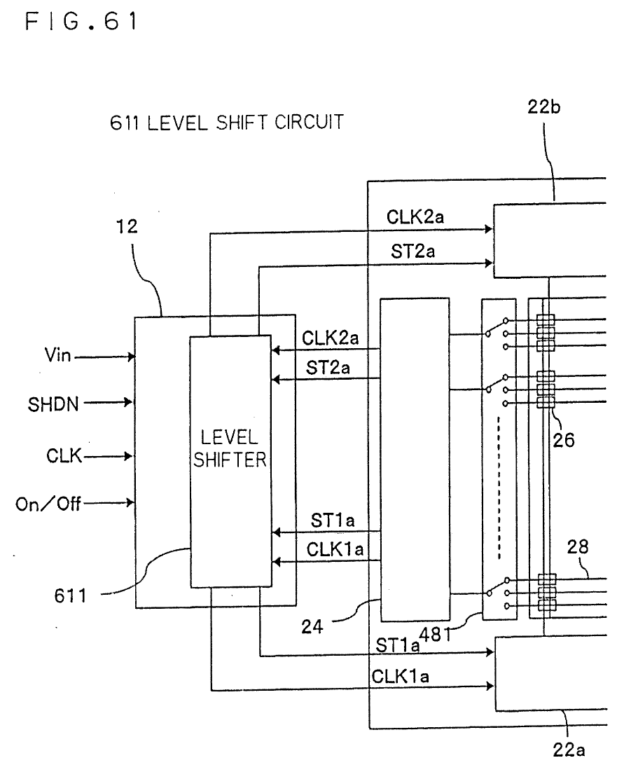

FIG. 61 shows a configuration which provides the power supply circuit 12 with a level shift function. The source drive circuit 24 generates clock signals (CLK2a and CLK1a) and start signals (ST2a and ST1a) used in the gate drive circuits 22. A logic level of the generated signals is a 3V system.

The heretofore described 3V system signals are input into the power supply circuit 12. A level shifter circuit 611 is embedded inside the power supply circuit 12. The level shifter circuit 611 converts the 3V system logic level into a logic level of the gate drive circuits 22. The logic level of the gate drive circuits 22 is VGL−VGH. The level shifted signals become clock signals (CLK2b and CLK1b) and start signals (ST2b and ST1b), and are input into the gate drive circuits 22.

### 22. Point Defect Inspection

The power supply circuit 12 of the embodiment can also be used for a point defect inspection of the display panel. The power supply circuit 12, as well as supplying the voltages of the gate drive circuits 22, and supplying the voltages which turn on or off the test transistors 295, controls the test transistors 295 or the like.

In FIG. 29, test transistors 295R are formed as the red (R) test transistors 295. A voltage which turns on or off the test transistors 295R is applied to a transistor control terminal 297R, and a constant current or a constant voltage is applied to a signal input terminal 296R. The source drive circuit 24 is mounted in a source drive circuit mounting position 294.

Also, test transistors 295G are formed as the green (G) test transistors 295. A voltage which turns on or off the test transistors 295G is applied to a transistor control terminal 297G, and a constant current or a constant voltage is applied to a signal input terminal 296G. Test transistors 295B are formed as the green (B) test transistors 295. A voltage which turns on or off the test transistors 295B is applied to a transistor control terminal 297B, and a constant current or a constant voltage is applied to a signal input terminal 296B.

As in FIG. 29, by configuring in such away that a selected test transistor 295 differs for each of R, G and B, it being possible to display R, G and B images on the display screen 21, it is easy to implement an inspection such as the defect inspection.

The gate signal lines 27a being synchronized with the horizontal synchronization signal, pixel row positions to be selected are shifted one pixel row at a time. Also, a voltage or a current from the test transistors 295 is applied to each pixel row. Normally, an always on voltage is applied to the gate terminals of the test transistors 295.

In FIG. 29, 293 is an input terminal pad of the source drive circuit 24, and 291 an output terminal pad of the source drive circuit 24.

In a pixel row in which the on voltage is applied to the gate signal lines 27a, the off voltage is applied to the gate signal lines 27b. In a pixel row in which the off voltage is applied to the gate signal lines 27a, the on voltage is applied to the gate signal lines 27b. Alternatively, in a case in which the duty drive is implemented as in FIGS. 5 and 7, the off voltage is applied to the gate signal lines 27a and gate signal lines 27b in a pixel row corresponding to the non-illumination area 55.

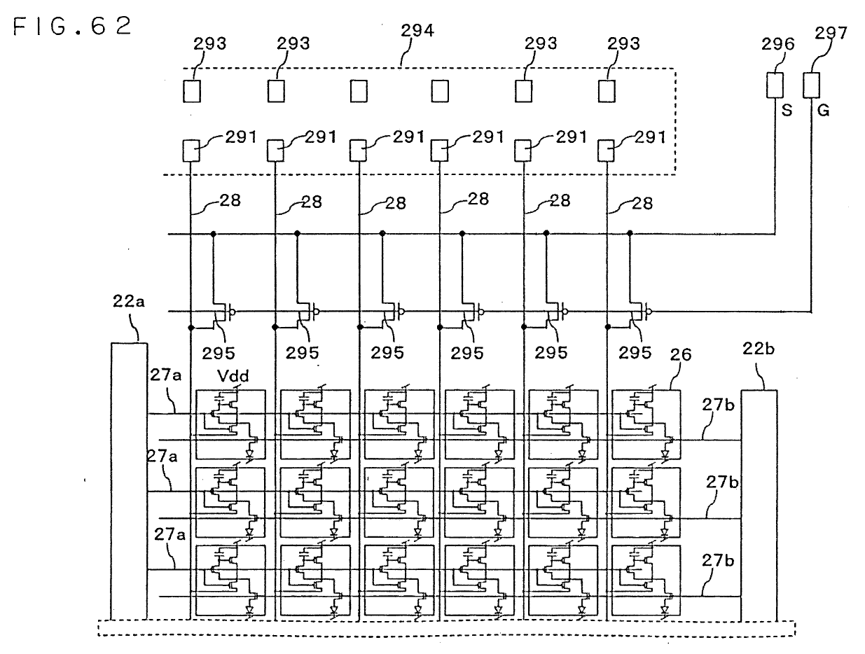

FIG. 29 shows a system which disposes the test transistors 295 (295R, 295G and 295B) for each of red (R), green (G) and blue (B), and applies an independent predetermined current or predetermined voltage for each of R, G and B. However, the embodiment is not limited to this. For example, as shown in FIG. 62, it is also acceptable to dispose the test transistors 295 irrespective of R, G and B.

In the example of FIG. 62, a voltage (a current) applied to the signal input terminals 296 is controlled by means of a control voltage applied to the transistor control terminals 297, and applied to the source signal line 28. In FIG. 29, it is taken that the voltage (current) is applied to the whole of the display screen 21 by means of the control voltage applied to the transistor control terminals 297. However, the embodiment not being limited to this, it is also acceptable to configure in such a way that, the display screen 21 being divided into a plurality of areas, it is possible to apply different voltages (currents) to the divided areas.

In order to apply the on/off voltage to the gate signal lines 27, the gate drive circuits 22 are operated (FIG. 29). When performing a test with an image displayed, a control is carried out in such a way that ST1 and CLK of FIG. 2 match a frame rate 60 Hz or 50 Hz. In a case of detecting a point defect, or evaluating or inspecting characteristics of the pixel drive transistors 31a or the like, ST1, CLK or the like is controlled and reduced to a frame rate 1 Hz or the like. The VGH and VGL voltages are applied to the gate drive circuits 22. That is, in the point defect inspection, a frame rate is made lower than at the normal display time. The frame rate of the point defect detection inspection is set to 5 Hz to 30 Hz.

The gate drive circuit 22a sequentially selects a gate signal line 27a. In synchronism with the selection of the gate signal line 27a, the predetermined current or the predetermined voltage is applied to the source signal lines 28 from the test transistors 295, and the heretofore described voltage or the like is written to pixels by means of the switching transistors 31c in a selected pixel row.

In the gate drive circuit 22b, a gate signal line 27a is selected, and a non-selection voltage is applied to a pixel row to which the predetermined voltage (predetermined current) has been written. A selection voltage is applied to, or the duty ratio drive of FIGS. 5 and 7 is implemented on, the other pixel rows.

In the heretofore described example, pixel rows are selected one by one, and the predetermined voltage (predetermined current) is written to the pixels 26, but the embodiment is not limited to this. For example, it is also possible to select a plurality of pixel rows (for example, a 1 pixel row and a 2 pixel row, a 3 pixel row and a 4 pixel row, a 5 pixel row and a 6 pixel row, . . . ), and write the predetermined voltage (predetermined current) to the pixels 26. Also, it is also acceptable to select all the gate signal lines 27a at the same time, and write the predetermined voltage (predetermined current) to the pixels 26. Also, it is also acceptable to select gate signal lines 27a on an upper half of the screen at the same time, and write the predetermined voltage (predetermined current) to the pixels 26, and next to select gate signal lines 27a on a lower half of the screen at the same time, and write the predetermined voltage (predetermined current) to the pixels 26.

The examples of FIGS. 29 and 62 are examples in which a predetermined voltage or predetermined current for a test is written to a pixel row by the gate drive circuits 22. The gate drive circuits 22 are formed at the same time as the transistors of the pixels 26 by means of the polysilicon technology.

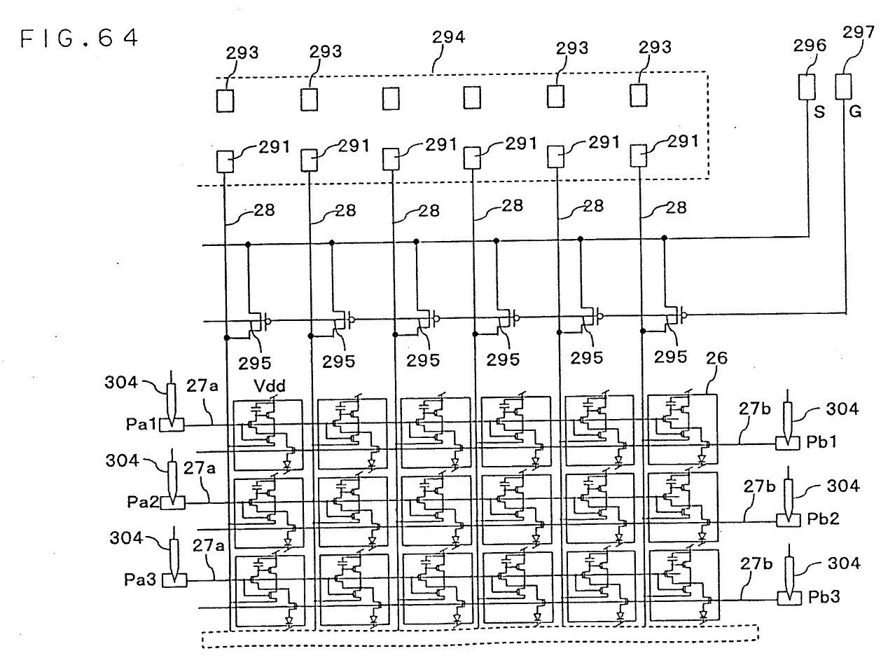

FIG. 64 shows an example in which probing pads Pa and Pb are formed at ends of the gate signal lines 27 without using the gate drive circuits 22. Probes 304 or the like are brought into contact with the probing pads Pa and Pb, applying the VGH voltage and the VGL voltage. By applying the VGL voltage (non-selection voltage) sequentially to probing pads Pa1, Pa2, . . . , and applying the VGH voltage (non-selection voltage) to probing pads Pa which are not selected, it is possible to actualize the same operation as the gate drive circuits 22a. Also, it is also acceptable to apply the selection voltage in a zigzag manner (pads Pa1, Pa3, Pa5, . . . ).

After the inspection of the EL display panel, the gate drive circuits 22 fabricated with semiconductors are mounted on the gate signal line 27 ends.

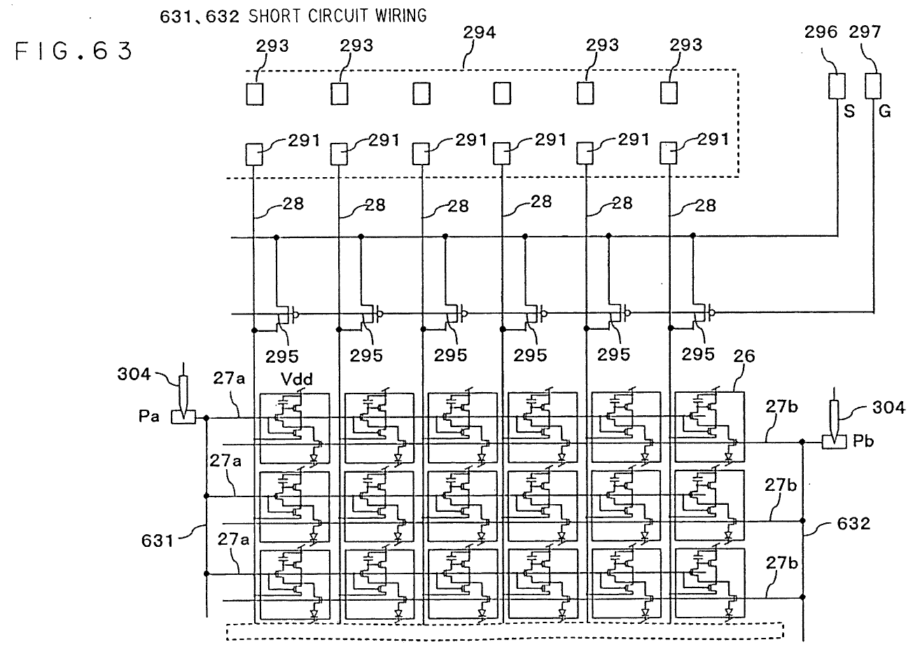

FIG. 63 shows an example in which the probing pads Pa and Pb are formed separately for the gate signal lines 27a and 17a, and the probes 304 or the like are brought into contact with the pads Pa and Pb, applying the VGH voltage and the VGL voltage. FIG. 33 shows an example in which a plurality of the gate signal lines 27a are short circuited by a short circuit wiring 631, and the probing pad Pa is disposed. Also, the figure shows an example in which a plurality of the gate signal lines 27b are short circuited by a short circuit wiring 632, and the probing pad Pb is disposed.

The probes 304 or the like are brought into contact with the probing pads Pa and Pb and, by applying the VGH voltage and the VGL voltage, it is possible to on or off control the whole of the display screen 21.

By operating the test transistors 295, it is possible to display an image on the display screen 21 without mounting the source drive circuit 24. By means of the image display, it is possible to easily detect a point defect, a line defect, a color drift or the like. The control of the test transistors 295 is carried out by the power supply circuit 12 or a control circuit.

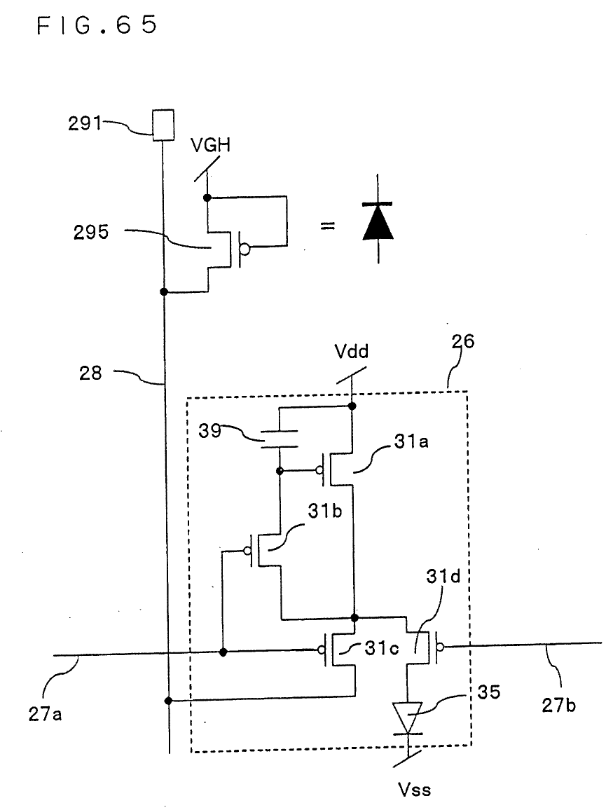

In other than the inspection mode (at the normal image display time), as shown in FIG. 65, the source terminal and gate terminal of the test transistor 295 are electrically short circuited. By their being short circuited in the way of FIG. 65, the test transistor 295 becomes equivalent to a diode.

Consequently, in the event that the off voltage (VGH) is applied to the source terminal and gate terminal of the test transistor 295, it does not happen that a voltage or a current is applied to the source signal line 28 from the test transistor 295. Also, the diode configured of the test transistor 295 functions as a protection diode for an electrostatic protection, and functions as an element which protects the EL display panel.

The system of FIG. 28 is used to make the test transistor 295 a diode connection as in FIG. 65.

In the heretofore described example, the test transistor 295 of the P channel is formed on the source signal line 28, but it is also acceptable that the test transistor 295 of the N channel is formed on the source signal line 28.

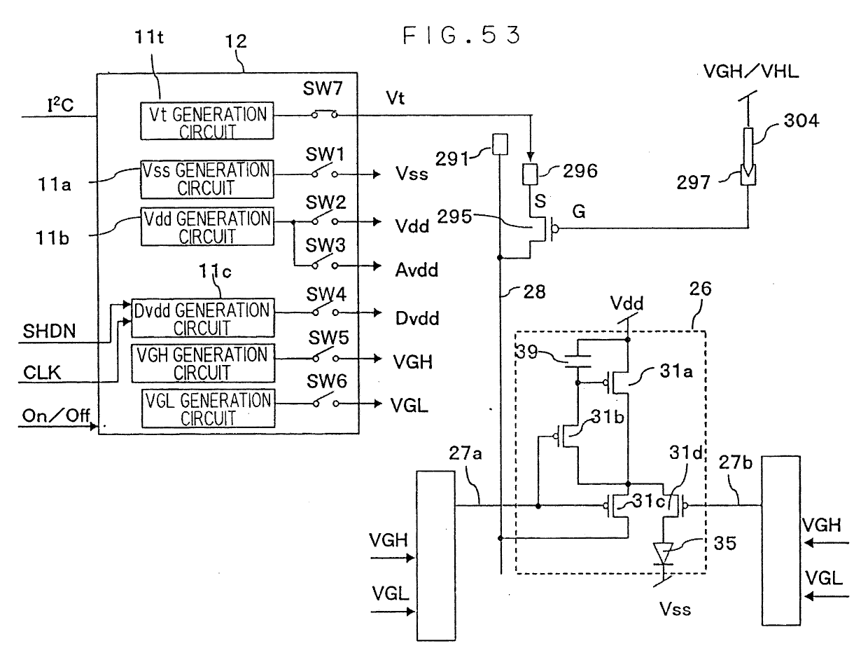

A voltage is supplied to the gate drive circuits 22 from the power supply circuit 12. Also, the power supply circuit 12, when necessary, supplies a voltage to be applied to the signal input terminal 296 of the test transistor 295, and a control voltage (the on/off voltage of the test transistor 295) to be applied to the transistor control terminal 297 (refer also to FIG. 53).

However, it is preferable to match the channel polarity of the test transistor 295 with the channel polarity of the switching transistor 31c (a transistor which generates the current or voltage applied to the source signal line 28 in a current pathway with the pixel 26) of the pixel 26. This is because the test transistor 295 can be reliably turned off by means of the voltage which turns off the switching transistor 31c.

Regarding the test transistor 295, it is also acceptable that two transistors, of the P channel and the N channel, are formed in each source signal line 28. By forming two channel polarity test transistors 295, it is possible to apply a voltage (current) best suited for a test to the source signal line 28.

In the EL display device of the embodiment, as shown in FIG. 29, the test transistors 295 are formed. The test transistors 295 are formed on the array substrate 282 on which are formed the transistors 31 of the pixels. Also, the formation of the test transistors 295 is carried out by means of the same process as the transistors 31. Also, the test transistors 295 are formed on the array substrate 282 by means of the same process as the gate drive circuits 22.

The test transistors 295 basically have the same configuration as the transistors 31 of the pixels 26. The transistors 295 are taken to be the same channel transistors as the switching transistors 31c. In the event that the switching transistors 31c are the P channel transistors, the test transistors 295 are also taken to be the P channel transistors. In the event that the switching transistors 31c are the N channel transistors, the test transistors 295 are also taken to be the N channel transistors.

The switching transistors 31c are on or off controlled by means of the applied voltages (VGH1 and VGL1) of the gate signal lines 27a. Also, when necessary, the VGH and VGL voltages transmitted by the power supply circuit 12 are changed by means of a command, and applied to the EL display panel.

In the event that the switching transistors 31c are the P channel transistors, the switching transistors 31c attain the off condition by means of VGH1, and the switching transistors 31c attain the on condition by means of VGL1. In the event that the switching transistors 31c are the N channel transistors, the switching transistors 31c attain the on condition by means of VGH1, and the switching transistors 31c attain the off condition by means of VGL1.

The test transistors 295 are turned off by means of the off voltage of the gate signal lines 27a. In the event that the test transistors 295 are the P channel transistors, the test transistors 295 attain the off condition by means of VGH1. In the event that the test transistors 295 are the N channel transistors, the test transistors 295 attain the off condition by means of VGL1.

The test transistors 295 are turned on by means of a voltage higher than the on voltage of the gate signal lines 27a. In the event that the test transistors 295 are the P channel transistors, they are placed in the on condition by means of a voltage VGLt (a voltage which is high in a negative direction) lower than VGL1. For example, in the event that VGL1 is −3V, VGLt is −9V.

VGHt and VGLt are voltages used in the inspection mode. VGH1 (VGH) and VGL1 (VGL) are generated in the power supply circuit 12. VGHt and VGLt are generated in an inspection circuit fabricated for the inspection. Alternatively, VGHt and VGLt are generated in the power supply circuit 12. The power supply circuit 12 changes the output voltage by means of the command setting.

The VGHt and VGLt voltages are varied and, by inspecting or evaluating the display condition and the display luminance by means of the varied voltage setting value, it is possible to quantitatively acquire a characteristic margin and operation margin of the EL display panel. The same applies to Vdd (Vddt) and Vss (Vsst).

The test transistors 295 are off controlled by means of the applied voltages (VGH1 and VGL1) of the gate signal lines 27a. A W/L ratio of the test transistors 295 is made higher than a W/L ratio of the switching transistors 31c. In the event that the switching transistor 31c channel width W is 4 μm, and the channel length L is 5 μm, it is taken that (W/L=4/5=0.8) while, in the event that the test transistor 295 channel width W is 10 μm, and the channel length L is 5 μm, it is taken that (W/L=10/5=2).

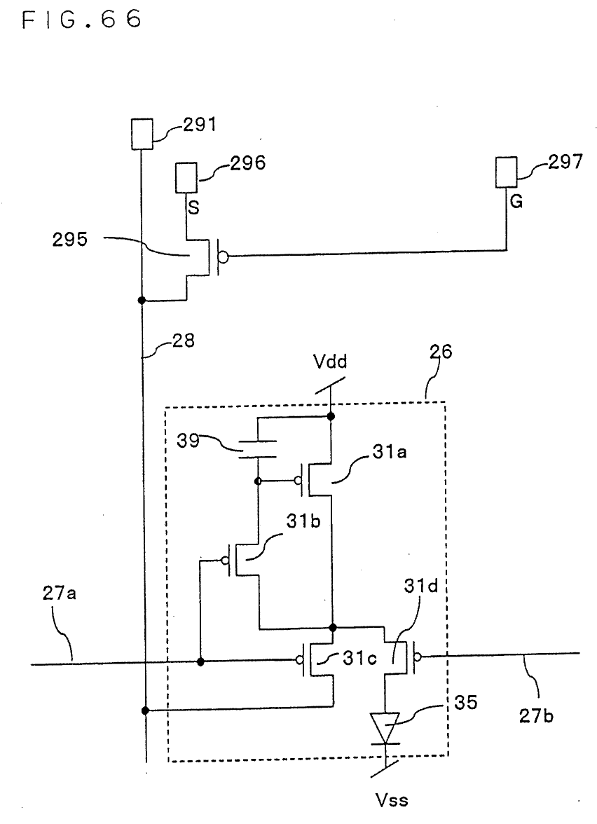

As shown in FIG. 66, a drain terminal of the test transistor 295 is connected to the source signal line 28. Also, an output terminal pad 291 for making COG (Chip On Glass) connection with the output terminal of the source drive circuit 24 is formed at one end of the source signal line 28. Also, the source drive circuit 24 is ACF connected to the output terminal pad and input terminal pad 291 of the IC 24, and mounted in the source drive circuit mounting position 294 shown by the dotted line of FIG. 29.

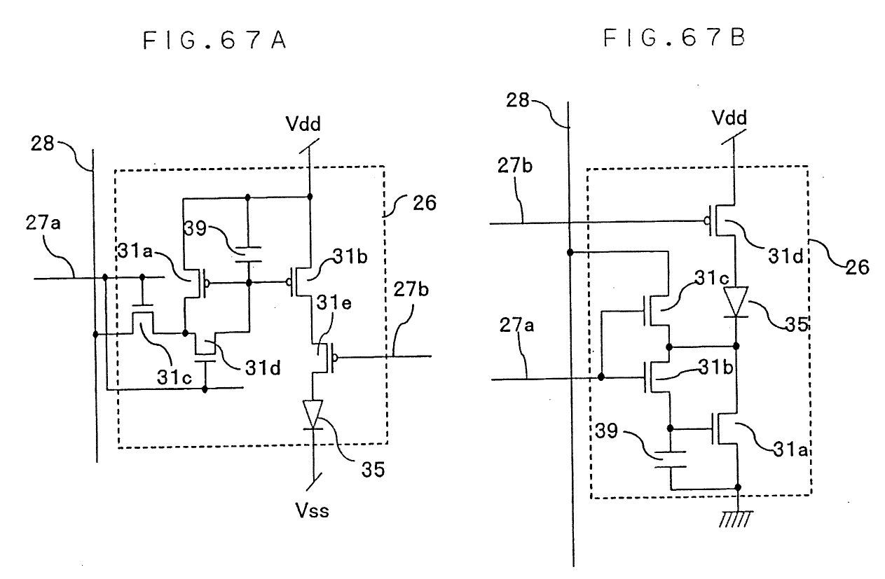

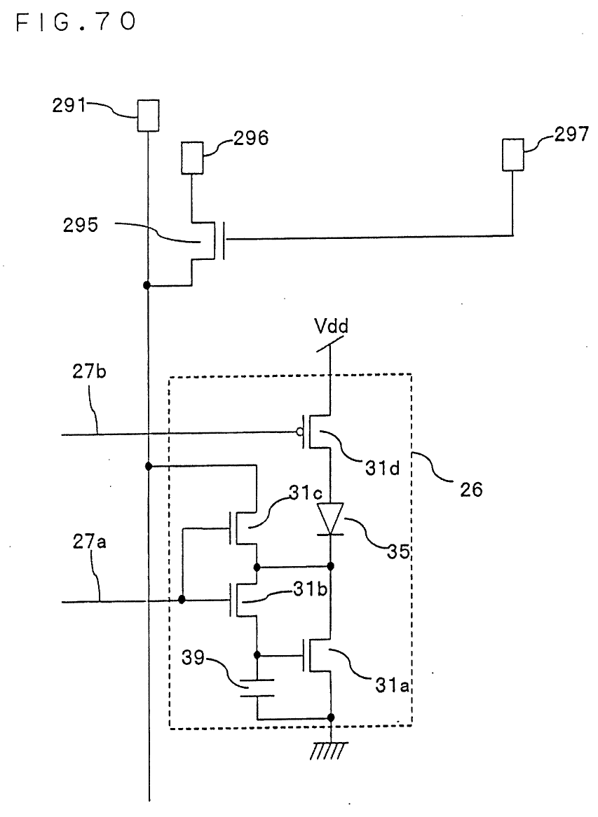

The pixel configuration is not limited to the configuration of FIG. 66. For example, it is also acceptable to use a kind of pixel configuration of FIG. 70. Naturally, the embodiment can also be implemented with the pixel configurations of FIGS. 67A, 68A and 68B. As heretofore described, the embodiment is not limited to, or constrained by, the pixel configuration. The heretofore described item can also be applied to other examples of the embodiment.

### 23. Circuit Generating Constant Current

The source terminal of the test transistor 295 is connected to the signal input terminal 296. A constant current source or a constant voltage source is connected to the signal input terminal. The constant current source or the constant voltage source is supplied from the power supply circuit 12.

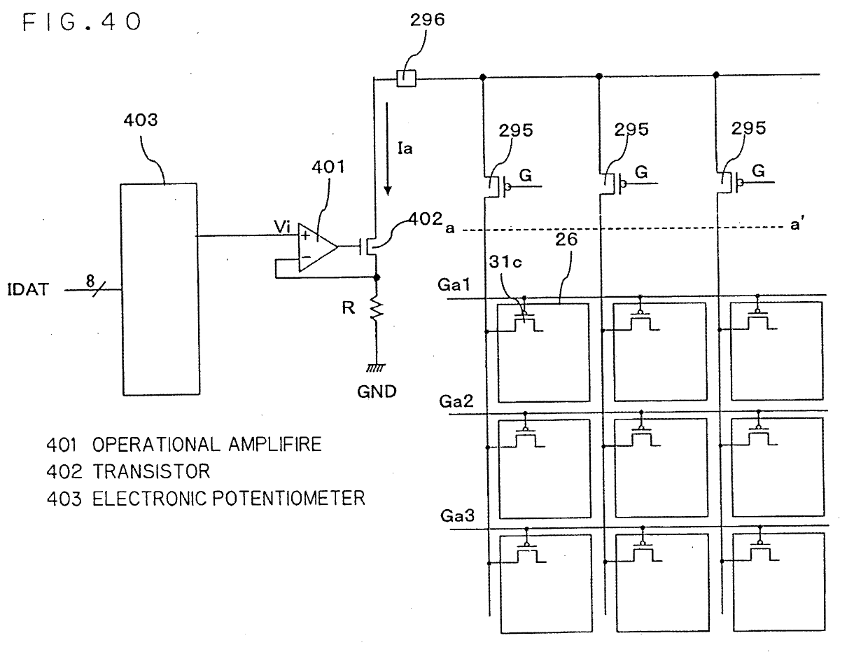

The circuit configuration shown in FIG. 40 is used as one example of a circuit which generates the constant current. In FIG. 40, a constant current circuit is configured of an operational amplifier 401, a transistor 402 and a resister R. A voltage Vi is applied to a +terminal of the operational amplifier 401. The voltage Vi is set by means of data (IDAT) applied to an electronic potentiometer 403. The electronic potentiometer 403 is a DA converter circuit. A constant current Ia is determined by means of Ia=Vi/R.

The circuit configuration of FIG. 40 being configured of three circuits for R, G and B, constant currents transmitted by the R, G and B constant current circuits are varied by the independently configured electronic potentiometers 403.

As in FIG. 40, in a system of applying the constant current to each pixel 26, it is necessary that the pixels 26 have the pixel configuration of the current program system. It is necessary that the pixel configuration of the current program system is configured in such a way that a direct current flows between the current pathway, which runs through the drive transistor 31a or 31b, and the source signal line 28.

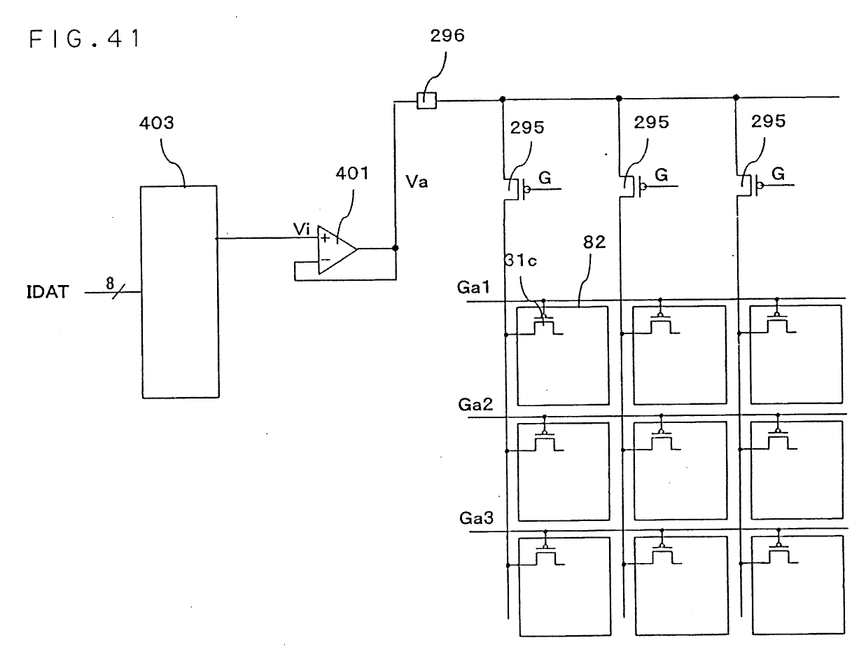

The circuit configuration shown in FIG. 41 is used as one example of the circuit which generates the constant voltage. In FIG. 41, a constant voltage circuit is configured of the operational amplifier 401 and the transistor 402. The voltage V1 is applied to the +terminal of the operational amplifier 401. The voltage V1 is set by means of data (IDAT, 8 bits=256 stages) applied to the electronic potentiometer 403.

The circuit configuration of FIG. 41 being configured of three circuits for R, G and B, constant voltages transmitted by the R, G and B constant voltage circuits are varied by the independently configured electronic potentiometers 403.

In FIGS. 40 and 41, the current or voltage applied to each of R, G and B pixels is made different as necessary. This is because, as there is a case in which EL element luminance efficiencies differ in R, G and B, and sizes of the drive transistors 31a differ, emission luminances in R, G and B differ at the same current or voltage. In the embodiment, as the independent electronic potentiometers 403 are provided in R, G and B, a flexible response is possible.

In FIGS. 40 and 41, at a panel inspection or panel adjustment time, the test transistors 295 are turned on while, at the normal display time, the voltage is applied to them as shown in FIG. 65, and they are turned off.

It is also acceptable to configure the gate terminals of the test transistors 295, in the same way as the gate drive circuits 22, in such a way that the shift registers 363 (refer to FIG. 36, etc.) are added, and one or a plurality of the test transistors 295 are sequentially selected by means of the function of the shift register circuits 363.

By configuring in the way heretofore described, it is possible to on or off control the test transistors 295 independently. Consequently, by turning on or off the test transistors 295 separately from the gate drive circuits 22a, it is possible to select the pixels 26 arrayed in the matrix formation individually or in pixel row units, and apply the voltage or current. The heretofore described item can be similarly applied in other examples of the embodiment.

It is also acceptable that the test transistors 295 are cut off and removed after a panel inspection or panel adjustment process finishes. For example, the test transistor 295 is formed in the portion B of FIG. 30 (an edge opposite to the portion in which the source drive circuit 24 is mounted). The test transistors 295 are severed by cutting the array substrate 282 along the a-a′ portion of FIGS. 40 and 37. The heretofore described item can be similarly applied in other examples of the embodiment.

In the following description, a description will be given taking the test transistors 295 to be the P channel transistors. In the case in which the test transistors 295 are the N channel transistors, it is sufficient to switch between VGH and VGL.

The voltages (VGH and VGLt) applied to the gate drive circuit 22a are applied to transistor control terminals G (GR, GG and GB) connected to the gate terminals of the test transistors 295. In the case in which the test transistors 295 are the P channel transistors, the test transistors 295 are turned on by means of the application of the VGH voltage. When the test transistors 295 are turned on, the signal (the constant current or the constant voltage) applied to the signal input terminals 296 is applied to the source signal lines 28.

The constant current is not limited to a constant DC (direct current). It is also acceptable to change it into a rectangular shape. Also, it is also acceptable to change it into a stepped shape. It is sufficient that the constant current is constant for a certain period (for a period in which at least one pixel row is being selected). In the same way, the constant voltage is not limited to a constant DC (direct current) voltage. It is also acceptable to change it into a rectangular shape. Also, it is also acceptable to change it into a stepped shape. It is sufficient that the constant voltage is constant for the certain period (for the period in which at least one pixel row is being selected).

Each power supply voltage or the like is generated in the voltage generation circuit 11 (FIGS. 3, 13, 30, 31, 27, 36, 32, 58, 47, 25, 16, 22, 23, 26, 48, 12, 11, 46, 53, etc.) of the embodiment, and applied to each terminal or the like by operating or controlling the voltage generation circuits 11.

The voltage applied to the signal input terminal 296, by the test transistors 295 being turned on, is applied to the source signal lines 28 to which are connected the heretofore described test transistors 295. The voltage which turns on the test transistors 295 is VGLt. For example, in the event that the constant voltage applied to the signal input terminal 296 is −2V, −2V is applied to each source signal line 28 while, in the event that the constant current applied to the signal input terminal 296 is 10 mA, 10 mA is shunted and applied to each selected source signal line 28.

In the case in which the pixel configuration is of the current program system as in FIGS. 3, 67A, 67B, etc., the constant current is applied to the signal input terminal 296. The pixel rows are selected one by one, and the heretofore described constant current is shunted and applied to the selected pixel rows. For example, in the event that 240 test transistors 295 are selected, the constant current 10 mA is divided by 240, and applied to each source signal line 28. Consequently, the program current being applied to each pixel 26, it is possible to realize a relatively effective image display.

In the case in which the pixel configuration is of the voltage program system as in FIGS. 68A, 68B, 74, 75, etc., the constant voltage is applied to the signal input terminal 296. The pixel rows are selected one by one, and the heretofore described constant voltage is applied to the selected pixel rows. For example, in the event that 240 test transistors 295 are selected, the constant voltage −2V is applied to each source signal line 28. Consequently, the program voltage is applied evenly to each pixel 26.

In the following example, a description will be given taking FIG. 3 as an example of the pixel configuration, and taking the test transistors 295 to be the P channel transistors. However, the embodiment is applicable even to other pixel configurations of FIGS. 67A, 67B, 68A, 68B, 74, 75, etc.

As heretofore described, the power supply circuit 12 of the embodiment can also be applied to an inspection system or the like using the inspection transistors 295, as shown in FIG. 53. It supplies the inspection voltage Vt to the terminals 296, 141 and the like of the inspection transistors 295. Also, the inspection voltage Vt, as well as varying a voltage value Vt by means of a command, on or off controls the switch SW7. The heretofore described item can be applied to an inspection system and adjustment system other than those described in the embodiment, and also, can be used in combination with them.

### 24. Non-illumination Area and Illumination Area

In the embodiment, as shown in FIGS. 5 and 7, the non-illumination area 55 and the illumination area 56 are generated on the display screen 21. With the pixel configuration of FIG. 3, in the illumination area 56, the selection voltage (the on voltage) is applied to the gate signal line 27b, turning on the switching transistor 31d in the selected pixel row. In the non-illumination area 55, the non-selection voltage (the off voltage) is applied to the gate signal line 27b, turning off the switching transistor 31d in the non-selected pixel row.

In the same way, with the pixel configuration of FIG. 67A, in the illumination area 56, the selection voltage (the on voltage) is applied to the gate signal line 27b, turning on the switching transistor 31e in the selected pixel row. In the non-illumination area 55, the non-selection voltage (the off voltage) is applied to the gate signal line 27b, turning off the switching transistor 31e in the non-selected pixel row.

With the pixel configuration of FIG. 67B, in the illumination area 56, the selection voltage (the on voltage) is applied to the gate signal line 27b, turning on the switching transistor 31d in the selected pixel row. In the non-illumination area 55, the non-selection voltage (the off voltage) is applied to the gate signal line 27b, turning off the switching transistor 31d in the non-selected pixel row.

In FIGS. 68A and 68B which show the pixel configuration of the voltage drive system, in the illumination area 56, the selection voltage (the on voltage) is applied to the gate signal line 27b, turning on the switching transistor 31d in the selected pixel row. In the non-illumination area 55, the non-selection voltage (the off voltage) is applied to the gate signal line 27b, turning off the switching transistor 31d in the non-selected pixel row.

The EL display device of the embodiment generates the illumination area 56 and the non-illumination area 55 on the display screen 21, and displays the non-illumination area 55 or the illumination area 56 while moving them in an up and down direction of the display screen 21.

A drive method, which generates the illumination area 56 and the non-illumination area 55 on the display screen 21, and displays the non-illumination area 55 or the illumination area 56 while moving them in the up and down direction of the display screen 21, in this way, is referred to as a duty drive method.

A ratio of the illumination area 56 to (the illumination area 56+the non-illumination area 55) is referred to as a duty ratio. Alternatively, the duty ratio is also a ratio of (a number of gate signal lines 27b to which the on voltage is applied) to (a total number of gate signal lines 27b). Also, the on voltage being applied to the gate signal line 27b, the duty ratio is also a ratio of (a number of selected pixel rows connected to the relevant gate signal line 27b) to a total pixel row number in the illumination area 56.

The EL display device of the embodiment changes a ratio of the illumination area 56 to the non-illumination area 55. Alternatively, it changes an area of the non-illumination area 55 with respect to an area of the display screen 21. Alternatively, it has a feature of, by increasing or reducing a number of pixels in the display condition, adjusting the luminance or brightness of the screen. Also, it changes a size or amplitude value of the image signal written to the display screen 21. As one example, the luminance of the screen can be actualized by changing or adjusting the duty ratio, the reference current or the image amplitude value.

In the embodiment, the duty ratio is changed in response to an illumination ratio. The illumination ratio is a ratio with respect to a maximum current flowing through the anode or cathode of the panel. Also, the illumination ratio can also be translated into a ratio of a maximum current flowing through all the EL elements of the panel. When the illumination ratio is high, the display is close to the white raster. When the illumination ratio is low, there are many black display portions over a whole of the screen. By changing the duty ratio in response to the illumination ratio, it is possible to average power consumed in the display screen 21. Also, it is possible to suppress the power consumption to a certain level or lower.

Although the low illumination ratio means that the current flowing through the display screen 21 is small, it also means that there are many low gradation display pixels configuring an image. That is, an image configuring the display screen 21 has many dark pixels (low gradation pixels). Consequently, the low illumination ratio can be translated into a condition in which, when the image data configuring the screen are subjected to a histogram process, there are many low gradation image data.

Although the high illumination ratio means that the current flowing through the display screen 21 is large, it also means that there are many high gradation display pixels configuring an image. That is, the image configuring the display screen 21 has many bright pixels (high gradation pixels). Consequently, the high illumination ratio can be translated into a condition in which, when the image data configuring the screen are subjected to the histogram process, there are many high gradation image data. Controlling the duty ratio or the like in response to the illumination ratio may mean a condition synonymous with, or similar to, controlling it in response to a gradation distribution condition or histogram distribution of pixels.

For the reason heretofore described, the control based on the illumination ratio can be translated into a control based on the gradation distribution condition of pixels (the low illumination ratio=many low gradation pixels, and the high illumination ratio=many high gradation pixels) as the case may be. For example, it is also effective to increase a reference current ratio as the illumination ratio becomes lower. It is also effective to reduce the duty ratio as the illumination ratio becomes higher, in terms of averaging the power consumed in the EL display panel. Also, it is effective in that it is possible to suppress a peak power (a peak current suppression drive).

By implementing the peak current suppression drive or the duty ratio drive, it is possible to reduce the output current of the power supply circuit to a certain value or less. Also, it is possible to suppress a maximum output current (a maximum output power) to a certain value or less. Also, it is possible to apply a large current to the EL display panel for a certain period at the aging time. Consequently, it is possible to reduce a size of the power supply circuit 12. For the reason heretofore described, there is a close relationship between the peak current suppression drive and the duty ratio drive, and the power supply circuit 12 of the embodiment.

In the embodiment, as shown in FIG. 69, the duty ratio is changed in response to the illumination ratio (%). However, fixing the duty ratio at a certain illumination ratio, or less or more, is also within a scope of the invention.

The illumination ratio can be obtained from the image signal input into the EL display device. Alternatively, the illumination ratio can be obtained by measuring a current flowing through the anode wiring 301 or cathode wiring 302 of the EL display device. The current flowing through the anode wiring 301 or the cathode wiring 302 can be acquired by means of the method of driving or adjusting the power supply circuit of the embodiment, or the EL display device of the embodiment, described in FIGS. 30 to 35.

The illumination ratio and the duty ratio change in accordance with the display image displayed on the display screen 21. The change in the illumination ratio or duty ratio is not implemented in real time, but is carried out with a certain delay or hysteresis. It is also effective to vary the duty ratio in accordance with an external environment illuminance of the EL display device. The external environment illuminance is measured with the photosensor added to the EL display device. When the external environment illuminance is higher than a value of a certain level or more, the duty ratio is fixed at a maximum value. When the external environment illuminance is low, the duty ratio is made low in accordance with the external illuminance.

Although the horizontal axis of FIG. 69 is taken to indicate the duty ratio, it is also acceptable to replace it with the illumination ratio. The higher the illumination ratio, the lower the duty ratio is, and the lower the illumination ratio, the higher the duty ratio is. Also, the illumination ratio is correlated with the power or current consumed in the display screen 21 of the EL display device.

Consequently, it is also acceptable to obtain the duty ratio from the power or current consumed in the display screen 21 of the EL display device. A relationship between the illumination ratio and the duty ratio is obtained from FIG. 69 as one example. FIG. 69 is obtained in advance, or obtained in real time by means of a calculation.

In order to facilitate understanding, in the embodiment, a description will be given, mainly taking a duty ration control or the like to be changed in response to the illumination ratio (%).

In the embodiment, as shown in FIG. 7, it is possible to divide the illumination area 56 occupying the display screen 21 into a plurality of pieces. The division of the illumination area 56 can be actualized by means of an input pattern of the start pulse signal (ST2) input into the gate drive circuit 22b. By dividing the illumination area 56 into the plurality of pieces, it is possible to suppress an occurrence of a flicker at a low frame rate too. Also, a division number of the illumination area 56 or the non-illumination area 55 is caused to differ between a moving image display and a still image display. Also, it is also acceptable to change the division number of the illumination area 56 in response to the illumination ratio.

A feature is such that the non-illumination area 55 or the illumination area 56, occupying the display screen 21, moves zonally in a downward direction from a top of the screen, or in an upward direction from a bottom of the screen. In certain cases, it is also acceptable to interchange the downward direction from the top of the screen, and the upward direction from the bottom of the screen.

In the embodiment, the gate drive circuit 22a selects a pixel row to which the image signal is written, and the gate drive circuit 22b selects a pixel row to be illuminated. Consequently, the gate drive circuits 22 are pixel row selection circuits. The selection circuits 481 select the image signal transmitted from the source drive circuit 24, and allot it to the R, G and B source signal lines. The selection circuits 481 are formed on a glass substrate by means of the polysilicon technology.

It is not necessary that the gate drive circuit 22a and the gate drive circuit 22b are provided distinctly separated. It is also acceptable to provide the gate drive circuit 22a and the gate drive circuit 22b in one gate drive circuit. In this case too, it is assumed that the gate drive circuit 22a and the gate drive circuit 22b are provided. Also, the gate drive circuits 22 have a function of selecting or designating a pixel row. Consequently, one which has a function of the shift register circuit is synonymous with the gate drive circuit 22. Also, one which has a function of designating or selecting a specific pixel row is synonymous with the gate drive circuit 22. As heretofore described, in the embodiment, the gate drive circuits 22 are used in a broad sense.

In the embodiment, the off voltage is taken as VGH, and the on voltage as VGL. This applies to a case in which the switching transistors 31b, 31c, 31d and the like are the P channel transistors. In a case in which the switching transistors 31b, 31c, 31d and the like are the N channel transistors, the on voltage becomes VGH, and the off voltage becomes VGL. Consequently, in the embodiment, it is sufficient to set the logic voltages (VGH and VGL) to be applied to the gate signal lines 27, in accordance with a channel polarity of the drive transistors 31a and the switching transistors 31.

In the event that both the program current output circuit and the program voltage output circuit are configured in the source drive circuit 24, it can also be applied to the drive method which applies the constant current to each pixel in a first half of the period in which one pixel row is selected for the applied image signal, and applies the program voltage in a second half of the period in which one pixel row is selected. By applying the constant current, an operating point of the drive transistor 31a is reset (an offset position is obtained). Next, the program voltage is applied to the pixels. A configuration, in which FIGS. 3 and 30 are combined, or the like is used as the pixel configuration.

In the event that both the program current output circuit and the program voltage output circuit are configured in the source drive circuit 24, it becomes easier to modulate the amplitude or size of the image signal by means of the reference current. Also, it is also possible to easily actualize the white balance adjustment and the duty drive system.

### 25. Modification Examples of Pixels

As heretofore described, in the embodiment, there are a great variety of pixel configurations which can be employed or used. Hereafter, other pixel configurations will be illustrated.

### 25-1. Modification Example 1

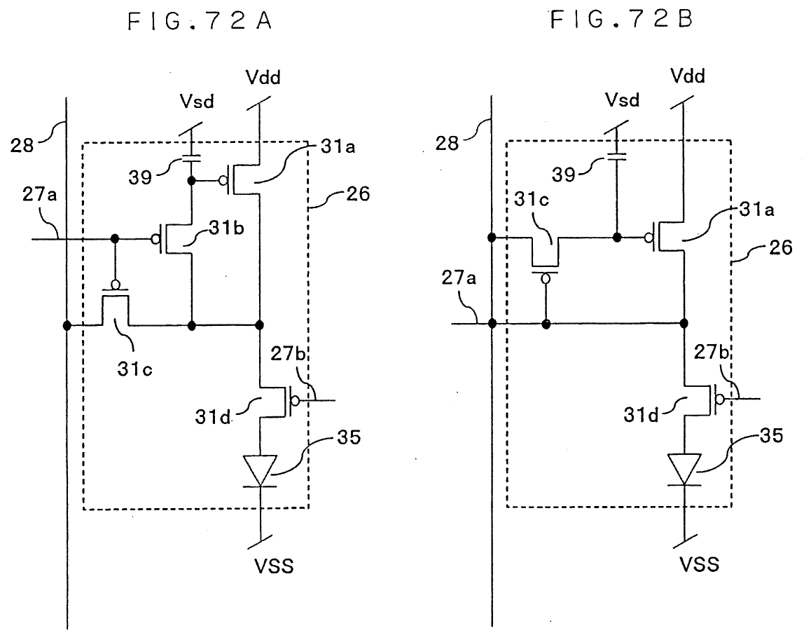

FIG. 72A shows a modification example of FIG. 3. In the configuration of FIG. 72A, one terminal of a capacitor 39 is connected to a Vsd voltage. That is, the anode voltage Vdd connected to one terminal of the drive transistor 31a is made different from the voltage Vsd connected to the capacitor 39.

With the kind of configuration of FIG. 72A, by the voltage Vsd applied to the capacitor 39 being separated from the anode voltage Vdd, no influence of a fluctuation in the anode voltage Vdd due to a change of the image display is suffered. Consequently, a voltage maintenance of the gate terminal of the drive transistor 31a becomes effective. The Vsd voltage is changed at a time of the defect inspection (or other inspections) of the EL display device. On changing the Vsd voltage, the cathode current or the anode current is changed, and it is possible to effectively inspect a pixel characteristic or defect by means of a magnitude of the current, a rate of change of the current, a speed of change of the current or the like. Also, it is also acceptable to carry out the inspection not only by means of a detection of the current, but by means of a change of the display luminance or the like. The heretofore described item can also be applied to another pixel configuration (a configuration in which the Vsd voltage is applied) of the embodiment.

### 25-2. Modification Example 2

The heretofore described configuration of FIG. 72A can also be applied to the pixel of FIG. 72B.

In FIG. 72B too, the Vsd voltage, which differs from the anode voltage Vdd, is applied to one terminal of the capacitor 39. Consequently, no influence of a voltage change of the anode voltage Vdd is suffered.

### 25-3. Modification Example 3

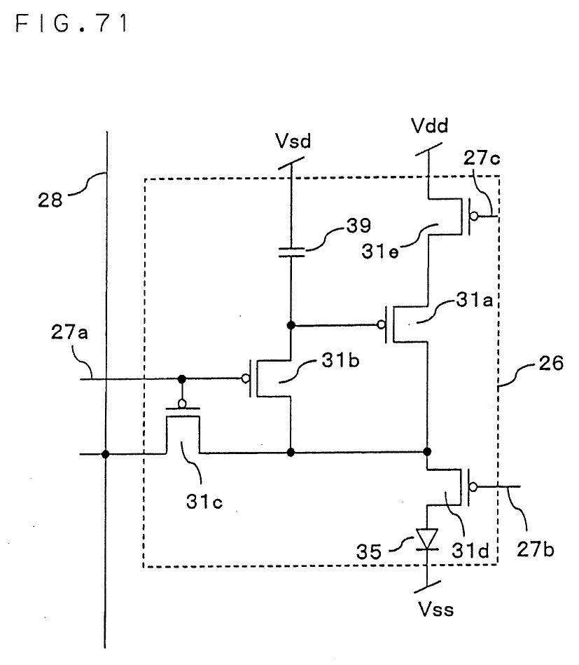

FIG. 71 shows a modification example of FIG. 72A or 3. In the example of FIG. 71, the switching transistor 31e is formed or disposed between the drive transistor 31a and the anode signal line. The switching transistor 31e is on or off controlled by means of the on/off voltages (VGH and VGL) applied to the gate signal line 27c. The switching transistor 31e is turned on when a current is supplied to the EL element 35. It is on or off controlled at the pixel defect inspection time (the inspection time or the like). By on or off controlling the switching transistor 31e, the inspection can be effectively carried out.

The switching transistor 31e is on or off controlled at a time of a characteristic cancellation of the drive transistor 31a of the pixel. Also, it is placed in the off condition when illuminating (starting up) or extinguishing (shutting down) the EL display device. By turning off the switching transistor 31e at the illumination and extinction time, it is possible to prevent an unnecessary current from flowing through the EL element 35. Other configurations and operations are the same as those of FIGS. 3, 72A, 72B, etc.

### 25-4. Modification Example 4

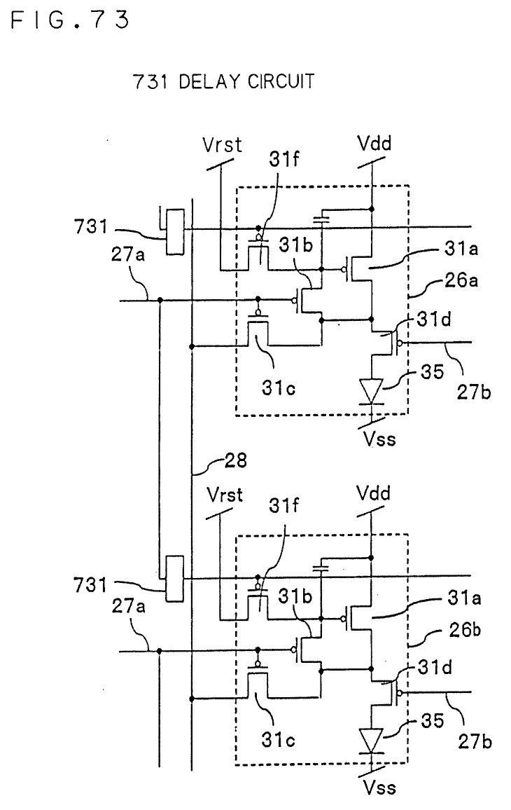

FIG. 73 also mainly shows a modification example of FIG. 3. A difference from FIG. 3 is in an existence or otherwise of switching transistors 31f. The transistors 31f have a function of applying the reset voltage Vrst to the gate terminals of the drive transistors 31a. The reset voltage Vrst is a voltage which places the drive transistors 31a in the off condition (a voltage which causes no current to flow through the EL element 35). The reset voltage Vrst is, for example, a voltage of the anode voltage Vdd−1 (V). It is also acceptable to change the reset voltage Vrst in response to characteristics or variations of the drive transistors 31a. Also, the reset voltage not being limited to being applied only to the gate terminals of the drive transistors 31a, it is also acceptable to arrange in such a way that it is applied to the source terminals or the drain terminals of the drive transistors 31a.

### 25-5. Modification Example 5

In the heretofore described example, the reset voltage Vrst is taken to be a voltage at which the drive transistor 31a passes no current. However, the embodiment is not limited to this. It is also acceptable that the reset voltage Vrst is a voltage which places the drive transistor 31a in an initial condition. It is also acceptable that the reset voltage Vrst is a voltage of, for example, Vdd−5 (V) which is applied to set the drive transistor 31a in such a way as to pass a current through the EL element 35. That is, it is sufficient that the reset voltage Vrst is a voltage which places the drive transistor 31a in the initial condition or in a certain operating condition. This is because, by placing the drive transistor 31a in the initial condition, the image signal is applied with the reset voltage Vrst as a reference, enabling the image signal to be effectively written to the pixel 26.

In FIG. 73, when the on voltage is applied to a gate terminal 27a1, the switching transistor 31c is turned on, and the image signal applied to the source signal line 28 is applied to the drive transistor 31a of a pixel 26a. At the same time, the switching transistor 31f of a pixel 26b is turned on, and the reset voltage Vrst is applied to the drive transistor of a pixel 26b. When the on voltage is applied to a gate terminal 27a2, the switching transistor 31c of the pixel 26b is turned on, and the image signal applied to the source signal line 28 is applied to the switching transistor 31a of the pixel 26b. At the same time, a switching transistor 31f of a pixel 26 in a pixel row next to the pixel 26b is turned on, and the reset voltage Vrst is applied to the drive transistor of the pixel 26.

In the way heretofore described, as the gate signal lines 27a are sequentially turned on, the reset voltage Vrst is applied to corresponding pixel rows, placing them in the initial condition, and after a next one horizontal scanning period, the image signal is applied to the pixel rows placed in the initial condition. Consequently, each pixel row is firstly placed in the initial condition, after which the image signal is applied to each pixel row. For this reason, it is possible to effectively write the image signal to the pixels 26.

### 25-6. Modification Example 6

In the heretofore described example, a timing at, and a time for, which the image signal is applied to the pixel 26a, and a timing at, and a time for, which the reset voltage Vrst is applied to the drive transistor 31a of the pixel 26b, are taken to be the same, but the embodiment is not limited to this. It is also acceptable that, for example, a delay circuit 731 is formed partway through each gate signal line 27a, causing on/off timings of the switching transistor 31f and the switching transistor 31c to differ.

The reset voltage Vrst is generated by the power supply circuit 12 described in the embodiment, or, a switching element being formed on the array substrate, is generated by a charge pump circuit configured of the switching element. The heretofore described item relating to the reset voltage Vrst can also be applied to other examples of the embodiment. Consequently, the item described in FIG. 73 can also be applied to other examples of the embodiment, or it is possible to combine them.

### 25-7. Modification Example 7

It is also possible to use the configuration of FIG. 74. In FIG. 74, each pixel 26 is configured of three capacitors 39a, 19b and 19c, five switching transistors (31b, 31c, 31d, 31e and 31f) and one drive transistor 31a. The transistor 31b is a threshold compensation transistor, to which the transistor 31a is diode-connected, for compensating for a threshold voltage. The transistor 31f is an initialization transistor for applying the reset voltage Vrst in order to initialize the capacitor 39a. Then, the transistor 31d is a transistor for controlling the emission of the EL element 35.

As it is necessary to reduce an off-state leakage, the switching transistors 31b and 31f are formed in a multiple gate configuration having dual or more gates.

The switching transistor 31c, a gate electrode of which is connected to the gate signal line 27a, and a source electrode of which is connected to the source signal line 28, is on or off controlled by means of a selection signal from the gate drive circuit 22a.

A source electrode of the drive transistor 31a is connected to a drain electrode of the transistor 31c. A source or drain electrode of the threshold voltage compensation transistor 31b, and a first terminal of the capacitor 39a, are brought into common connection, determining a gate voltage of the drive transistor 31a. Consequently, the drive transistor 31a generates a drive current corresponding to the voltage applied to its gate electrode.

The threshold voltage compensation transistor 31b, being connected between the gate electrode and source electrode of the drive transistor 31a, diode-connects the drive transistor 31a in response to a scan signal applied to the gate signal line. Consequently, the drive transistor 31a takes on a condition like a diode due to the scan signal, and a voltage Vdata−Vth (V) is applied to the gate terminal of the drive transistor 31a, which becomes the gate voltage of the drive transistor 31a.

The initialization transistor 31f, being connected between a reset voltage line Vrst and the first terminal of the capacitor 39a, in response to a scan signal of an (n−1)th gate signal line 27a connected to the gate electrode, initializes the capacitor 39a via the reset voltage line Vrst by discharging an electric charge charged in the capacitor 39a at a time of a preceding frame.

The transistor 31e, being connected between a first power supply voltage line Vdd and the source electrode of the drive transistor 31a, is turned on by means of an emission control signal transmitted via the gate signal line 27b connected to the gate electrode, applying a first power supply voltage Vdd to the source electrode of the drive transistor 31a.

The transistor 31d, being connected between the drive transistor 31a and the EL element 35, transmits the drive current generated by the drive transistor 31a to the EL element 35, in response to the emission control signal transmitted via the gate signal line 27b connected to the gate electrode.

The capacitor 39a, being connected between the first power supply voltage line Vdd and the gate electrode of the drive transistor 31a, maintains an electric charge, which corresponds to a voltage difference between the first power supply voltage Vdd and the voltage Vdata−Vth(V) applied to the gate electrode of the drive transistor 31a, during one frame.

A first electrode of the auxiliary capacitor 39b is commonly connected to a current gate signal line 27a and the gate terminal of the transistor 31b, and a second electrode thereof is commonly connected to the capacitor 39a and the gate terminal of the drive transistor 31a.

The auxiliary capacitor 39b plays a role of boosting a gate voltage VG of the drive transistor 31a while changing from a scan period to an emission period. The capacitor 39c has a function of maintaining the image signal during a cancellation period.

Taking the off voltage applied to the gate signal lines to be VGH, and the on voltage to be VGL, when the voltage applied to the gate signal lines 27a is changed from VGL to VGH, the gate voltage of the drive transistor 31a rises by a correction voltage caused by means of a coupling of the capacitor 39a and the auxiliary capacitor 39b.

### 26. Other Modification Examples

As a modification example of the voltage program system or current program system, there is a pulse drive system (a PWM drive system or a sub-field drive system), having a sub-field concept, in which a gradation is expressed by a number of times, or a period of time for which, the drive transistors are turned on or off. These are also the voltage program system or the current program system.

The embodiment can be applied to both the EL display device of the current program system, and the EL display device of the voltage program system, in FIGS. 3, 67A, 67B, etc. Also, it can also be applied to the EL display device of the pulse drive system (the PWM drive system or the sub-field drive system). That is, the embodiment can be applied to the pixel configuration described in the embodiment and a commonly known pixel configuration.

As heretofore described, the embodiment can be applied to the pixel configuration of either the voltage or current drive system.

The drive system of the embodiment is not limited to a drive method or drive circuit of an organic EL display panel, or the like. It can also be applied to other displays such as, for example, a field emission display (FED) and an inorganic EL display.

### 27. Application Example

Next, a description will be given of a display instrument of the embodiment in which the EL display device implementing the drive system of the embodiment is used as a display.

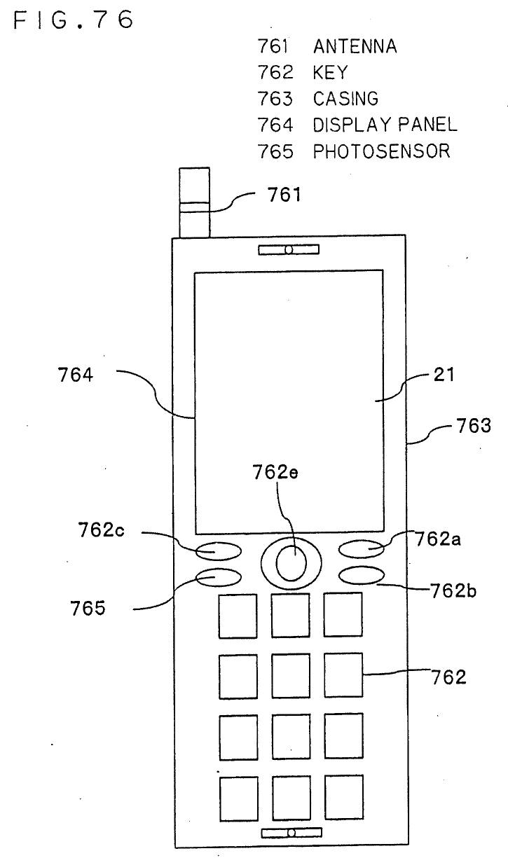

FIG. 76 is a plan view of a portable telephone as one example of an information terminal device. An antenna 761 is attached to a casing 763. 762a is an exchange key with which to change the duty ratio, 762b a power on/off key, and 762c a key with which to switch an operating frame rate of the gate drive circuit 22b. 765 is a photosensor. The photosensor 765 changes the duty ratio or the like in accordance with an intensity of outside light, automatically adjusting the luminance of the display screen 21.

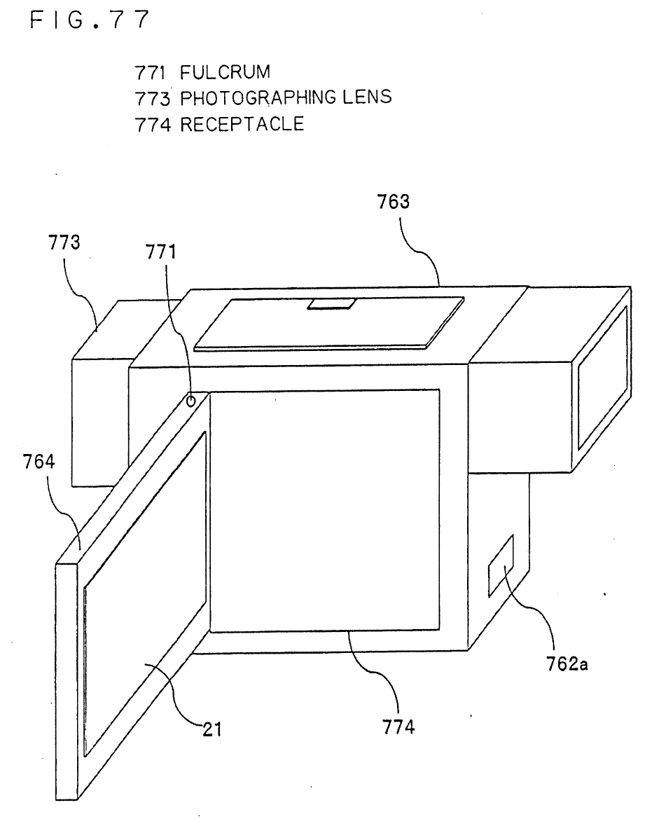

FIG. 77 is a perspective view of a video camera. The video camera includes a photographing (imaging) lens 773 and a video camera main body 763. The EL display device of the embodiment is also used as a display monitor 764. An angle of the display screen 21 can be freely adjusted around a fulcrum 771. The display screen 21, when not used, is stored in a receptacle 774.

In the display instrument of the embodiment in FIGS. 76, 77, etc., by operating the key 762a, it is possible to switch the duty ratio. Regarding the operation of the key 762a, the key 762a is set in advance in such a way as to be switchable by a user. Also, the key 762a is set in advance in such a way as to be switchable with respect to whether an automatic alteration can be made in a setting mode. In a case of the automation, a configuration is such that, by detecting a brightness of outside light, the display luminance can be automatically set at 50%, 60% or 80%.

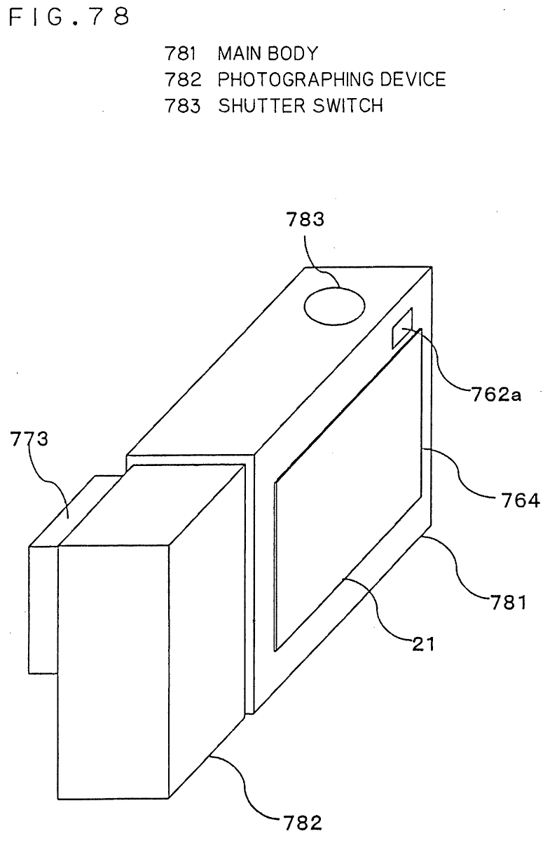

The EL display device or the like of the embodiment can be applied not only to the video camera, but also to a kind of electronic camera shown in FIG. 78. The El display device of the embodiment is used as a monitor 22 attached to a camera main body 781. Switches 762a and 762c, apart from a shutter 783, are attached to the camera main body 781.

### INDUSTRIAL APPLICABILITY

As a power supply circuit has an output open function, it being possible, in an aging process, to apply a voltage higher than in a normal condition to an EL display panel, an aging can be efficiently implemented. By using the output open function, it is possible to measure a current from a cathode wiring with the power supply circuit remaining mounted on a substrate or the like. Consequently, a white balance and luminance adjustment of the EL display device can be easily implemented. Also, pixels are sequentially selected and, by measuring a current transmitted from the selected pixels, it being possible to detect a defect of the pixels, it is possible to measure a characteristic variation of a drive transistor of the pixels.

The EL display device of the embodiment can apply a voltage or a constant current to the source signal lines 28 via the test transistors. Consequently, it is possible to easily actualize an inspection of the pixels 26 or the like without using another device.

Consequently, the EL display device of the embodiment is useful in a light-emitting display panel (display device) such as an EL display panel using an organic or inorganic electroluminescence (EL) element, its drive method and drive device, a display device using these display panels, and the like.

What is claimed is:

1. An EL display device comprising:
a display screen in which a plurality of EL elements are disposed in a matrix formation;
a source drive circuit which, being connected to each EL element, supplies an image signal to each EL element;
a gate drive circuit connected to each EL element; and
an extraction terminal which, as well as supplying a drive voltage to each EL element via a voltage output terminal, has a switch which open-circuits or short-circuits each EL element and the voltage output terminal and, being disposed between each EL element and the switch, extracts a current flowing through each EL terminal.

2. The EL display device according to claim 1, further comprising:
a test signal supply module which, using the source drive circuit, supplies a white image signal or a black image signal to each EL element; and
a current measurement module which, when the white image signal or the black image signal is supplied to each EL element, open-circuits the voltage output terminal by means of the switch, and measures a current flowing through the extraction terminal.

3. The EL display device according to claim 1, further comprising:
an aging current supply module which open-circuits the voltage output terminal by means of the switch, and supplies an aging current to the extraction terminal.

4. An EL display device comprising:
a display screen in which EL elements are disposed in a matrix formation;
a power supply circuit which has a function of open-circuiting a voltage output terminal; and
an extraction terminal which extracts a current flowing through the display screen.

5. The EL display device according to claim 4, wherein
a current flowing through the extraction terminal is measured by a current measurement module.

6. The EL display device according to claim 4, wherein
the power supply circuit switches the voltage output terminal between a high impedance condition and a voltage output condition.

7. An EL display device having a display screen in which pixels having the EL elements formed therein are disposed in a matrix formation, comprising:
a gate drive circuit which selects the pixels;
a voltage generation circuit which generates a first voltage applied to the gate drive circuit, and a second voltage applied to the pixels;
a power supply wiring which transmits the second voltage generated by the voltage generation circuit to the pixels of the display screen; and
an output open circuit which places the second voltage output of the voltage generation circuit in an open condition, wherein
a drive transistor which supplies a current to each EL element is formed in each pixel, and
after the voltage generation circuit supplies the first voltage to the gate drive circuit, the output open circuit takes on a closed condition, applying the second voltage generated by the voltage generation circuit to the power supply wiring.

8. The EL display device according to claim 7, wherein
the power supply wiring is an anode wiring or a cathode wiring.

9. The EL display device according to claim 7, wherein
the voltage generation circuit can set a plurality of current limit values.

10. The EL display device according to claim 7, wherein
the first voltage and the second voltage are variable.

11. The EL display device according to claim 7, further comprising:
a clock detection circuit, wherein
an output of the voltage generation circuit is controlled by means of a number of clocks detected by the clock detection circuit.
